(19) United States
(12) Patent Application Publication
(10) Pub. No.: US 2015/0304491 A1
(43) Pub. Date: Oct. 22, 2015

(54) METHOD PROVIDING A GRAPHICAL USER INTERFACE READOUT OF THE IDENTIFICATION OF A RINGBACK TONE ON THE INCOMING AND OUTGOING CALL HANDSETS

(71) Applicant: Tribeca Mobile Innovations Inc., Oakland Gardens, NY (US)

(72) Inventor: Martin Gindi, Oakland Gardens, NY (US)

(21) Appl. No.: 14/564,889

(22) PCT Filed: Mar. 12, 2013
(86) PCT No.: PCT/US13/30564

§ 371 Date: Dec. 9, 2014

Related U.S. Application Data
(60) Provisional application No. 61/663,394, filed on Jun. 22, 2012.
(60) Provisional application No. 61/661,479, filed on Jun. 19, 2012.
(60) Provisional application No. 61/663,418, filed on Jun. 22, 2012.

(51) Int. Cl. H04M 3/42; H04W 4/16; H04M 7/12

(52) U.S. Cl. CPC H04M 3/42051; H04M 7/129; H04W 4/16

(57) ABSTRACT

A method and a system for identifying various details of a ringback tone (“RBT”) or other call pair related metadata after a call is placed is disclosed (“the system”). The system includes a user interface suitable for use in various mobile devices. The user interface allows a user to identify multiple characteristics of an RBT such as the song name, artist name, and the image of the album cover. Additionally, Metadata enhancing the RBT, such as a coupon related to an RBT advertisement may be displayed. Metadata displayed may be call pair related information unrelated to an RBT such as the name of a customer service representative you may have just spoken with. The user interface also provides appropriate actions to be performed after the call such as purchase of the whole song related to the RBT, rating the RBT, using the coupon or rating the customer service representative.

### CROSS-REFERENCE TO RELATED APPLICATION(S)

The present application claims priority to and the benefit of PCT Application No. PCT/US2013/030564, filed Mar. 12, 2013, and titled “METHOD PROVIDING THE IDENTIFICATION OF A RINGBACK TONE AND OTHER CALL PAIR INFORMATION ON INCOMING AND OUTGOING CALL HANDSETS,” U.S. Provisional Application No. 61/663,394, filed Jun. 22, 2012, and titled “METHOD PROVIDING A GRAPHICAL USER INTERFACE READOUT OF THE IDENTIFICATION OF A RINGBACK TONE ON THE INCOMING AND OUTGOING CALL HANDSETS,” U.S. Provisional Application No. 61/663,418, filed Jun. 22, 2012, and titled “METHOD FOR SENDING AND RECEIVING METADATA CONTAINING REFERENCES TO DIGITAL MEDIA OR CONSUMER GOODS BETWEEN CALLING PARTIES,” and U.S. Provisional Application No. 61/663,479, filed Jun. 22, 2012, and titled “METHOD FOR EXCHANGING FILES OR MESSAGES WHEN ONLY ONE SIDE OF A CALL HAS AN APPLICABLE SOFTWARE APPLICATION,” all of which are hereby incorporated herein in their entirety.

### BACKGROUND

As mobile technology improves, mobile devices have become more powerful. The wireless networks they connect to have improved, as well. These improvements mean that mobile devices can now connect to networks for many functions beyond simple voice calling. For example, they can be used to send email, browse the Internet, and send instant messages. In addition, many mobile carriers have deployed commercial services known as ringback tones (RBTs), also known as caller tones and other names. RBTs are short audio clips played in place of a traditional ringer. The carrier of a called party (herein “callee”) plays these audio clips on the calling party's (herein “caller”) handset while waiting for the callee to answer the call. Many times these audio clips are portions of popular songs or songs that a phone subscriber enjoys. The audio clip may be a default tone or the callee may select it. An audio clip that the callee intends to use as an RBT is saved into a callee's profile. The callee may have many audio clips in his profile and the callee may designate that certain RBTs be used for particular callers.

### BRIEF DESCRIPTION OF THE DRAWINGS

The following are brief descriptions of the figures referred to in detail throughout:

FIGS. 1a, 1b and 1c: Architecture arrangement of physical components of the present system, representing alternative arrangements. This also shows the location of certain databases.

FIGS. 2(1), 2(2), 2a and 10: Schema and sample data as part of illustrative examples for tables used in the system.

FIGS. 3, 3a and 3b: Process flow for three main components of the system including; starting events (FIG. 3), the ‘what I heard’ service (FIG. 3a), and the display and return of what I heard visual Metadata. (FIG. 3b).

FIG. 4: Schematic drawings of various visual displays supported by the system.

FIG. 5: Schematic representation of the audio match service.

FIG. 6: Schema for data returned and sometimes stored by various APIs in the system. Also includes a list of example rules used for processing certain return values.

FIGS. 7(1) and 7(2): Time flow diagram for two alternate methods for obtaining a phone's phone number if the OS restricts access.

FIGS. 8(1), 8(2), 8a(1), 8a(2), 8b(1), 8b(2), 8c(1), 8c(2), 8d, 11(1) and 11(2) Time flow diagrams showing illustrative examples of certain features of the system

FIGS. 9(1), 9(2), 9a(1), 9a(2) and 12: Represent embodiments of various display methods for ‘what I heard’ and ‘what I played’.

FIG. 13 is a high-level block diagram showing an example architecture of a mobile device

FIG. 14 is a front view of a mobile device suitable for processing.

### DETAILED DESCRIPTION

Often times many mobile phone users wonder about certain details of an RBT that they may have heard, including the song name, artist name, album name, image of the album cover, or other characteristics of the RBT. Additionally there may be Metadata enhancing this RBT such as a coupon associate with an RBT advertisement or Metadata unrelated to the RBT such as the name of the corporation and customer service representative you just spoke with. This metadata is often stored on a remote server. While the respective networks of the callers are designed to play audio clips, there is no current signaling path to convey any of this metadata back to the caller's handset. In addition, there is no available method to route the metadata to the callee's handset. Thus it would be useful to have a system that could enable the metadata to be sent to both handsets under a variety of circumstances.

Consider two phones, Phone A calls Phone B. Phone B had, previous to the call provisioned his or her line on their carrier that provides service for phone B to play a ‘Ring Back Tones’. Ring-back tones are some audio recording played in the earpiece of phone A until phone B ‘picks up’ the phone. In addition, extra Metadata related to phone A may have been set up on phone line B.

The current disclosure provides methods for Phone A to view a human readable message, immediately after the call, or within a number of seconds, regarding the RBT just heard or other relevant Metadata. We will call this display and the software apparatus that performs this ‘what I heard’ (even in the case where no RBT is in fact played and only relevant Metadata is returned). Similarly, Phone B will display ‘what I played’ information on Phone B's handset.

The current disclosure supports various fallback mechanisms should either of Phone A or Phone B or both not being able to run a display application or for that matter, Phone A and/or phone B are land-lines.

Various embodiments of the application will now be described. The following description provides specific details for a thorough understanding and an enabling description of these embodiments. One skilled in the art will understand, however, that the application may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the application.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section. Overall General flow

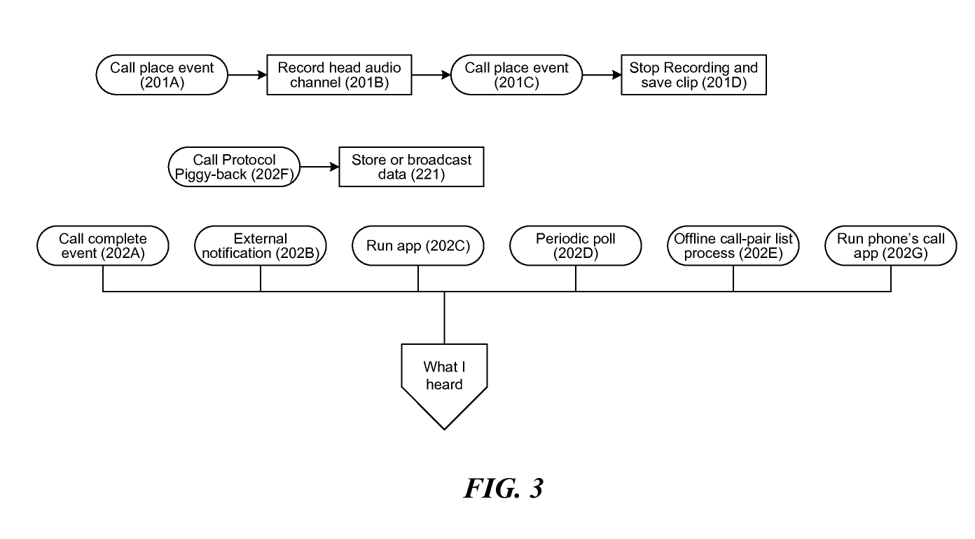

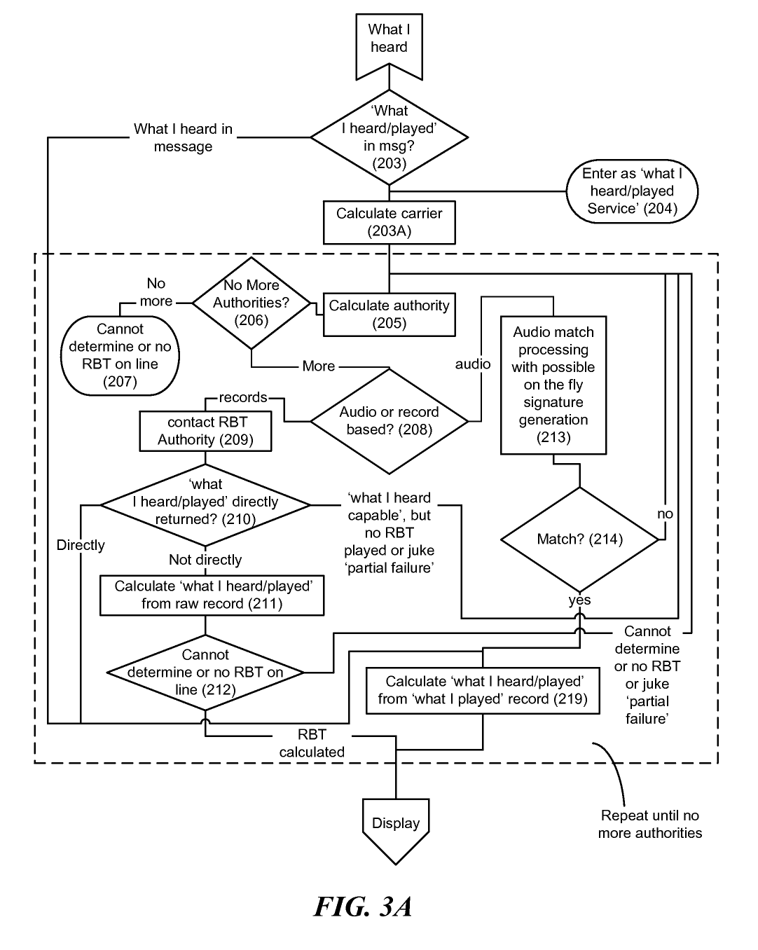

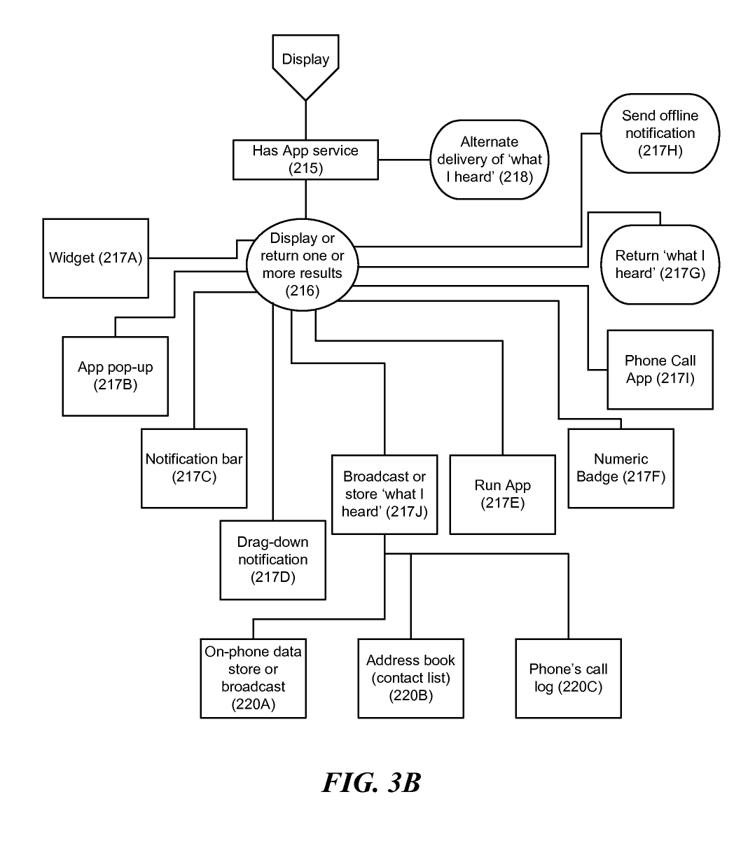

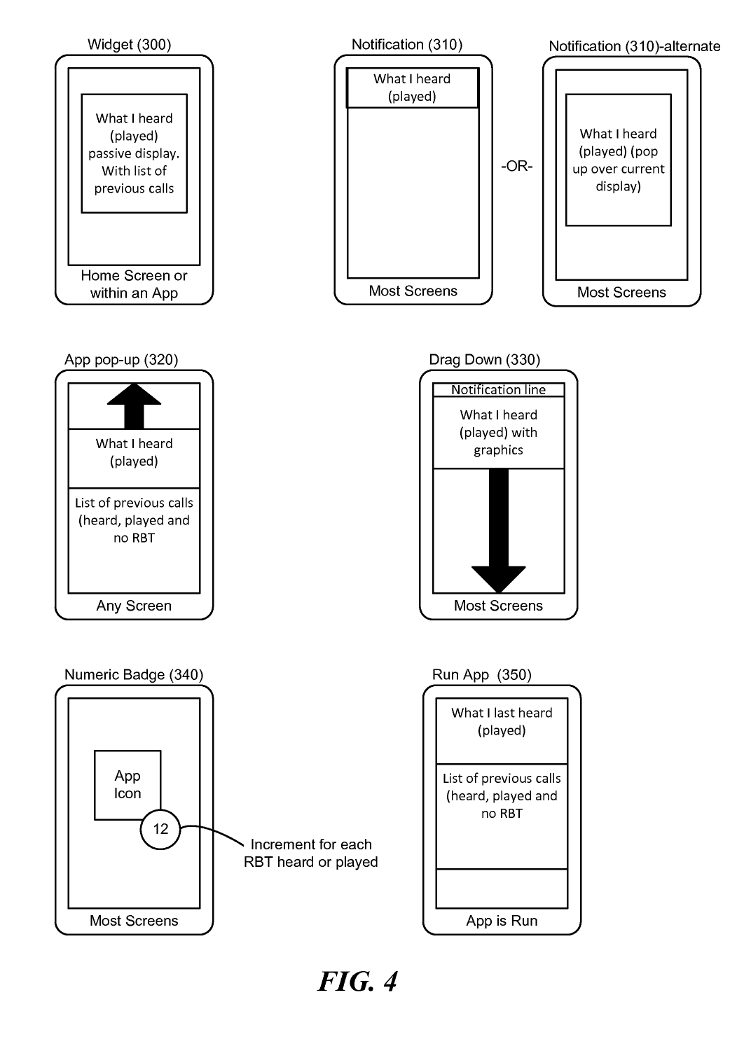

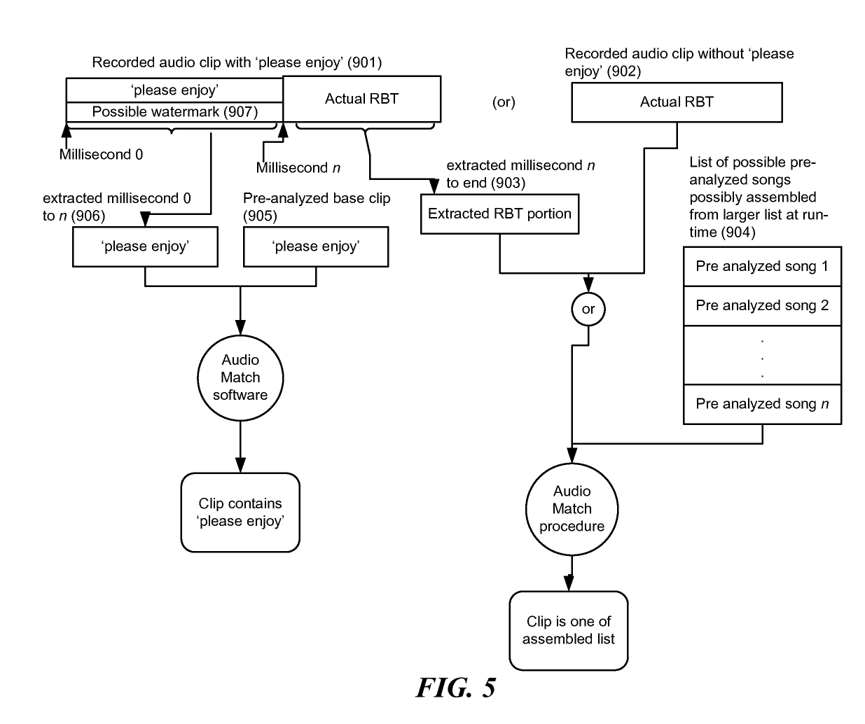

FIG. 3 shows a flowchart of the ‘what I heard’ or ‘what I played’ method. The detailed description begins with FIG. 3 to give an overview of the functional aspects of the disclosure.

The method begins at step 201A where phone A calls phone B. At step 201B the system records the audio on an outgoing call just in case we may need it for later audio processing. At step 201C, the method determines if phone B has connected the call. This step can occur if the user of phone B has answered the call or if phone B's voicemail activates. Upon the connection of the call, the system stops recording and saves the audio clip at step 201D.

Steps 202A-G represent a number of events that can trigger the system to determine what RBT was played or which call related Metadata to display. It is possible for the system to receive either one or more of these events in order to begin a ‘what I heard’ event. For example, multiple trigger events could occur if a call has completed and the user of phone A later opens the ‘what I heard’ mobile app.

Event 202A is an indication from the phone's operating system that the call has completed. Event 202B is an external notification. For example, an outside source such as from server 30 or 40, or from a carrier's network 10 or 20 have the ability to provide this notification. Event 202C occurs when a user manually initiates the ‘what I heard’ mobile app. Event 202D occurs when a user has indicated in the app's settings that the app periodically polls the system. Event 202E occurs when an off-line process runs that goes thorough lists of phone A-phone B call pairs. Event 202F occurs when a RBT determination is delivered within the low level protocol exchange during call setup. Step 202G occurs when the user's phone initiates its own third party application.

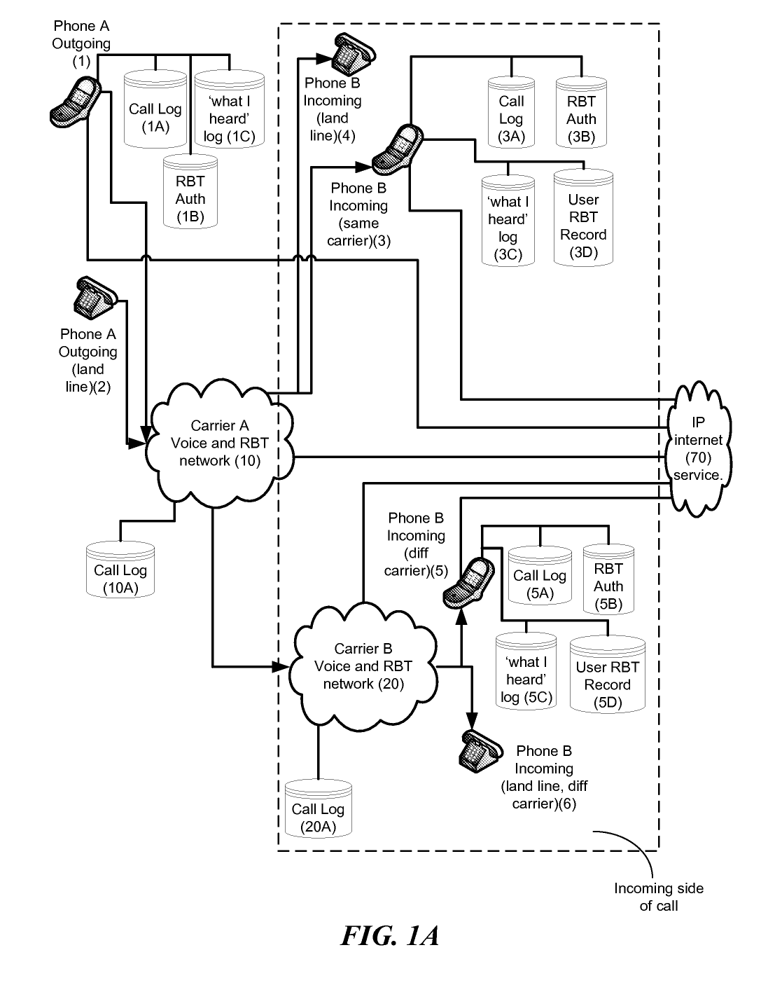

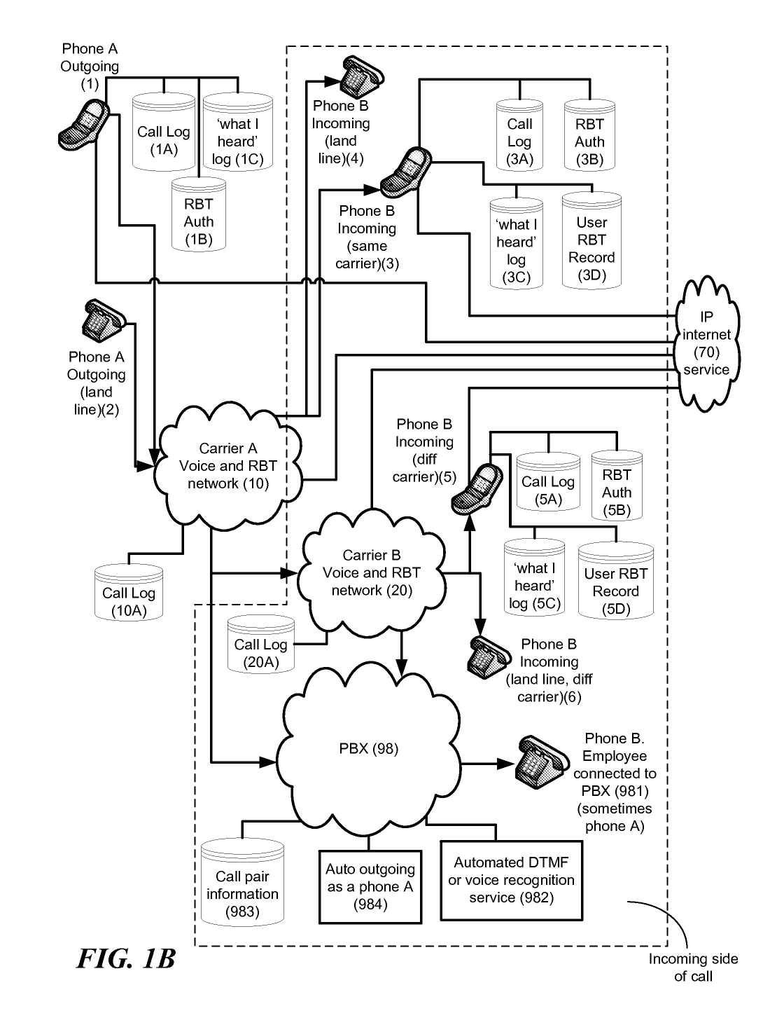

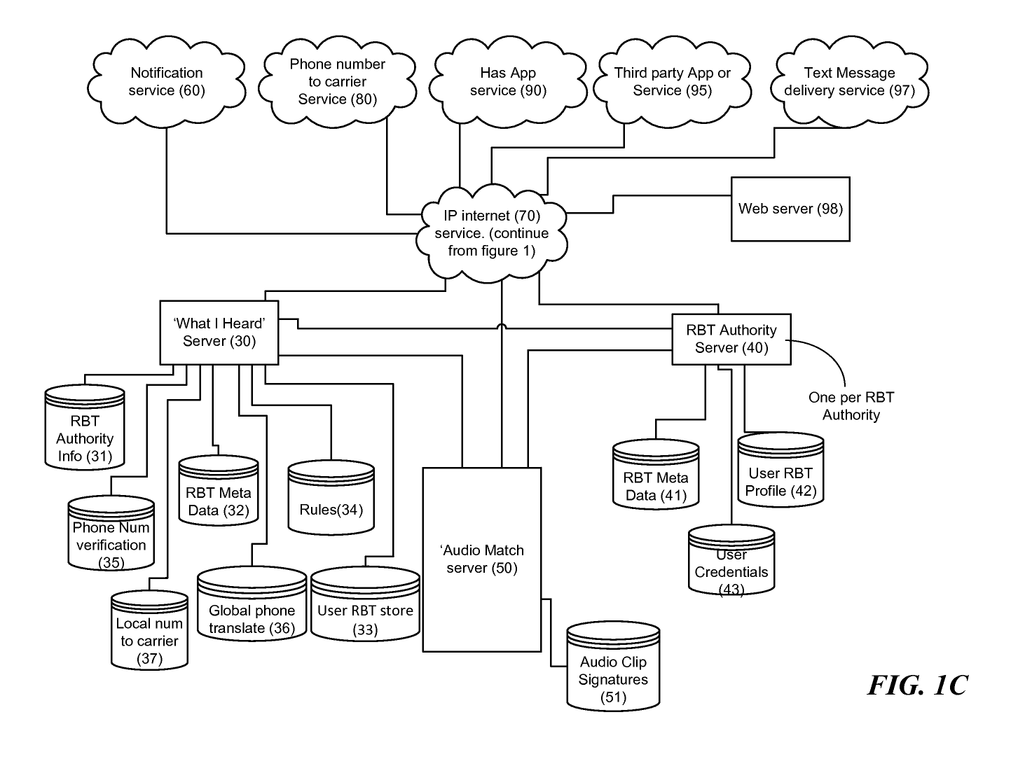

FIG. 3a shows a flow chart of a ‘what I heard’ method. The method utilizes the various servers and databases shown in FIGS. 1a, and 1b to determine the RBT or call related Metadata. The various components of FIGS. 1a, 1b and 1c are described in detail herein or are known to those of ordinary skill in the relevant art.

Upon a received event from steps 202A-G, the method proceeds to decision block 203. Decision block 203 determines if the event includes any data from the ‘what I heard’ mobile app. If the system identifies RBT data or other Metadata, then the method proceeds to 219 to collect the remaining Metadata.

If the event did not include data from the ‘what I heard’ mobile app, processing continues to step 203A. At step 203A the system determines the carrier associated with Phone B. Step 203A first consults table 180 to determine if the phone number is known locally. If it is a carrier is determined directly. If not, step 203A contacts the phone number to carrier service 60 to determine the carrier for phone B. After determining the carrier for phone B, the method proceeds to step 205. It should be noted here that ‘carrier’ here is simply a key used in accessing table 100 and may or may not be an actual carrier. Steps 205-214 and 219 constitute a submethod of determining a RBT. The method uses RBT authorities to determine RBTs or other Metadata. RBT authorities are either audio-match or record-based. The audio-match RBT authority determines the RBT through analyzing the audio of the RBT. The record-based RBT authority determines the RBT through analyzing the metadata of the RBT. These steps can be repeated if one RBT authority cannot determine what was heard or other Metadata. If the current RBT authority cannot determine the RBT or other Metadata, the system moves on to another RBT authority.

In addition, Step 204 is an alternate entry to the ‘what I heard’ submethod. It provides server 40 or a third party app or server 95 a way of accessing the submethod as an API to determine what was played.

Step 205 uses the carrier to determine an RBT authority. The system has access to an ordered list of RBT authorities. If this is the first pass through the ‘what I heard’ submethod, the system starts at the first RBT authority on the ordered list for this carrier. It should be noted that an RBT authority may in fact be related to an RBT or it may simply provide other Metadata related to this call pair. Subsequent iterations of the ‘what I heard’ submethod uses the next RBT authority available on the ordered list.

At step 206, the system determines if there are any RBT authorities available on the ordered list. If there are no RBT authorities available, the method proceeds to step 207. At step 207, the system returns a message that it could not determine the RBT.

If there is an RBT authority remaining, the method proceeds to step 208. Step 208 is a decision block that determines whether the RBT authority is an audio-match or record-based authority. If the RBT authority is an audio match authority, processing continues to step 213. Otherwise, for a non-Audio match authority, the process continues to step 209

At step 209, the record-based RBT authority is contacted with the appropriate information to determine the RBT or to retrieve a record that may be decoded to produce a RBT determination. This RBT Authority may be a remote Server 40 or may be a software apparatus housed in Server 30. Step 210 is a decision block where three possible paths ensue. If the RBT or other Metadata is directly returned, the system exits the subroutine. If the RBT authority returned a Raw RBT record, the system decodes this record and sees if it applies to the current phone A and proceeds to step 211. If the authority determined that the RBT record is not supported by this authority, processing continues to step 205 to try another authority.

At step 211, the system applies stored rules to the record to determine which RBT phone A heard. For example, if phone A is on a list of per-phone-number custom RBTs, the RBT listed on the list associated with the phone number is returned. It may also store the RBT in table 120. The method proceeds to decision block 212 which determines whether an RBT or other Metadata was determined. If an RBT or other Metadata was determined, the process exits the subroutine. If an RBT was not determined in step 211, at the subroutine returns to step 205. In some embodiments, the system may fail to determine an RBT in step 211 if the stored rules were not sufficient to determine the RBT. In some embodiments, the system fails if the RBT requires processing by another RBT authority. For example, a jukebox of RBTs requires further processing by an audio-match RBT authority. In some embodiments, upon exiting the subroutine, the method stores the determined RBT in table 120 with its associated phone number. If decision block 208 had determined that an audio authority is needed, processing continues to step 213. At step 213 the system uses a RBT audio match service to match the clip recorded in step 201B against a list of pre-analyzed or on-the-fly-analyzed audio clips. The process continues to decision block 214 which determines whether the RBT audio match service found a match for the RBT. If the audio match service was successful, the process proceeds to step 219. If there was no match, the method returns to step 205 where another RBT authority is used.

Upon exiting the subroutine with an identified RBT, the system proceeds to decision block 215 which determines if the user has the ‘what I heard’ mobile app. If the system determines that the user does not have the app, the method proceeds to step 218 where the system will send a ‘what I heard’ or ‘what I played’ message by some alternate means to the owner of phone A and/or Phone B. If that phone is capable of running the app, the alternate message contains instructions on how to download the app or access the identified RBT information on the Web, social network, or other electronic means.

Step 216 determines which display mechanism will be used to display the results. It is also possible that multiple methods may be chosen (e.g., display on a widget but also a pop-up).

For 217A, the system displays the results through a software widget at a spot on the phone's home screen in real-time. As new RBTs or other Metadata, are heard and/or played, this area updates with the latest results. In some embodiments, the widget displays one or more previously identified RBTs. In some embodiments, the widget is included in the screen space of another app (an ‘in-app’ widget’).

For 217B, the system activates a pop-up RBT app in real-time on the phone's main screen. The RBT is displayed in app. In some embodiments, the app displays one or more previously identified RBTs or other Metadata. It may physically display in full screen or it may be a partial screen.

For 217C, a small portion of the phone display, known as the notification bar, is used to display the identified RBT or other Metadata. The notification bar commonly displays small text and graphic messages alerting the user of an incoming message or reminder. In some embodiments, the user is allowed to activate the RBT app through the notification bar.

In 217D, drag-down notification is a variation on 217C. With the drag-down notification, there is no predefined display area, however, the phone has the ability go to a notification area that would show the identified RBT or other Metadata and allow an app to be run.

In 217E, Normal phone app, the identified RBT or other Metadata is shown within the app. The app display may take up the entirety of the phone display or it may take up a smaller portion or the phone display. In some embodiments, the app displays one or more previously identified RBTs or other Metadata. This normal display may also be entered from 217A, B, C, D and F

In 217F, numeric badge, the phone device supports a small icon, usually with a number in it, to indicate to the phone's owner that there is some event that occurred. Usually this icon is not shown at all if there are no events. For identified RBTs or other Metadata, this badge is displayed on the first identified RBT and then incremented on additional identified RBTs or other Metadata. When the phone's owner runs the app (217E) the identified RBTs or other Metadata since the last run of the app are shown.

Phone Call App 217G is the phone's own phone call app. This Phone Call App may also be a third party app that acts as a third party consumer (95) of the ‘what I heard’ service.

Broadcast and store actions 217J perform 3 separate broadcast operations: 220A broadcasts a RBT or other Metadata determination using a phone's inter-process broadcast mechanism, sending it to any application that is listening. This step also saves this information in a common data store. (Exact features are dependent on a phone's abilities.). 202B stores RBT or other Metadata associated with outgoing calls as part of the person's contact information (likewise it stores RBT or other Metadata information for incoming calls). 202C stores RBT Metadata along with recent phone calls in the phone's call log.

Descriptions of 217A to 217J include the embodiment of the processes in the system into specific software apparatus that may be executed on various physical handsets.

In 217G, is a special case of display for an identified RBT or other Metadata. It returns the calculated RBT that was requested in 204 by server 40 or third party server 95.

217H, sends a notification to Phone A and/or Phone B from the offline server process started in 202E.

### GLOSSARY

‘What I Heard’: without a modifier, generally refers to the determination of ‘what was heard or played’ after a call on phone A. Sometimes it also refers to ‘what was played’ when used generically. The term ‘What I heard’ embodies not only RBT Metadata but also enhanced and non-RBT Metadata.

‘What I heard/played’: generally refers to the determination of ‘what was played or heard’ on a phone A or Phone B.

‘What I played’: generally refers to what a phone B line played for a phone A, In a non-RBT case, or in the case of an enhanced RBT, this refers to the arbitrary information displayed by a called pair on the incoming, MT side of the call.

‘What I heard’ determination: same as ‘what I heard’ without a modifier.

‘What I heard’ Service: generally refers to the service, defined herein for determining ‘what I heard’ or ‘what I played’ and for the associated non-RBT and enhanced RBT determinations.

‘What I heard’ Software Apparatus: generally refers to the ‘app’ on a phone A or phone B that responds to events, uses the ‘what I heard’ Service and then displays or broadcasts the results

App: used generically refers to the ‘what I heard’ Software Apparatus.

Ring Back Tone (RBT). The audio clip played on a phone A after a call is placed and before the Phone B picks up.

Phone Number. Used generically to refer to a string of digits that is used to access a Phone A or Phone B.

Global Dialing Plan Phone Number. A phone number using the worldwide dialing plan.

Jukebox: a collection of RBTs played in a sequence or randomly on phone A's when they call phone B's.

Raw record vs. ‘what I heard’ determination. A raw record is a phone owner's actual RBT administration record that contains rules for playing an RBT on this line. The ‘what I heard’ service then applies rules to it to determine ‘what I heard’. A ‘what I heard’ determination by contrast is a record retrieved or sent to a service that contains some or part of the actual RBT played. The raw record method in some embodiments may be used to determine non-RBT related Metadata.

Audio Features. Frequencies, pitch and amplitude values extracted from audio clips. Many features are extracted from a single audio clip.

Feature Extraction. The act of extracting Audio features from an Audio clip.

Audio Matching. The process of taking Audio Features extracted from a recently recorded audio clip and comparing them to a list of some baseline features from many Audio clips. The process makes a ‘best match’ of many features over the baseline set.

Phone A. The Mobile Originating (MO) or ‘outgoing’ phone. Also referred to as the Caller phone

Phone B′ the Mobile Terminating (MT) or ‘incoming’ phone. Also referred to as the Callee phone.

Direction: on a particular phone call whether the call is ‘incoming’, ‘outgoing’ or ‘missed’

Metadata: Information associated with a ‘what I heard’ determination, including its title, image, code values, corporate information, customer service agent name, name of a separate app that needs to be run etc. This Metadata may be a set of defined data values such as those just mentioned or may be a block of display code such as HTML5 code that is to be displayed.

‘What I heard display (or visual) Metadata. Enough Metadata (determined by business rules) to display a ‘what I heard’ using a particular display method.

Server: used herein to represent a physical processor and its associated components.

Service: a function, often tied to a particular server. Usually have inputs and outputs in the form of an API or other data.

Enhanced Ringback Tone. Additional or replacement determination for ‘what I heard’ or ‘what I played’ such as information needed to retrieve a coupon mentioned in an RBT advertisement

Non-RBT. Arbitrary determination and display related to a phone call where no RBT is played. Instead other relevant information about a call pair is determined and displayed.

RBT Authority. A server, or possibly a local server, that can provide raw records or ‘what I heard’ determinations given a Phone B and/or a phone A. Usually an RBT Authority is associated with a carrier or locally on the phone or server 30, however, in the case of a non-RBT authority it is associated with local or remote server that can provide arbitrary call pair information. In this case it is referred to as a non-RBT information authority.

Non-RBT Information Authority. A non-RBT authority differs from an RBT Authority in the type of metadata returned on a call pair query.

Carrier. A service that connects two handsets referred to by the global dial plan. The carrier itself generally plays the Ringback tone. (or they subcontract this service to a third party who provides it through the carrier's network. In some embodiments of the system “carrier” is simply used as a term to index into an RBT Authority and may or may not be an actual carrier.

PBX. Private Branch Exchange. Used by entities, small or large corporations or other organizations to direct phone calls to a general, global dial plan number to an employee or other person in the organizations. PBXs also may provide DTMF or voice directed announcements and call routing. The PBX is generally connected to a carrier and may be looked at as a further switch after the carrier has routed the call.

### 1. Architecture and Databases

FIGS. 1a, 1b and 1c illustrates the hardware and database tables involved in the system as well as communications paths between these elements.

1.a. Architecture

Phones A (1 and 2) and B (3, 4, 5, and 6)

Phone A places a phone call to Phone B. We will use these terms for the outgoing (MO) calling party (phone A) and incoming (MT) called party (phone B) throughout.

Phone A may either be a Mobile handset (1) or a landline (2). Phone A is serviced by carrier network A (10). Phone B may be a mobile handset (3) or a landline (4) on the same carrier (10) or may be on a mobile handset (5) or landline (6) on another carrier network 20.

Sometime prior to this Phone call, the owner of phone B, the carrier that services phone B, or some third party such as an advertising entity contracted by the carrier arrange for a particular audio clip to be played on Phone B's line to whatever phone A happens to place a call to phone B. In one variation of the system, no clip is played at all.

If phone A or Phone B are mobile phones they may or may not support the following hardware and software features: 1) call started event, 2) call established event 3) Call completed event, 4) ability to respond to external (the handset) notifications 5) ability for an application to run periodically in the background, 6) ability to display information passively on the home screen, 7) ability for an application to ‘pop-up’ (to become visible and accept input) on the home screen from some event, 8) possess a notification bar that shows various events, 9) has the ability to expand on events in the notification bar, 10) has the ability for the user to run applications from a menu of application, 11) has a badge that can show a back-ground updateable number next to or over the entry in the menu of applications. 12) has the ability to record the incoming audio stream between the time an outgoing call is started (dialed) up to the point that the call connects (picked up by phone B) 13) has a call log table 1A, 3A or 5A. 14) The phone may broadcast data to another app. 15) the phone may store data to be picked up by other apps. 16) The phone has an address book (contact list).

Various methods will now be described for starting a ‘what I heard’ or ‘what I played’ process through to its display depending on some, none or all of the features existing on either phone A or phone B. The app also houses a local version of an RBT Authority 40.

Phone A or Phone B may house the ‘what I heard’ software apparatus (app) if there are sufficient hardware and software features to run the app and business rules dictate that the software apparatus be available on those devices. In another embodiment no software apparatus runs on the phone at all.

In one embodiment, if the ‘what I heard’ software apparatus is housed on a particular phone. It may also house a version of server 50, the audio match service.

In one embodiment a third party app, 95 may run on a phone A or Phone B. This app may exist on its own and read broadcast data from the ‘what I heard’ service on the phone or it may incorporate a binary version of the ‘what I heard’ service within itself.

Phones A and B contact a carrier network 10 or 20 to place and/or receive phone calls. Phone A and B are connected to the internet, 70. Through the internet it may contact the ‘what I heard’ server 30, any number of RBT Authority servers 40, the Audio processing server 50, phone number to carrier service 80, ‘Has App’ service 90, text message delivery service 97 and web server 98.

Notification service 60 may send asynchronous notifications to Phone A and Phone B. In turn, these notifications may originate from carrier networks 10 or 20, ‘what I heard’ server 30 or an RBT Authority server 40. Text messages may be received via text message service 97 which in turn originate from server, the ‘has app’ service 90 (described in inventor's concurrently filed application, entitled, “METHOD FOR EXCHANGING FILES OR MESSAGES WHEN ONLY ONE SIDE OF A CALL HAS AN APPLICABLE SOFTWARE APPLICATION,” inventor: Martin Gindi, attorney docket no. 82227.8003.US01, filed _{——————}, which is incorporated herein by reference in its entirety), or server 30. The on-phone version of the ‘what I heard’ service may provide ‘what I heard’ broadcast and data to third party apps 95 on the phone.

### Carrier Network 10 and 20

Carrier 10, and 20 are the phone switches, cell towers etc. that setup the real time voice connection between two phones and also play the ring-back tone. While server 40, the server that houses a user's RBT profile, may be ‘owned’ by a carrier for our purposes we consider it a separate entity from 10 and 20. For our purposes, Carrier network 10 originates a phone call from a Phone A. That call can go to a phone B on the same network or be routed to phone B on carrier network 20

If an RBT is played, it is played by the incoming side (phone B side) of carrier network 10 or by the incoming (phone B) side of carrier network 20.

Carrier Networks 10 and 20 may have Call Log tables 10A and 20A that may be, in some variations, accessed from phone A or B and Server 30 through an API. These tables contain lists of calls, incoming, outgoing and missed as recorded by the Network.

The incoming calls on phone B, whether on carrier 10 or 20 contact the phone to ‘ring it’ when an incoming call arrives from a phone A.

Carrier networks 10 or 20 my contact the notification service 60 to have it send notifications to phone A or phone B. In another variation, carrier network 10 or 20 may send notifications to server 30 which then forwards the notification to a notification service 60. Alternately, the Carrier network could send notifications directly to phone A or phone B

Carrier networks 10 or 20 may contact server 30. It also may have an active connection to a server 40 that is part of the carrier's corporate network.

Carrier network 10 or 20 may contact text message service 97 to send text messages to phone A or phone B.

Calls originated from phone A contact the carrier network to place calls.

### Internet 70

The internet 70 connects the phones, servers and services that comprise the system. IP or DNS names are used to establish connection sessions between entities. Once connected, illustratively, various protocols such as HTML get/put and XML are used to exchange data. Note that while servers 30, 40, and 50 show direct connections, these connections may or may not in fact route through the internet.

### ‘What I Heard’ Server 30

The ‘what I heard’ server 30 houses the ‘what I heard’ API service. Server 30 also houses the ‘track info’ API. It may house a local RBT Authority 40 as well as housing the audio match service 50. It also houses the offline processing application started in step 202E. The various APIs provided by server 30 are enumerated below

Server 30 contacts Notification service 80 that in-turn forwards these notifications to Phones A and B. In one variation these notifications may go directly to phones A and B. Server 30 uses phone number to carrier service 80 and the Has App service 90. It uses the Text Message delivery service 97 to send text messages to phones A and B. It contacts RBT Authority 40 for various services provided by the RBT authority and contacts the Audio Match server 50 as needed.

The services housed on server 30 are provided to phones A and B, RBT Authority servers 40, Carrier Networks 10 and third party apps and servers, 95

### RBT Authority 40

RBT Authority 40 are servers that provide RBT information through APIs. In one variation, these authorities provide information based on phone numbers and GPS unrelated to RBTs. The actual APIs provided by these servers vary according to each carrier and are discussed herein as illustrative examples. Examples include such things as a raw RBT record related to a phone B, a full ‘what I heard’ determination given phone A and B, track-info information, track clips and carrier customer log-ins. The system is designed to interface to a broad range of the specific APIs provided by an RBT Authority, however, a list of broad requirements for RBT Authorities connected to the system are enumerated below.

As noted, while there may be a one-to-one relationship of RBT Authorities to Carrier Networks 10 and 20, the system treats them as logically distinct. They may communicate at will. An RBT authority 40 houses the API services it provides. It may also physically house all ‘what I heard’ services provided by server 30 or 50.

As part of housing the ‘what I heard’ service 30 it may contact all the entities described with server 30 above. Additionally it may contact the notification service 80 on its own volition to send notifications to phones A and Phone B.

The API services provided by an RBT Authority are accessed by phones A and B and Server 30. In one embodiment they may also be accessed from the third party App or Service 95.

### Notification Service 60

The Notification Service 60 is a service provided by third parties such as phone manufactures or carriers that forward notifications from third party servers (such as server 3) to send asynchronous notifications to apps residing on Phones A or B. Often, the apps on phones A and B register that they allow notifications to be sent to it. Notifications may be implemented between the notification service 60 and phones A or B in many different ways, illustratively as polled TCP/IP sockets or as text messages. The system however is designed to operate with all services

In one variation, certain phone models allow the server to send notifications to phones A or B directly without an intervening notification service. In another variation, notifications may be sent directly between phones.

The notification server 60 houses the notification service. The notification service 60 sends notifications to phone A and Phone B

The API to send notifications is contacted by servers 30 and 40 and Phone A and Phone B as well as Carrier networks 10 and 20. The API to register notifications is sent from phone A and Phone B. It may also be sent from servers 30 and 40 as well as Carrier networks 10 and 20

### Phone Number to Carrier Service 80

The phone number to carrier service is provided by third parties to all applications and servers to determine the carrier associated with a particular phone number. This same service may also include device information such as the make/model of the phone as well as things such as screen size and other hardware capability. These services are updated frequently to keep up with the fact that a user may move his or her phone number to other carriers. The system is designed to operate with all services.

Phone Number to Carrier server 80 houses the Phone number to carrier service.

Service 80 does not contact any other entity in the system.

Phones A and B and servers 30 and 40 (when the server 40 houses the services of server 30).

### Has App Service 90

The system uses a ‘has app service’ 90 to determine if one or both of phone A or phone B has the appropriate ‘what I heard’ software apparatus installed, and if not, if the phone is capable of running this app.

The ‘has app’ service also delivers device information to server 30, that is information specific to the hardware/software on phone A or Phone B allowing it to make more informed in decisions about delivering information to the phones. As an example, it may decide that a device supports ‘notification bar only’ and does not support ‘widgets’, in which case the ‘what I heard service’ would send a notification to the phone.

The ‘has app’ server 95 houses the ‘has app’ service.

The ‘has app’ server contacts the text message service 97 and notification service 80 to send alternate deliveries to phones A and Phone B. It also refers in some of these notifications to web server 98. Additionally, internally it contacts the phone number to carrier service 80 and may pass some of this information to any server that uses its services (to save money by not calling the phone number to carrier service twice for the same phone number)

The ‘has app’ service is contacted by server 30, Phones A and B and servers 30 and 40 (when the server 40 houses the services of server 30).

### Third Party App or Service 95

A Third Party server or app on a phone may use the ‘what I heard’ services and APIs of an RBT Authority. They are shown in the system to illustrate that they may access the services.

These third party apps or services may be housed in separate servers or they may reside on phone A or phone B. When they reside on a phone they may use the data and broadcast methods of the ‘what I heard’ service or they may incorporate binary versions of the ‘what I heard’ service within themselves.

When the ‘what I heard’ service is incorporated within the third party app, it may access all the services and servers that the on phone ‘what I heard’ service may access. It may register for broadcast information from ‘what I heard’ services broadcasting on this phone.

In one variation, when the ‘what I heard’ service is incorporated into the third party app, it may receive notifications from the notification service 80.

### Text Message Delivery Service 97

The text message delivery service 97 delivers text messages to phones A and B on behalf of a server.

The text message delivery server 97 houses the ‘has app’ service.

Server 97 directly sends text messages to phones A and B.

Server 97 is used by the ‘has app’ service 90 to send text messages to phone A and B. In another variation the ‘what I heard’ services sends text messages via server 97 to phones A and B

### Web Server 98

Web server 98 is referred to by text messages sent by the ‘has app’ service and by phone number variation schemes described below for phones that do not have access to their own phone numbers.

The web server, in the exception case, contacts server 30.

Phones A and B contact this server to see web pages.

### Audio Match Server 50

The Audio Match Server provides an audio match service between clips recorded on phone A or phone B during ring-back time against various sets of referenced audio clips stored in table 51. It provides an API to do so as described below.

The Audio match service may be housed on server 50 or it may be housed on phone A or B as well as on server 30. It may also be housed on server 40 when server 40 hosts the ‘what I heard’ service.

The audio match server may contact a server to get referenced audio clips. These clips may be housed on server 30 or 40.

The audio match service may be accessed from phones A or B, server 30 or server 40 when it houses service 30.

### PBX 98, Employee Handsets 981, Automated DTMF or Voice Recognition Element 982 and Automatic Outgoing Voice Service 984

The Private Branch Exchange, PBX 98 is a private switch that routes to ‘extensions’, generally handsets 981 within a company or other organization. These handsets are alternate ‘phone B's in our system. The carrier network 10 or 20 connects phone A to a PBX by use of a global phone number. Most PBXs today use a DTMF (phone pad) or voice recognition system 982 to further route the call from phone A to an employee or other member of an organization possessing a handset 981. In one variation, the person on phone A may only interact with 982. As an illustrative example, 982 any be an automatic account system that verbally tells you your bank balance. In this case, 982 would be considered a Phone B.

It should be noted that a ringback tone is played exclusively during the ringback period by carrier 10 or 20. Once connected to a PBX, the ringback period is over and any audio heard on handset 10 comes from the PBX and is not a ringback tone for our purposes.

It should be noted that the person at handset 981 may also act as a phone A, calling out to out to a phone B at the other end of a carrier network In this case, either a ‘direct dial’ number is shown as the incoming phone number on phone B or some general PBX number may be shown. Additionally, the PBX may provide services whereby it calls out automatically and plays automated audio, this acting as a phone A. (i.e. 982 would act as a phone A)

The PBX keeps information about calls in table 983. This information includes routing information, e.g. the handset 981 that phone A or the call out to phone be was connected to.

As with Carriers 10 and 20 relations to server 40, the PBX provides a front end server that allows access to call information that may or may not be physically part of the PBX. Server 40 in this case takes as input phone A's phone number, and possibly other identifying information such as a timestamp and provides information stored in 983 about the call.

The PBX may contact the notification service 60 to have it send notifications to phone A or phone B. In another variation, the PBX may send notifications to server 30 which then forwards the notification to a notification service 60. Alternately, the PBX could send notifications directly to phone A or phone B. These may be done through internet 70

The PBX may contact server 30. This may be through internet 70

The PBX may contact text message service 97 to send text messages to phone A or phone B. This may be through internet 70

1.b. Database Tables and API Return Values

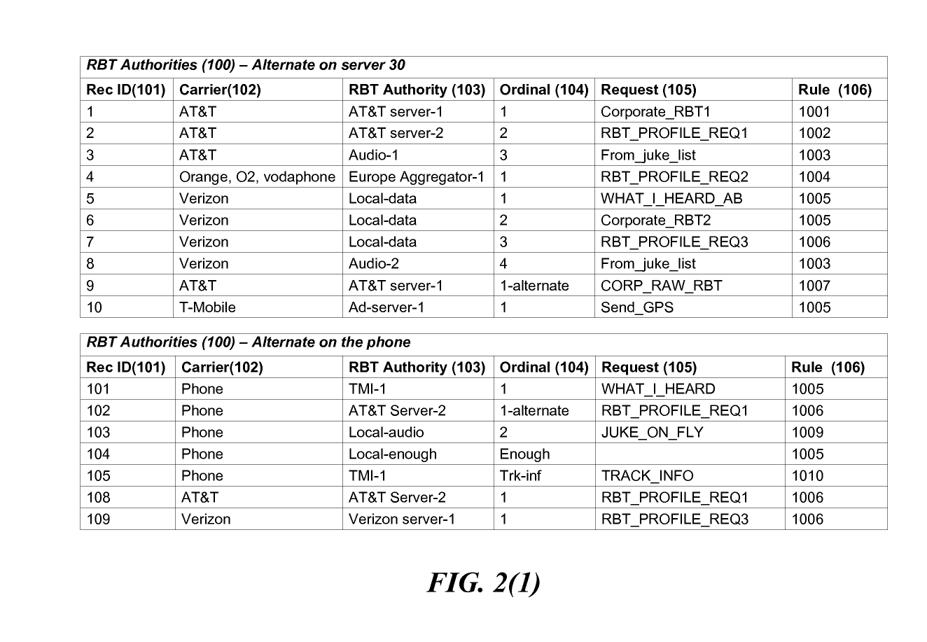

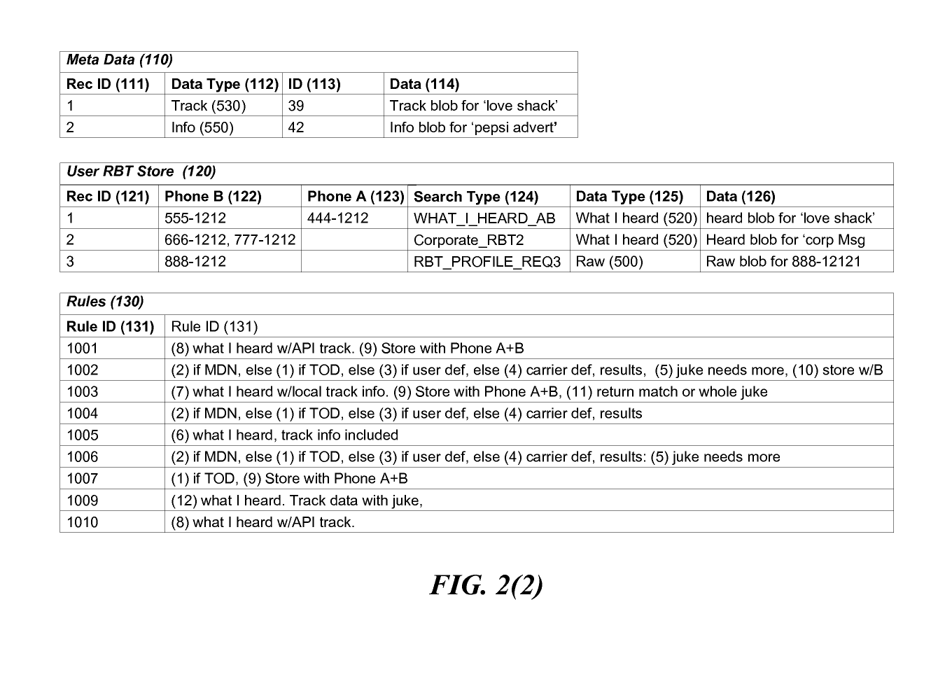

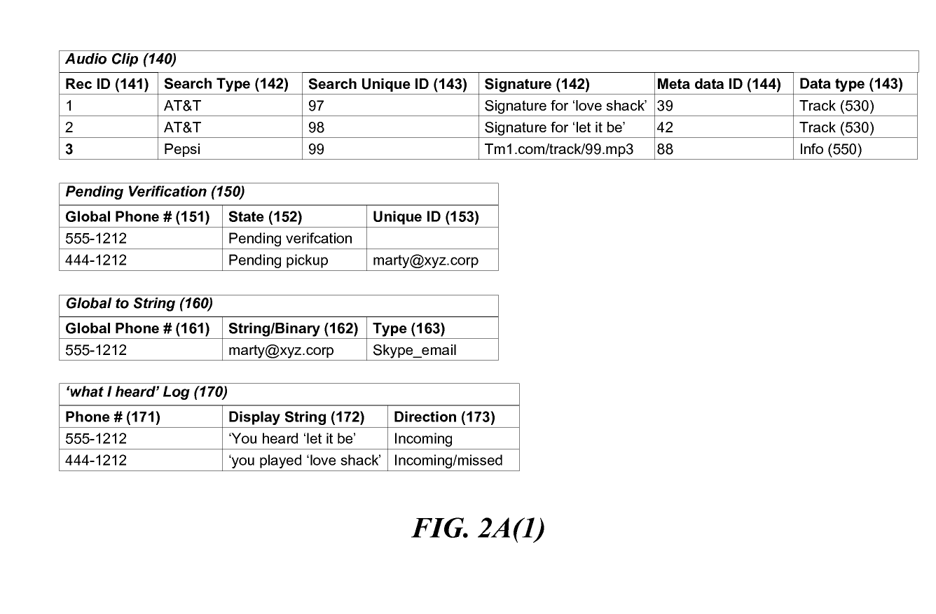

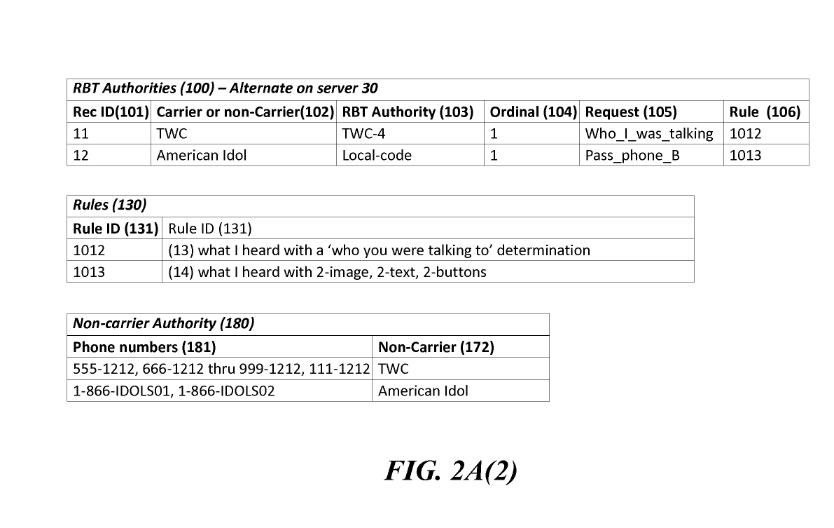

FIG. 2 shows the columns of database tables as they exist on server 30. As shown in FIGS. 1a, 1b and 1c though, there are equivalent tables on server 40. The system is not concerned with the structure of these tables on 40 and is shown for illustrative purposes only; server 30 indicates retrieves data from these tables via API to 40.

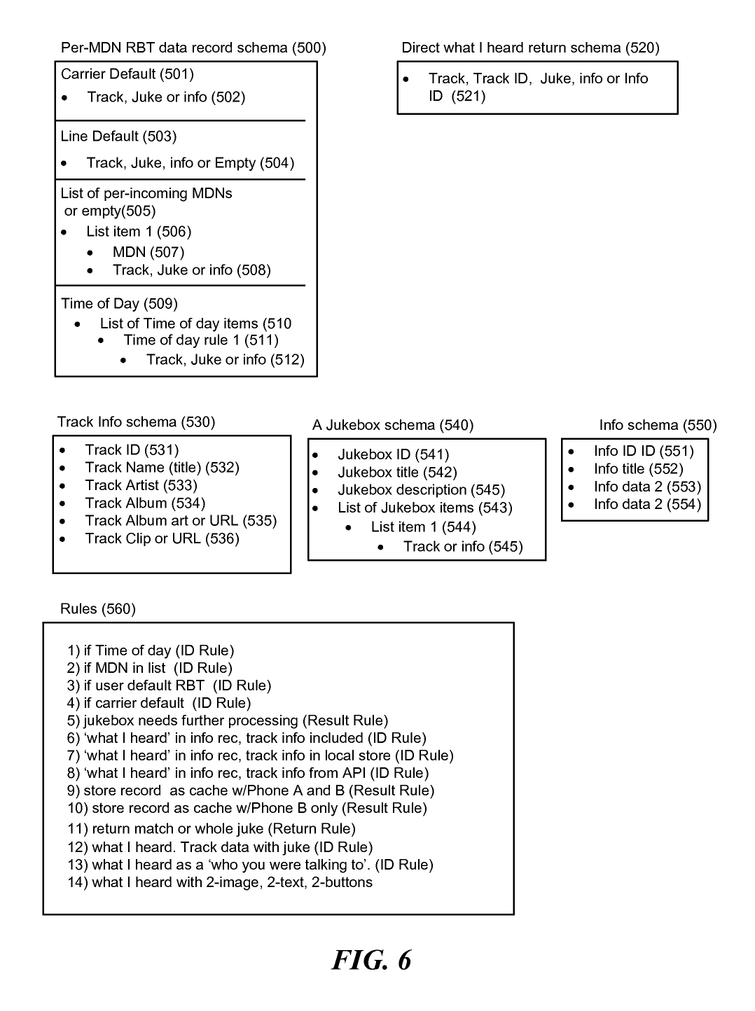

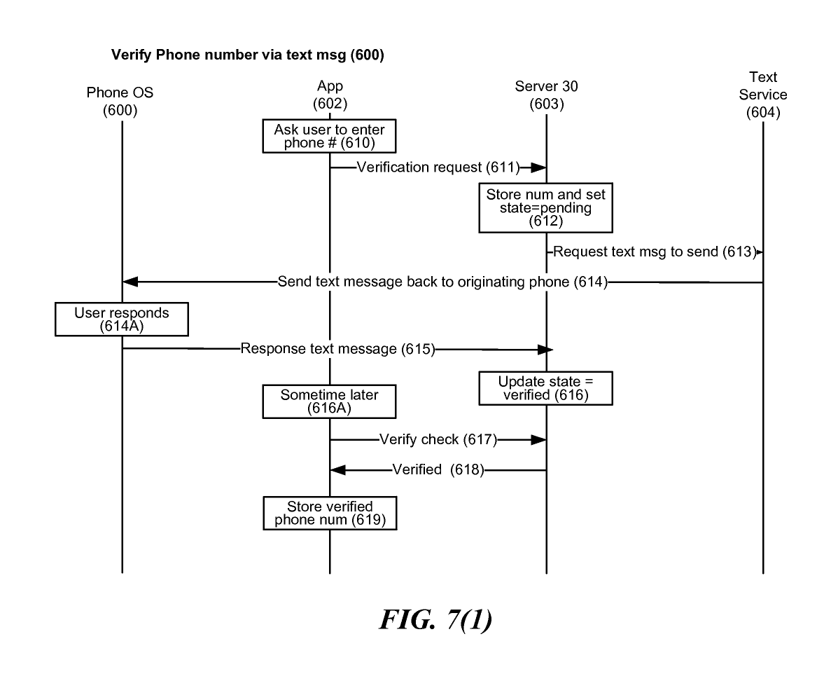

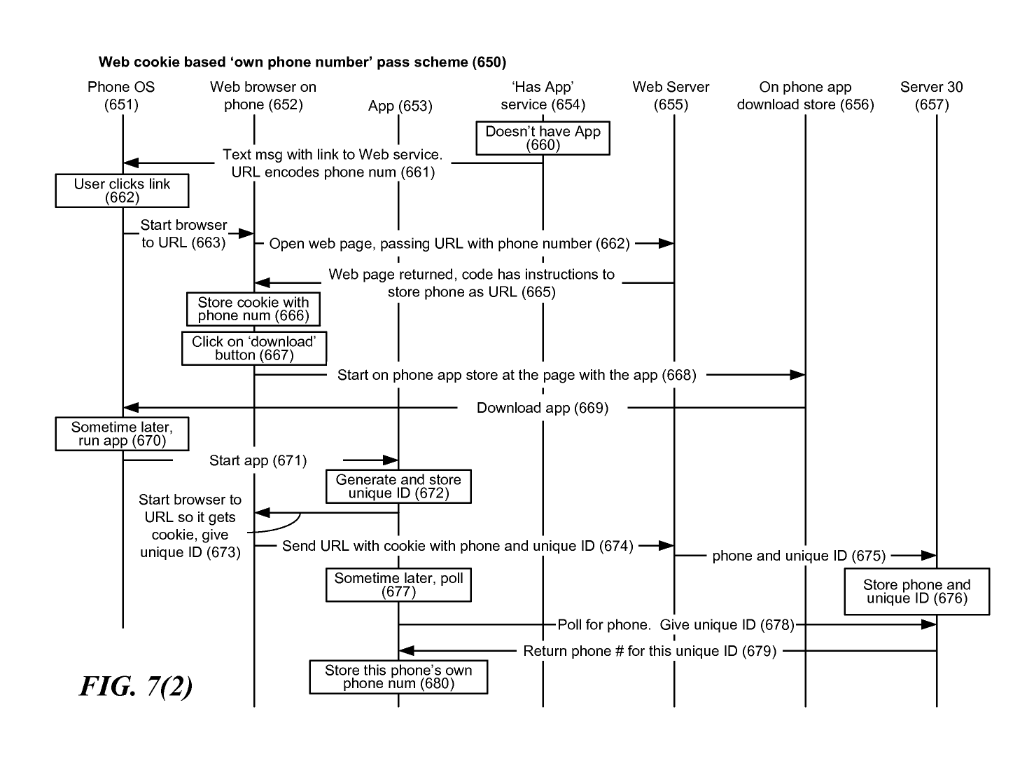

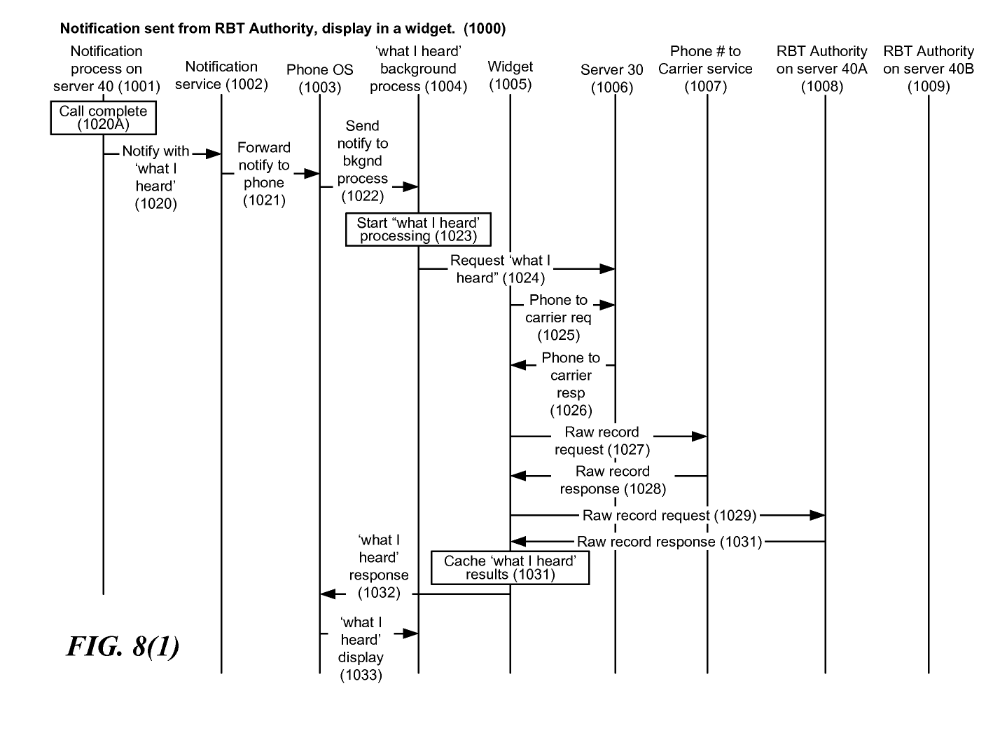

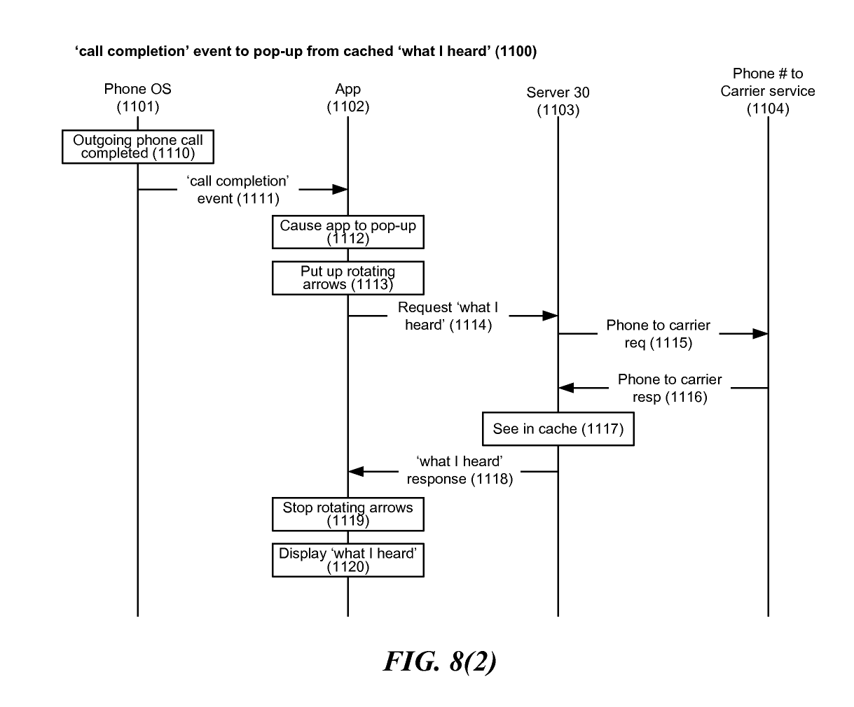

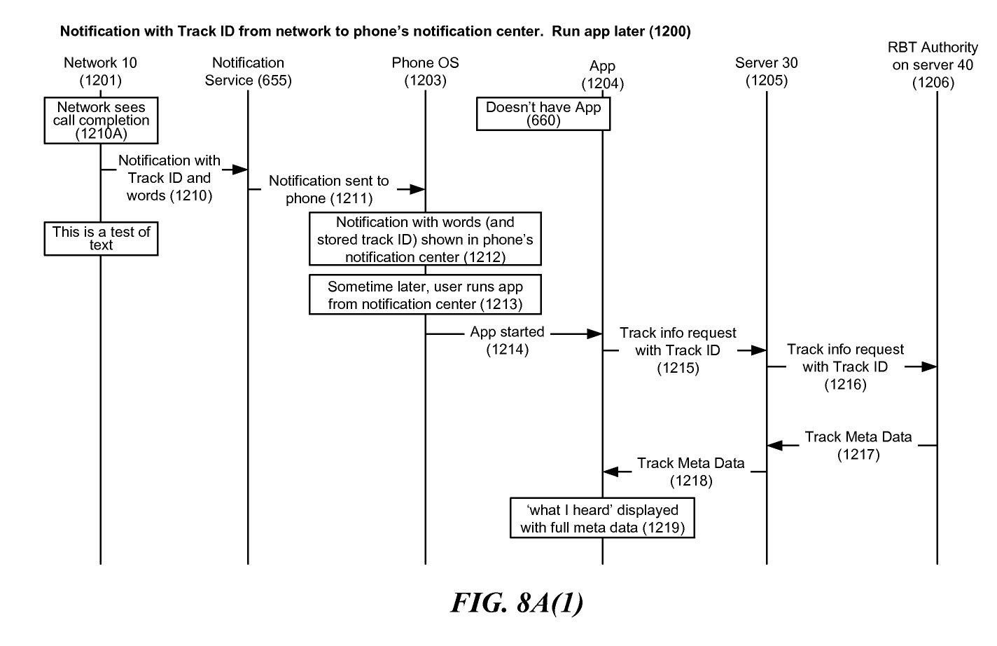

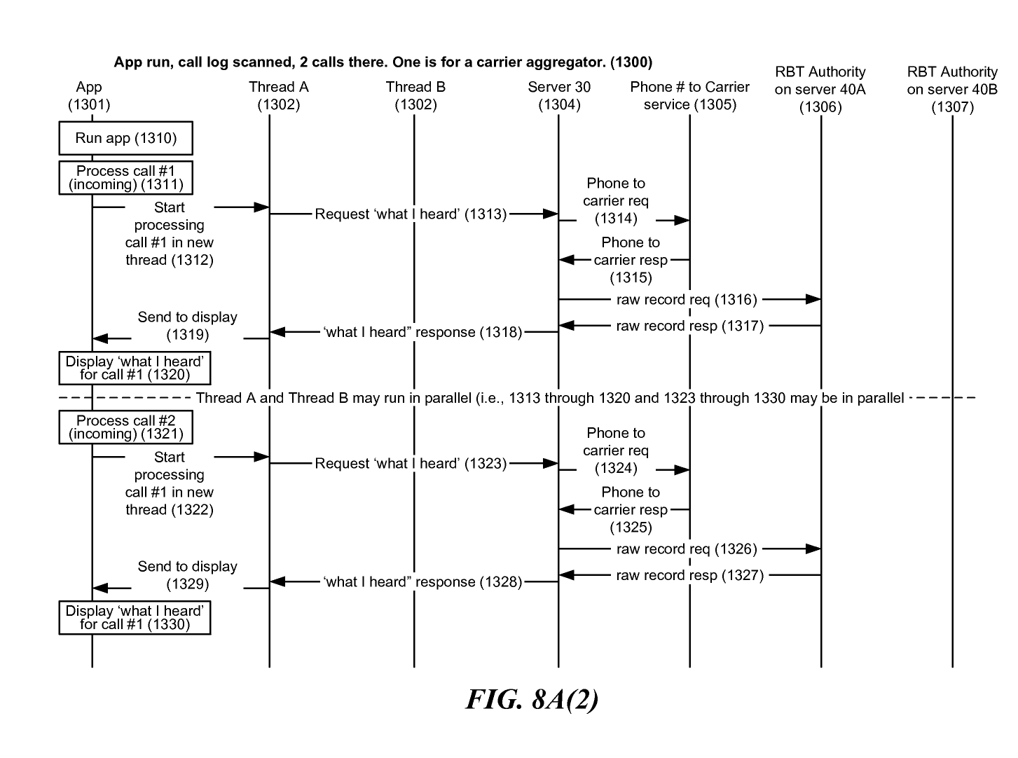

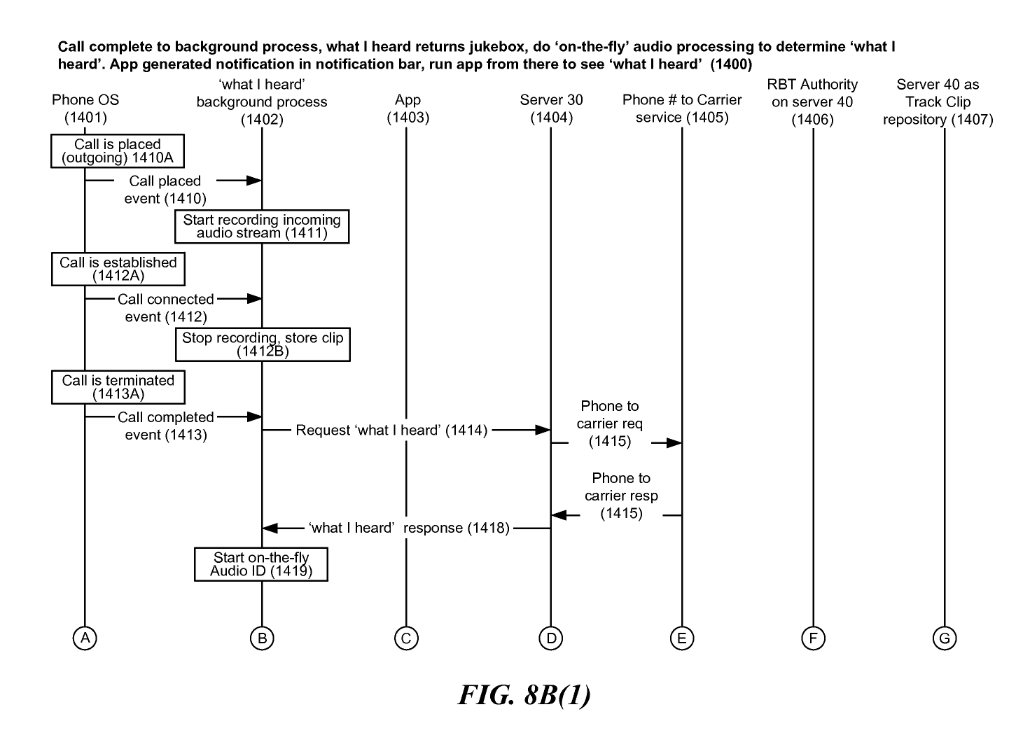

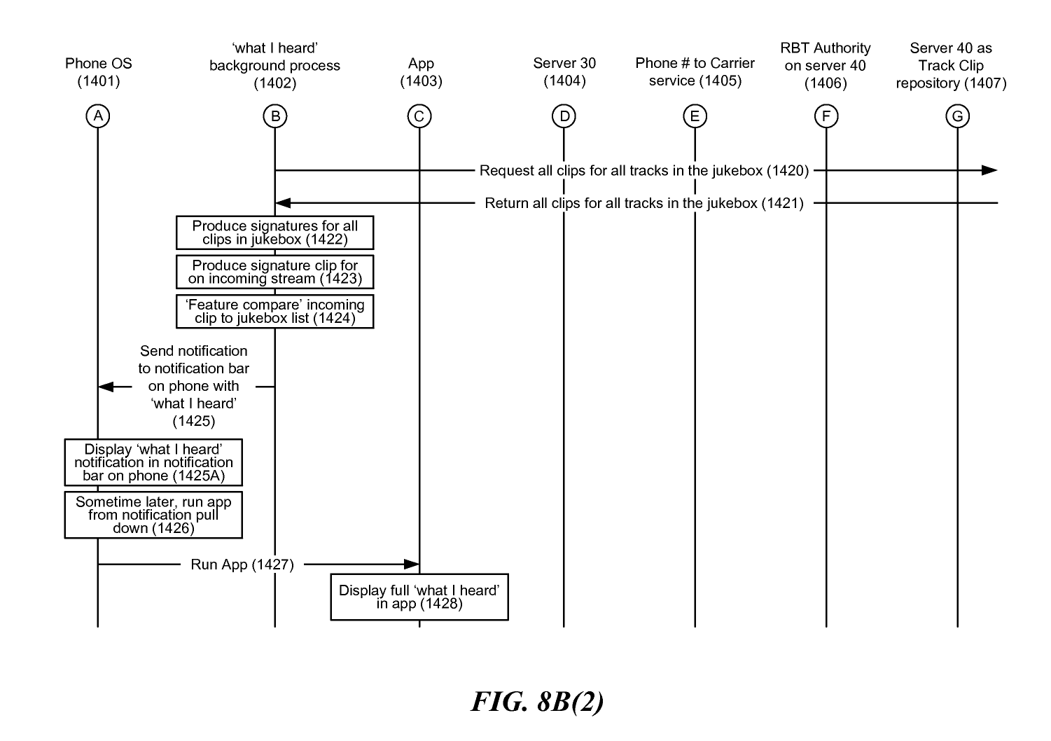

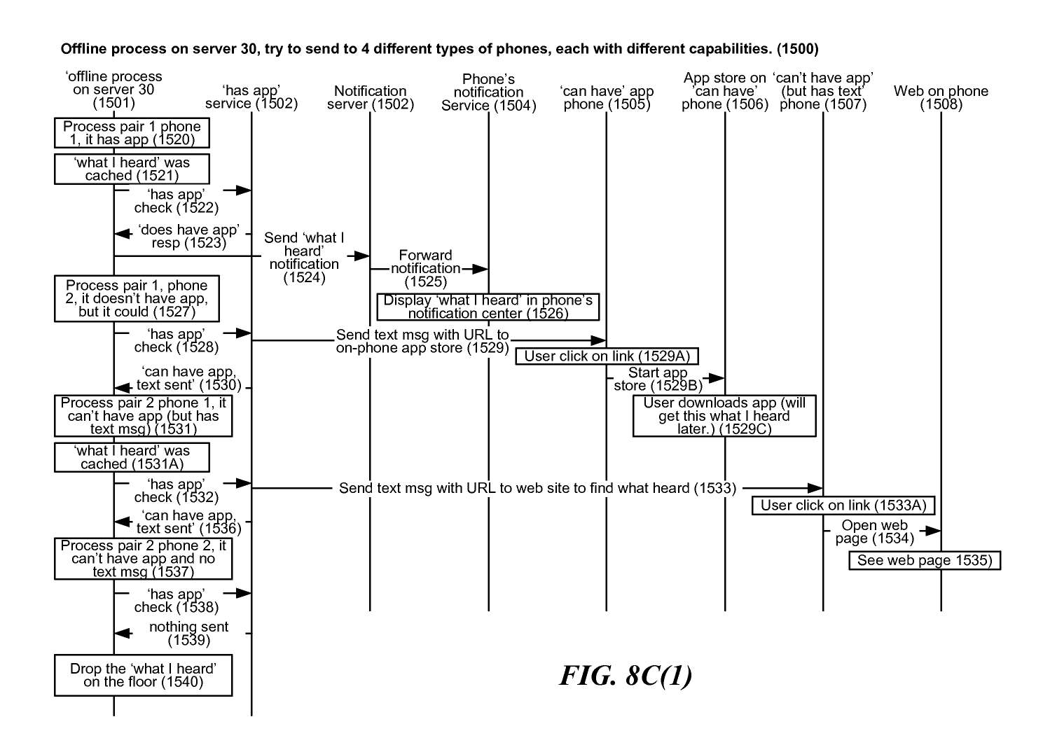

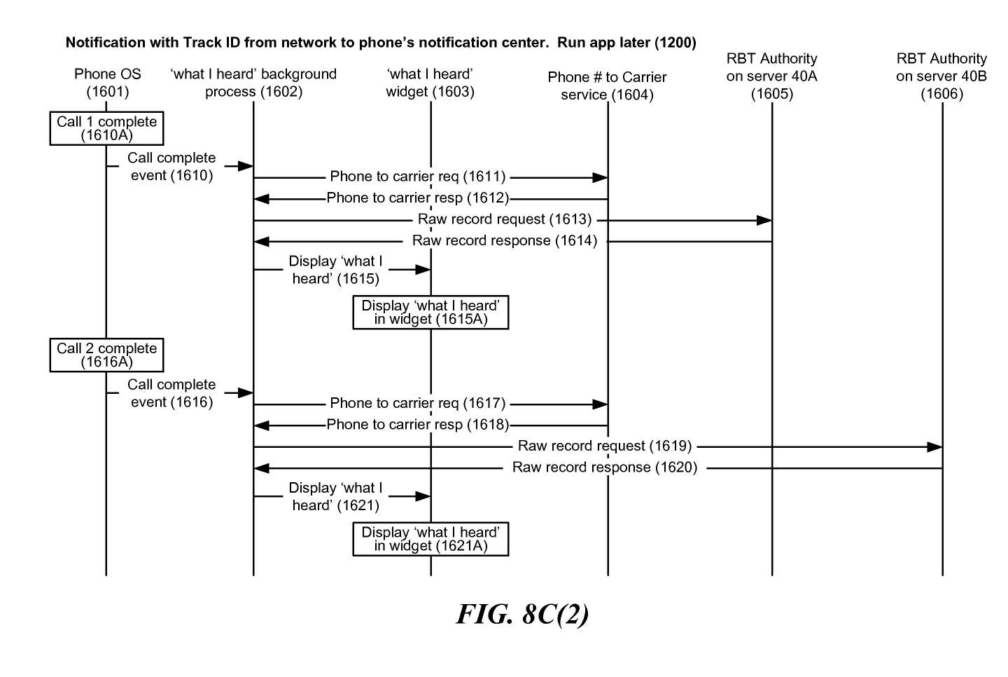

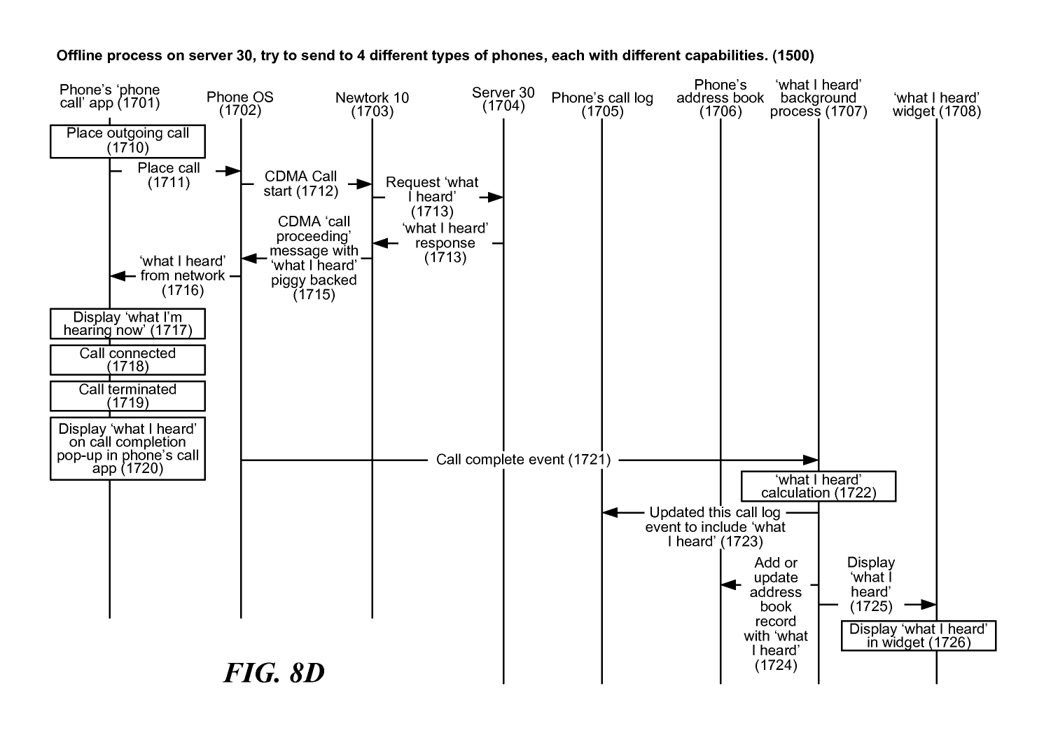

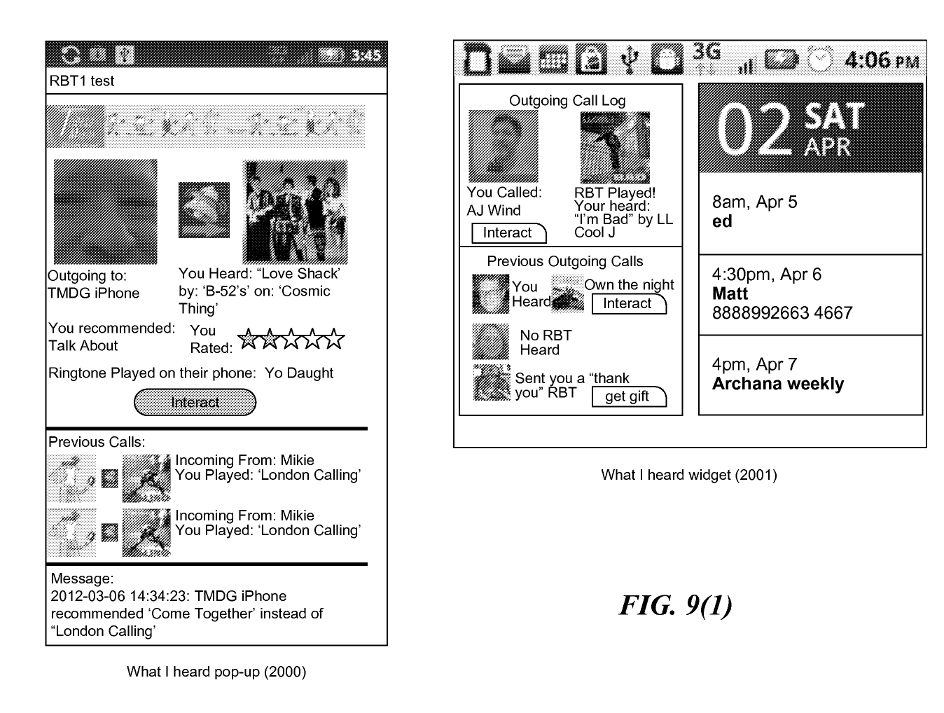

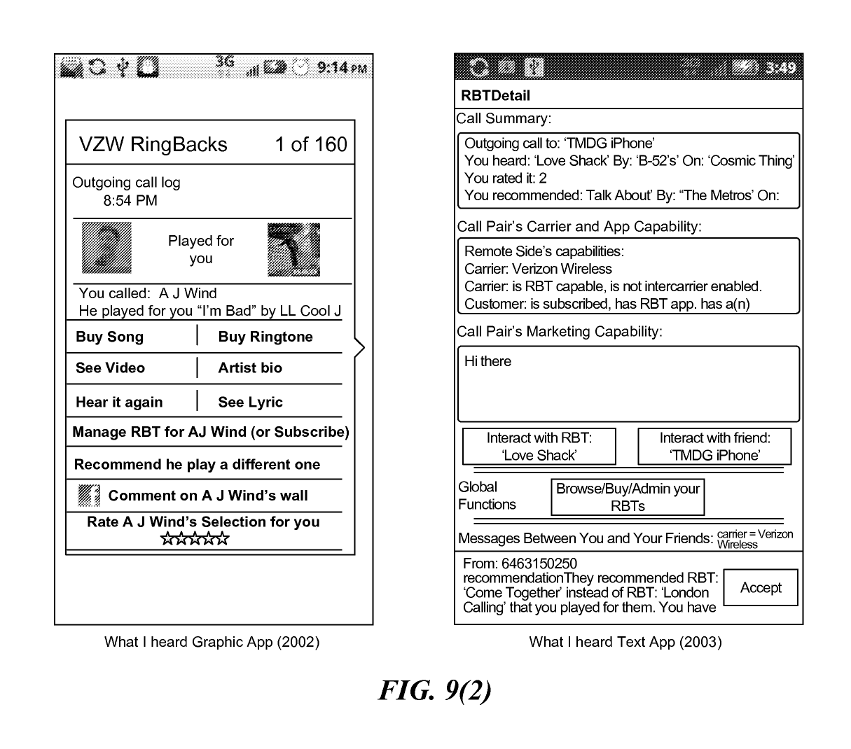

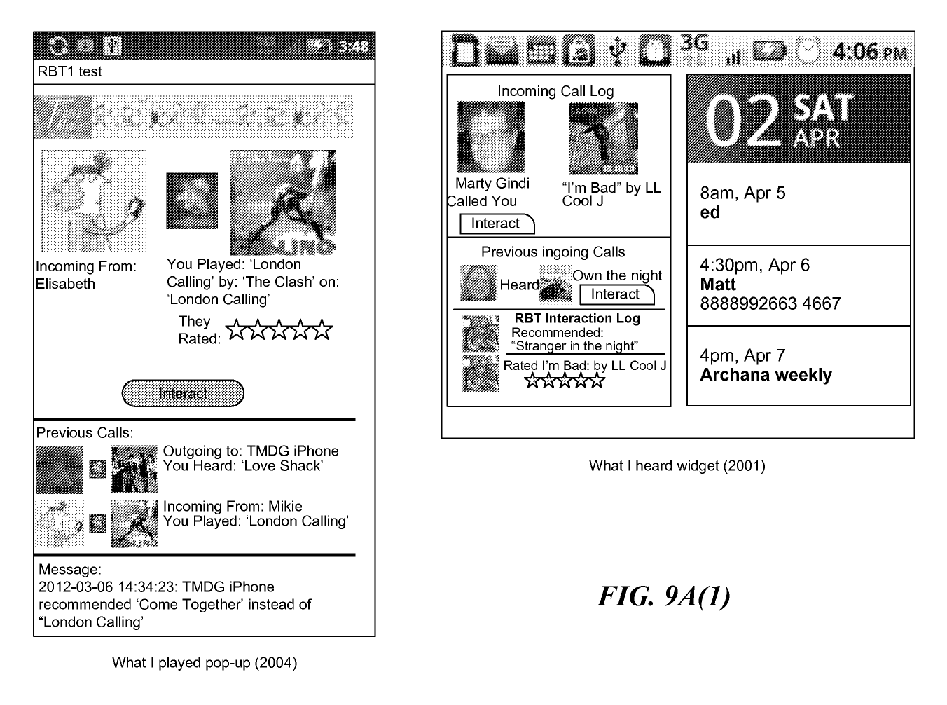

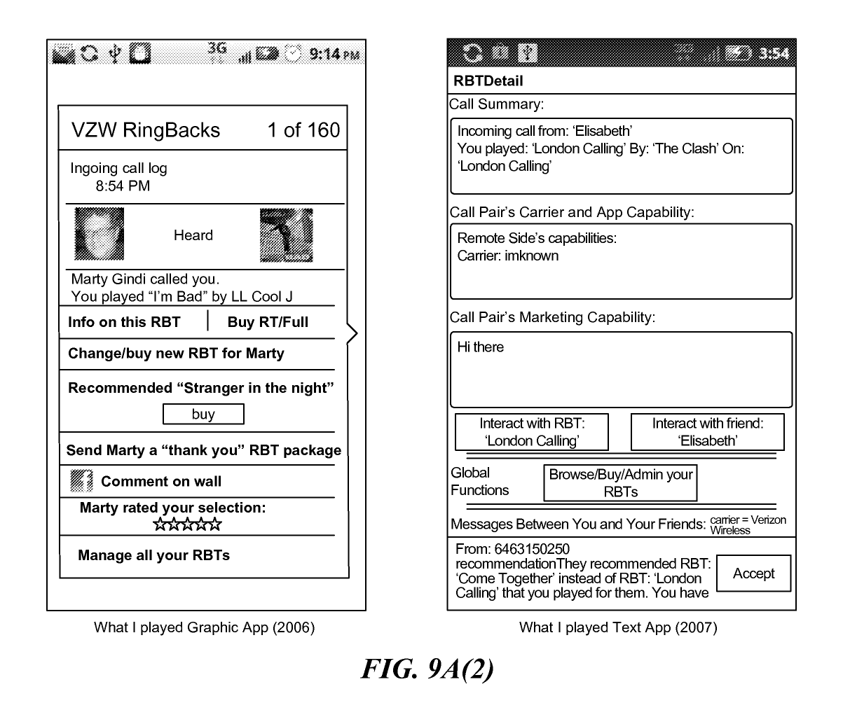

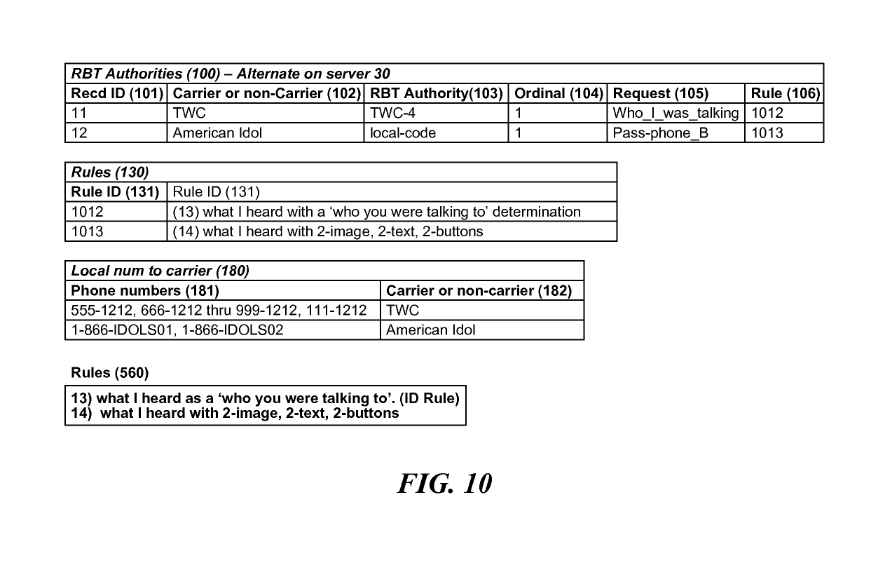

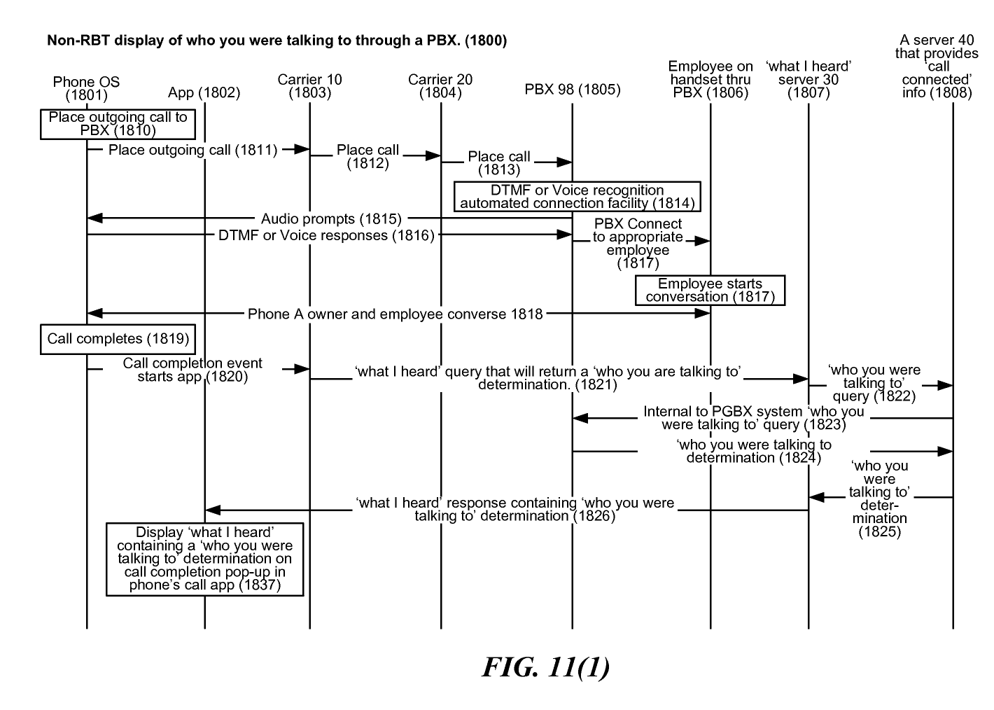

FIG. 6 show illustrative API returns from raw data and ‘what I heard’ calls from server 30 to server 40. These show a typical return value. These illustrative return values also describe the abstract data stored in certain columns of table on server 30. Indeed the actual return values from API calls are sometimes stored in these tables.

Each section here will describe detailed illustrative rows in these tables

RBT Authority info (100) (physical table 31 and optionally, 1B, 3B and 5B). This table allows server 30 or phones 1, 3 or 5 to contact various RBT authorities. When used for non-RBT determinations this table is referred to as an ‘information authority’. RBT and information authorities differ only in nomenclature and not their methods. These authorities may be located on phones 1, 3, 5, server 30 or server 40. The table is accessed by carrier name as returned from the phone number to carrier service 80 or may be accessed without carrier name. Server 30 or phone 3 or 5 then obtains records with increasing ordinals, one at a time, until one of the authorities returns a ‘what I heard/played’ success.

Column 101, record ID, is a simple sequential number referring to this row in the table. Column 102, carrier, the carrier for this record and if carrier is searched may match the carrier being requested. Multiple carriers may be listed in this column as belonging to this RBT Authority. Column 103 is the RBT authority to be used in this record. It contains an address if the server is remote: (e.g., AT&T RBT Server 1), or it may indicate an Audio match service to contact, or it may indicate ‘local-data’ in order to access the local user RBT Store table 33, ‘local-audio’ to use a local audio match service, ‘local-enough’ indicating that there is enough track data in a ‘what I heard’ determination or ‘local-code’ indicating that a software apparatus local to server 30 is to be used as the RBT (or information) authority. Column 104 is the ordinal for this RBT authority for this carrier (i.e. they repeat for each carrier or aggregator); the service will try Authority #1 first and try it, then #2 and so on. Column 104 may also contain special codes for special actions including: ‘have enough’ and ‘track-info-API’ for use when the table resides in 1B, 3B or 5B. Column 105, request, is an abstract field that contains the request to be asked of the authority, examples include ‘ask for corporate RBT’, ‘obtain RBT profile’, or access local table looking for ‘type=corporate_RBT’. Column 106 is a pointer to a rule in table 130. These are the rules to apply to records retrieved from an RBT Authority.

FIG. 2 shows table 100 filled with a number of illustrative examples.

Record IDs (101) numbers 1, 2 and 3 are a set of three RBT Authority records for a carrier caller ‘AT&T’ (all column 102 are set to AT&T). Record ID=1 would be used first as its ordinal (104) is 1, record ID=2 next and record ID=3 after that. Each record would either produce a ‘what I heard result’ or the system would then try the next.

Record 1 is for a corporate RBT check. As an illustrative example this type of RBT a large group of phone numbers belongs to a group that has particular rules for those phones. Many of these put a corporate announcement on a line, say at 9-5 on Monday through Friday, allowing a user's individual RBT to be played at other times. column 103 indicates that this check is available on RBT Authority ‘AT&T Server-1’, column 105 indicates that an API request should indicate ‘Corporate_RBT1’ so that the server know to return that record. Column 106 points to rule record 1001 in 130, rule 1001 indicates that a ‘what I heard’ is returned, that the track Metadata be retrieved via API and that the record be stored in 120 for cache purposes

Record 2 is the next AT&T RBT authority to be tried should AT&T ordinal 1 fail (i.e. the number is not in the corporate list or the time of day does not require the ID to be played). Record 2 allows for access to phone B's raw RBT record in order to calculate an RBT heard/played. Column 103 indicates server ‘AT&T server 2’ should be used. Column 105 indicates that the API should request ‘Raw RBT profile’; column 106 indicates rule 1002 in table 130 should be used. This rule has a set of rules that define how to process the retrieved raw RBT record. This rule would return the RBT heard/played, however, this rule also states that if a jukebox is determined, then go on to ordinal 3.

Record 3 is performed if a jukebox was returned in ordinal 2 to cause an audio match on the small set of possibilities in the jukebox. If a match occurs it is that track, if not, we return the jukebox anyway. Column 103 indicates to use ‘audio-1’ match server that contains the clip signatures for AT&T. Column 105 has server 30 asking a server 50 to process a jukebox, (as say opposed to a match over the whole catalog). Column 106 points to rule 1003 in table 130. Rule 1003 states 1) if there is an audio match return it, if not, 2) return the original jukebox as a match.

Record 4 shows a carrier aggregator that is an RBT authority that supports multiple carriers; this aggregator returns raw RBT records. There is no secondary RBT authority. Column 102 indicates that three carriers match this RBT Authority, ‘Orange’, ‘O2’ and ‘vodaphone’. Column 103 indicates if any of these are matched go to RBT Authority ‘Europe aggregator-1’. 105 asks for a raw profile and 106 uses rule 1004. That rule is the same as rule 1002 in record 2 above, except that it doesn't allow for Jukebox processing by an audio service. It also gets Metadata from table 110

Records 5, 6, 7 and 8 are a set of records for a carrier ‘Verizon’ that is processed locally on server 30 with access to table 120 (and on the audio server) rather than going to a remote RBT authority.

Record 5 is a ‘what I heard’ cache check, it uses both phone A and phone B to access table 120 to find a recent determination of ‘what I heard’. Column 103 is set to ‘local-data, column 105 is set to ‘What_I_Heard_AB’ which can be used as the search type key for column 124 in the User RBT Record table (120), and column 106 would use rule 1005, that rule, unlike rule 1001, indicates the track Metadata is stored with the record that will be retrieved from 120. Also that it should not store the data in 120 (which would result in the retrieved record being stored again.)

Record 6 is equivalent to record 1, except that it a) indicates to search local table 120 for type ‘VZW Corp.’ (column 103 is set to ‘local-data’, column 105 is set to ‘VZW Corp.’). and 2) it uses a rule 1005, the same rule as was described with record 5 to get the ‘what I heard’ directly and not store it.

Record 7 is equivalent to record 2, except it indicates in column 103 to search for search type ‘RBT_PROFILE_REQ3’ in table 120. Rule 1006 differs from rule 1002 only in that it does not store the retrieved record again in 120.

Record 8 is exactly equivalent to record 2 (except it is for Verizon.)

Record 9 demonstrates a raw corporate record that has a time-of-day rule. It is an alternate ordinal 1 for AT&T. Here, in column 105, a raw corporate record CORP_RAW_RBT is made. Rule 1007 indicates to use the only the TOD rule in the retrieved raw record. It then stores this raw record as A/B for cache purposes.

Record 10 demonstrates an “enhanced RBT housed at an external carrier. Here the T-Mobile server ‘Ad-Server-1’ is accessed after a call. The user would have heard an RBT at the beginning of the call, say about Pepsi. The current GPS location of the phone, along with Phone A, Phone B and direction are sent with request ‘Send_GPS’ in column 105. It is possible that the carrier employs a third party RBT advertisement content and that server 40 contacts (or is) a server provided by that third party to process advertisement requests. That relationship is out of the scope of this disclosure. The server returns info about an advertisement that is based on the GPS value and Phone A and B values. Rule 1005 is used since the format of the return resembles a ‘what I heard’.

Record 11 shows querying a Server 40 associated with a PBX. Here, phone A would have been talking to a customer service rep through Time Warner Cable's (TWC) PBX. The ‘what I heard’ query here would return, as an illustrative example, the company name, the name and photo of the customer service rep and a way of calling this customer service rep directly. This record 11 in table 100 contains information needed to contact the appropriate server, in this case server TWC-4. The record also indicates that a ‘what I heard’ determination is expected. Record 11 further refers to rule 1012 (column 106), referring to table 130 which then refers to rule ‘13’ in rule list 560. This rule says to expect a direct ‘what I heard’ determination with ‘who you were talking to’ Metadata.

Record 12 shows a local software apparatus delivering non-RBT metadata related to a particular phone number. This illustrative example shows calling an American Idol voting line that registers a vote for a particular contestant. After the call, the ‘what I heard’ software apparatus will thank you for voting for that individual and allow you among other things to download the song the contestant just sung. The second record in Table 180 contains the illustrative record for any phone A calling this phone B, in this case it is voting for a particular ‘American Idol’ contestant using one of two 1-800 (866) numbers assigned to vote for that particular contestant. Table 181 contains this list of phone numbers used to vote for this contestant. Column 182 has a key that will be used to access table 100, record 12 (in FIG. 10). This record 12 in table 100 indicates that the local-to-server-30 software apparatus be contacted (via the special value ‘Local-code’ in column 103) and that it need only pass ‘phone b’ (request column 105). The record also indicates that a ‘what I heard’ determination is expected. Record 12 further refers to rule 1013 (column 106), referring to table 130 which then refers to rule ‘14’ in rule list 560. This rule says to expect a direct ‘what I heard’ determination with a generic set of data to display, in this case it has two images, two sets of text and two action URLs connected to two buttons.

Records 101 to 105 are a special set of records illustrative of when the RBT Authority table resides in 1B, 3B or 5B, that is, when the table resides on a Phone A or a Phone B. when table 100 resides on a phone, illustrative records 1 through 8 would not be there, and conversely, records 101 to 105 would not be in the table when it resides on server 30. All records have column 102=‘phone’

Record 101 instructs the phone to determine ‘what I heard’ by calling the ‘what I heard’ service on server 30. Column 103 indicates the server 30 to contact, ‘TMI-1’. Ordinal (104) is 1 (note, in our illustrative example record 102 is an alternate ordinal 1, either record 101 or 102 would be on a phone). Column 105 indicates that the phone will use server 30's ‘what I heard’ service that takes Phone A, Phone B and direction as input, and returns ‘what I heard/played’ to the phone. Column 106 indicates that rule 1005 would be used to interpret the results (a ‘what I heard’ is expected with track info and it is not to be stored)

Record 102 is an alternate record to 101, it indicates that a server 40 be contacted directly to get the raw record for Phone B (from both a phone A and a Phone B). Column 103 indicates that ‘AT&T server 2’ is contacted. The ordinal is 1. Column 105 indicates that the phone will request a raw record from AT&T server 2. Column 106 indicates that rule 1006 would be used to interpret the results (Raw record processing with a failover to audio processing)

Record 103 provides this audio processing local to the phone using on-the-fly signature processing of the returned tracks in the jukebox in record 102. Column 103 indicates that ‘local-audio’ be used. The ordinal is 2, following record 102 (it could also follow on to record 101 when the API call in 101 returns a ‘juke, on-phone-audio requested’ value). Column 105 indicates that ‘juke-on-fly’ (jukebox on the fly) processing be performed. Column 106 indicates that rule 1009 would be used further process the returned matched track. Record 1009 indicates that ‘what I heard’ comes from audio processing and it should get Metadata from the returned jukebox in ordinal 1.

Record 104 is a special record relevant to the phone only it is an RBT authority specifically searched for by the software apparatus on the phone to process events 202B that contain all the Metadata information needed in the event. Column 103 indicates ‘local-enough’. The ordinal (104) is ‘enough’, the special search value. Column 105 indicates that ‘enough’ be performed. Column 106 indicates that rule 1005 would be used to interpret the results (a ‘what I heard’ is expected with track info and it is not to be stored).

Record 105 is a special record relevant to the phone only it is an RBT authority specifically searched for by the software apparatus on the phone to process events 202B that contain no Metadata for the ‘what I heard’ included in the event that only had a trackID and that server 30 needs to be contacted to return the Metadata associated with the trackID. Column 103 indicates that the server TMI-1 needs to be contacted. The ordinal (104) is ‘track-info’. Column 105 indicates that the ‘track-info’ API be used when contacting server TMI-1. Column 106 indicates that rule 1010 would be used for this ‘what I heard’ (use API for track info, no store).

Records 108 and 109 are used when the phone goes directly to a RBT Authority 40 (rather than through 30). The ‘what I heard’ software apparatus on a phone that does this is modified to contact the phone number to carrier service 80 to obtain a carrier for the other side of the call. This is then used to search the RBT Authority table on the phone. For record ID=108, column 102 indicates ‘AT&T’. The rest of this record is equivalent to record ID=102. For record ID=109, column 102 indicates ‘Verizon’. The rest of this record is equivalent to record ID=7

RBT Metadata (110) (physical table 32). This table stores data describing a particular RBT of varying types. Examples include Music RBTs, Advertisement RBTs and jukeboxes, arbitrary collection of various types of RBTs that may be played in some (usually random) order.

Column 111, record ID, is a simple sequential number referring to this row in the table. Column 112 contains the type of Metadata contained in the row. Examples include ‘music track’ and ‘info’. These are schemas that describe the method of decoding data in column 114. Examples of these schemas are 530, 540 and 550. Column 113 is some unique identifier for this record. Accesses to 110 are generally done with a combination of both column 112 and 113, e.g. Music track, ID=999. Column 114 is the Metadata itself.

This table is populated from large data transfers from carriers and RBT audio clip providers. It may also be populated by caching the API return values from various calls to server 40. It may also be populated manually.

FIG. 2 shows table 110 filled with a number of illustrative examples.

Record 1 of table shows music track data. It would be accessed in this case when an audio match returned a music track Column 112 indicates ‘track data’ as the type. Column 113 has a unique id, in this case ‘39’, and column 114 has the actual data in the form of 530. It contains the track title (532) artist (533), album (534), album art (535) and the audio review clip (536)

Record 2 has the info needed for an advertising clip. Column 112 indicated ‘info with URL’, 123 has a unique ID, in this case ‘42’, and column 114 has the actual data in the form of 550, in this case 553, the ‘info’ is a URL ‘www.pepsi.com’

User RBT Store (120) (Physical table 33 and 3D and 5D). This table stores information related to a user's RBT. It may be raw or ‘what I heard’. The table allows for multiple entries for the same user, allowing the ordinal system of table 100 to be used to access various possible RBTs in sequence. As an example an ordinal of 1 in table 100 could specify an advisement RBT and ordinal 2 in table 100 a music track with raw data. if there is then no ordinal 1 in this table, but there is an ordinal 2, then a music track has been played previously and not an Advertisement.

Column 121, record ID, is a simple sequential number referring to this row in the table. Column 122 contains the phone number or other unique identifier (such as email address or login name or other number unique to the phone) for Phone B. This column many also contain multiple phone numbers to form a group. Column 123 optionally contains a phone number A that is used only when this table contains specific results, such as ‘what I heard’ determinations between two phones. Column 124 is a search type identifier for this type of user profile record, Often it is the same as column 105 request type. Column 125 is the type of user data contained in the row. Examples include ‘Raw’ and ‘what I heard’. These are schemas that describe the way of decoding data in column 126. Examples of these schemas are 500 and 520. Column 126 is the User record itself.

This table is populated from large data transfers from carriers and RBT audio clip providers. It may also be populated by caching the API return values from various calls to server 40.

In one embodiment, table 120 exists on phone′ B in physical tables 3D and 5D. This is used to store the first raw RBT record retrieved for use in a scheme, described below, that uses this record for all ‘What I played’ determinations on phone B. Only one record is stored in this table on the phone.

FIG. 2 shows table 120 filled with a number of illustrative examples.

Record 1 in table 120 shows a ‘what I heard’ record, previously cached for this Phone A/Phone B pair (Phone A (123)=444-1212, phone B (122)=555-1212). The search type (124) is set to the value in 105 for local RBT authority record 5. Data type 125 ‘what I heard’ indicates schema 125 is used to interpret the ‘love shack’ what I heard record stored in 126.

Record 2 shows a corporate RBT ‘group’, here there are many phone numbers in the group, any match to a number is relevant to this group. Column 122 has 666-1212 and 777-1212. Phone A column 123 is blank. Column 124 is ‘corporate RBT2’. Data (126) is in ‘what I heard schema’ (125) and indicates that ‘Corp. Msg’ is played.

Record 3 shows a record where a Raw RBT record is stored, a rule from 130 will be applied to it to calculate what a phone A would have heard. Column 122 has phone B=888-1212. Search type (124) is RBT_Profile_REQ3 which comes from RBT authority record=7 which uses rule 1006 to extract ‘what I heard’. Data (126) is in ‘what I heard schema’ (125). This data record has all the song(s) and RBT configuration associated with line 888-1212

Rule table 130 (Physical table 34). This table contains the rules for interpreting API results returned from 40 and data in table 120. The rules are from a simple set of rules available in the system. These rules are dependent on actual RBT Authorities and are thus illustrative in the current disclosure. Some of the rules are arranged in sequence and are meant to be executed in sequential order to calculate or extract an RBT from a retrieved record (marked as ‘ID’ in illustrative table 560). Other rules are meant to be executed after an RBT is calculated or extract. These are marked ‘result’ in illustrative table 560)

Table 560 contains illustrative rules.

Column 131 is a rule ID. Column 132 contains rules for this row.

FIG. 2 shows table 130 filled with a number of illustrative examples that refer to the illustrative rules in 560.

Rule ID (131)=1001 shows a ‘what I heard’ rule’. This rule indicates that the API return in 120 contain the actual RBT (rule=8) and no further processing is needed to determine the RBT . . . however, the track info is not stored here but is retrieved via API (rule=8 also). Rule=9 indicates that the resulting record is to be stored in table 120 using both phone A and Phone B

Rule IDs 1003 and 1005 are variations on the ‘what I heard’ rules. 1003 uses rule 7 instead of 8 which indicate that the track info is to be retrieved from local Metadata table 110. 1005 uses rule 6 indicating that the data is stored within the ‘what I heard’.

Rule ID (131)=1002 is meant to parse a raw record with 4 cascading rules, (1) if current time fits into Time of Day’ rule window, else (2) if there is an MDN value and Phone A is one of them, else (3) user has a default RBT, else (4) the carrier has a default RBT After determining an RBT, rule 5 indicates that should the previous rules result in a jukebox, the next ordinal should be executed with this jukebox as input. Rule 10 indicates that the raw record is stored just using phone B.

Rules 1004 and 1006 are variations on the raw rules. 1004 does not allow for jukebox failover and has no storage rule. 1006 allows for the jukebox failover but it also has no storage rule.

Rule 1007 is used to process a corporate RBT record that returns just a raw time of day rule. It then stores the record in the cache.

Rule 1009 is a special rule for audio processing of a jukebox, here, the audio match determined the RBT within a returned jukebox. The record returned from the ‘what I heard’ to the server that was just used in audio matching included the complete Metadata for all jukebox entries. Rule 1009 indicates that it should get the Metadata from that previously returned record.

Rule 1010 is used to indicate that a simple API access is needed for a ‘what I heard’.

Rule 1012 says to expect a direct ‘what I heard’ determination with ‘who you were talking to’ metadata (rather than RBT related metadata).

Rule 1013 says to expect a direct ‘what I heard’ determination with a generic set of data to display, in this two images, two sets of text and two action URLs connected to two buttons.

Audio clip match table 140. (Physical table 51). This table stores audio signature clips for audio match server 50.

The system supports two distinct versions of this table, 1) a database of pre-extracted features, usually done off line and 2) a list of signatures extracted from reference clips just-in-time (on the fly) right before an attempt is made to match the just recorded clip. These two differ in physical location and storage of the table, but are logically similar.

Table 140 contains this set of extracted features. Column 141 has a unique record identifier. Column 142 and 143 are used to select sub-sets from the main list. Column 142 is ‘search type’ it can be used to collect extracted features. A match would occur only against those with this search type. Column 143 ‘search unique ID’ is a unique identifier for this record. It could for instance contain the trackID that is referenced in a jukebox (545). The ‘extracted features’ from the baseline analysis for a track are stored in column 144. Alternately this column is a URL to a reference clip. Column 145 is the type of user data contained in the row and is used along with column 146 (ID) as search keys into the Metadata table 110.

Column 146 is something to uniquely refer to this track when it is identified.

FIG. 2 shows table 140 filled with a number of illustrative examples.

Record (141)=1, Column 142 is used to identify a carrier, in this case ‘AT&T’, column 143 is a track ID 97 that may be in a returned jukebox, column 144 contains the extracted feature signature for ‘Love shack’, Columns 145 and 146 has the pointer into Metadata table 110 when a recording of ‘love shack’ is identified. It is set to ‘track/39’ to indicate that it should refer to table 110 and match columns 112 and 113 to find the actual title and other Metadata.

Record (141)=2, Column 142 is used to identify an advertiser, in this case ‘Pepsi’, column 143 is an advertisement ID 98 that may be in a returned in a list of possible advertisements for Pepsi, column 144 contains the extracted feature signature for ‘Pepsi super bowl’, Columns 145 and 146 has the pointer into Metadata table 110 when a recording of ‘Pepsi super bowl’ is identified. It is set to info/42’ to indicated that it should referrer to table 110 and match columns 112 and 113 to find the actual title and other Metadata.

Record (141)=3 is the same as record=1, except the signature field, 144 has a URL, indicating that ‘on-the-fly’ processing can occur on this record.

Pending Verification table 150 (physical table 35). This table supports two facilities related to phone devices that do not allow the ‘what I heard’ software apparatus to access its own phone number. The first facility allows global phone numbers to be verified, the second facility allows for unique ID to global phone number mapping

Column 151 has the global phone number. It is stored in both uses of the table. Column 152 has ‘state’, for the verification function the state may be ‘pending verification’ or ‘verified’. For the unique number to global phone number facility the values are ‘pending pick-up’ and ‘picked up’. Column 153 has the unique number stored only in the unique number to global phone number facility

FIG. 2 shows table 150 filled with illustrative examples

Record with global phone (column 151)=555-1212 shows a pending verification with state (column 152)=‘pending verification’ column 153 is blank.

Record with global phone (column 151) 444-1212 shows a unique ID to global phone record. Here, Column 153 shows a unique ID that happens to be an email address. The state, column 152 is ‘picked up’ indicating that the app has obtained the unique ID to global phone number mapping.

Phone number translate table 160 (physical table 36). This table supports two facilities related to translating global phone numbers and string and binary values. The first facility translates global phone numbers to string and binary values. The second facility translates string and binary values to global phone numbers.

Column 161 has the global phone number, column 162 has the associated string or binary value, column 163 has the type of value associated with column 162. These are dependent on the specific RBT Authorities or users of ‘what I heard’ systems.

This table may be populated by large transfers from an RBT Authority, or populated by an algorithmic means.

FIG. 2 shows table 160 filled with an illustrative example.

Record with global phone (column 161)=555-1212 shows a translation for a RBT Authority. The arbitrary value of the type field (column 163) is ‘Skype-email’, indicating that the data in column 162 is a Skype relevant email address.

‘What I heard’ log table 170 (physical table 1C). This table supports the contact call back facility as described with step 202B, display of ‘what I heard’ in the phone's contact list. Results of past ‘what I heard’ determinations are stored here so they can be provided on a call back-query from the phone's address book facility for a particular phone number

Column 171 contains a phone number, Column 172 the text string that will be displayed in the address book and contains the ‘what I heard’ or ‘what I played’ indication. Column 173 is the call direction. It is either ‘outgoing’ or ‘incoming/missed’

FIG. 2 shows table 172 filled with an illustrative example.

Record with phone (column 171)=555-1212 shows an outgoing record. Record with phone (column 171)=444-1212 shows an incoming or missed record.

### Local Number to Carrier Table (180) (Physical Table 37)

This table provides a mapping between specific phone numbers; groups or ranges or phone numbers and a RBT/Information Authority table 40 entry that usually, but not always, access a non-RBT authority. This table is used instead of a carrier lookup (it is accessed first and if there is an entry here, no carrier is looked up, as such it may be considered a local carrier lookup table). In one variation, this table may in-fact point to an RBT authority that is carrier. In that case this table acts as a carrier-lookup facility.

Column 181 contains an abstract field that may be a single phone number or represent a group of arbitrary numbers, a range of arbitrary numbers or any combination thereof. Column 182 is the RBT authority name, which is used as a key to match column 102 or authority table 100.

FIG. 2 shows table 180 filled with a illustrative examples.

The record for TWC (Time Warner Cable) shows a combination of single numbers and ranges of numbers that all access the same server 40, and thus the same after call information and experience. The information authority value ‘TWC’ accesses column 102 in table 100 retrieving record 11 in that table for the TWC.

The record for American Idol has two numbers associated with the American Idol line. A match on this retrieves record 12 in table 100 which then indicates that ‘local-code’ (local to server 30) will be called, passed phone B to get a ‘what I heard’ determination for calling this phone B.

### 3. Detailed General Flow

This section describes each of the steps in FIG. 3 in detail. (Note steps 201A to 201D will be discussed below as part of audio matching)

3.a. Triggering ‘A What I Heard (or Played)’ Event

Events 202A through 202E as well as a call from an external entity (204) trigger ‘what I heard/played’ processing.

3.a.i. Call Completion Event

Step 202A is an automatic event sent by a phone's operating system indicating that a call has completed. It is sent if the phone supports the generation of this type of event and business rules allow for this type of event service. This completion event is for when: 1) an outgoing call, originated on Phone A, is completed by either party ending the call (or by the outgoing party aborting the call before the incoming has answered), 2) an incoming call on Phone B is completed. A call is only classified as an incoming call if Phone B answers the call. 3) if Phone B does not answer the call then it is a ‘missed call’, This event is triggered as a call completion even after phone B fails to pick up the call or phone A aborts the call before phone B picks up.

A software apparatus on phone B configures the phone operating system to send these 3 events to it on call completions. This software apparatus receives these events when the event occurs. Step 202A records which of these three events occur. The event itself may include the ‘other sides’ phone number or the software apparatus may issue further instructions to retrieve this information from the phone OS. The software apparatus also collects its own phone number. The results of this step thus includes 1) the phone number of the current phone, 2) the phone number of the remote phone and 3) the ‘direction’ of this call (incoming, outgoing or missed). A variation on this event has a single ‘call completion’ event. In this case the software apparatus further determines if the event was ‘incoming, ‘outgoing’ or ‘missed’ by querying the phone operating system.

In another embodiment of step 202A some or all of the remote number or direction may not be available in this case, after the incoming, outgoing or missed event is generated, the software apparatus searches the phone's call log, 1A, 3A or 5A for the last call received or the last call(s) not processed by the software apparatus to obtain a list of one or more calls to be processed further. It is scanned if the phone supports it and business rules allow for this type of scan. For each of these calls the system retrieves the ‘other sides’ phone number along with call direction. The system may have a separate event each for incoming, outgoing or missed, in which case only the call log for that type of call is searched, or it may just get a general ‘call completed’ event in which case the incoming outgoing and missed logs are all searched. In all these cases the phone number of the current phone is retrieved from the phone operating system or it may be in the call log.

The software apparatus may store the information from these events for a run of the app 202C or a periodic poll (202D) to further process the event, or it may hand it off directly to the ‘what I heard’ processing section.

In another embodiment, the call log, or latest calls, may be retrieved via API from carrier networks 10 or 20. These logs at a minimum have phone A, phone B and call direction and may contain more ‘what I heard’ data. If business rules allow it, and network 10 or 20 support this, then an API call is made to network 10 or 20 to retrieve call lists. Should this call log information be retrieved, processing continues as if a local call log had been scanned as described in the previous paragraph.

3.a.ii. External Notification

Step 202B is an event from some entity external to this software apparatus. As illustrative examples these entities include: server 30, server 40, network 10 or 20 or servers 40, networks 10 and 12 via server 30. In these cases some third party entity 60 forwards the event to the handset or the event generating entity may send it directly to the handset. As yet more illustrative examples, this event may occur in another software apparatus on this same phone, or on some other phone (and be forwarded directly or through third party entity 60). External notifications are received if the phone supports it and business rules allow for this type of event service.

Except for one specific case in 202E, the current disclosure does not describe how the various servers or phones decide to send a notification.

A special case of notification is when the phone OS does not send external notifications right away to the software apparatus. Instead, if queues them until the app is later run (via a 202C). Once running the OS sends these events to the app. Processing then proceeds on each of these queued notifications within the running version of the app.

These notification events may have the following payloads or combinations: 1) no payload at all (i.e. just the event), 2) the ‘what I heard/played’ track number (or the complete track), 3) the ‘other side’ phone number and the direction of the call, 4) a reference number that can be used to pick up further information on a server for this call. 5) A reference to a previously stored ‘what I heard’ result on this phone. Additionally the external notification may contain a number of these payloads. (I.e. the record of a number of phone calls are sent at the same time)

In one variation the phone's operating system forwards this event to the software apparatus: The raw event, with its possible data may 1) simply be stored at this point and further processing continue when the app is run (202C) or 2) a poll later sees these store values (202D).

Another variation the notification increments the badge value 217F and data may be stored in raw form now or processing allowed to continue through ‘what I heard’ to step 217F now.

If ‘no payload’ was included in the event, the software apparatus scan call logs 1A, 3A or 5A for calls since the last time the apparatus was run, returning one or more calls to be processed along with ‘call direction’ a retrieved from these files.

In another variation the call log, or latest calls may be retrieved via API from networks 10 or 20. These logs at a minimum have phone A, phone B and call direction and may contain more ‘what I heard’ data. If business rules allow it, and network 10 or 20 support this, then an API call is made to network 10 or 20 to retrieve call lists.

If ‘what I heard’ or ‘what I played’ is included in the event ‘what I heard/played’ processing is not required (shown in step 203), directionality may be indicated by the message saying ‘heard’ or ‘played’ or it may be an explicit part of the value included in the event. Additionally the ‘other sides’ phone number may or may not be included.

If ‘the other side's phone number and call direction are included in the event, they are combined with this phone’ number and passed to ‘what I heard’ processing

If a reference number to a server is included, it is passed to the ‘what I heard’ processing to retrieve actual call information from some severs.

A reference to a previously stored ‘what I heard’ results may be returned, if for example some other entity had stored these results and is sending a notification for this software apparatus to display it. In this case processing would continue to 215 via 203.

Step 202B thus passes one of the following on to the ‘what I heard/played’ section: 1) the phone's phone number, the other side's phone number and call direction 2) a reference number to be used later to retrieve call/what I heard information or 3) ‘what I heard/played’ itself along with the other sides' phone number and call direction (if the latter two are provided). It may pass a single call or multiple calls.

3.a.iii. Run a ‘What I Heard’ (or Played) App

In step 202C, the software apparatus is invoked manually to display ‘what I heard’. It may be invoked from the list of applications on the phone, from the notification bar in 217C, the drag down in 217E or noticing a badge in 217F. It may also be run from the widget, 217A or pop-up, 217B. Running of the application is done if the phone supports running applications manually and business rules allow for this type of event service.

When the application is run, it processes various lists of calls and events. It may process one or more of these lists:

In one variation it reads the call log lists in 1A, 3A and 5A for calls since the last invocation of the app retrieving ‘other phone numbers’ and call direction along with the phone number of this phone and passes the information for each of the calls found to step 203 in turn. The scan of call logs occur if the phone supports it and business rules allow for this type of scanning.

In another variation the call log, or latest calls may be retrieved via API from carrier networks 10 or 20. These logs at a minimum have phone A, phone B and call direction and may contain more ‘what I heard’ data. If business rules allow it, and network 10 or 20 support this, then an API call is made to network 10 or 20 to retrieve call lists. Should they be retrieved, processing continues as if a local call log had been scanned as described in the previous paragraph.

In another variation the various stored raw outputs from set 202A and 202B are processed, these include 1) other phone, this phone and direction triplets, 2) ‘what I heard’ results from notifications, reference numbers to servers and references to already stored ‘what I heard’ results. Each of these would in turn be passed to step 203 for further processing.

In another this running app either now or previously arranged to receive notifications. On entry to the app, the phone OS ends all queued notifications to this now running process.

In another variation, startup parameters are passed by another app on the phone to the ‘what I heard’ software apparatus. These parameters are: Phone A, Phone B and all direction. Event 202C extracts these parameter's from the phone OS' startup parameter list and then uses them as Phone A, Phone B and call direction. Another variation on his provides just phone B. in this case Phone A is set to ‘this phone’ and call direction=outgoing.

3.a.iv. Poll on-Phone Call Log

In 202D a periodic event such as a system timer causes processing of ‘what I heard/played’ to start. Polling is done if the phone supports it and business rules allow for this type of service.

When the periodic event causes processing to start, it processes various lists of calls and events. It may process one or more of these lists:

In one embodiment, it reads the call log lists in 1A, 3A and 5A for calls since the last invocation of the app. retrieving ‘other phone numbers’ and call direction along with the phone number of this phone and passes the information for each of the calls found to step 203 in turn. The scan of call logs occur if the phone supports it and business rules allow for this type of scanning

In another variation the call log, or latest calls may be retrieved via API from carrier networks 10 or 20. These logs at a minimum have phone A, phone B and call direction and may contain more ‘what I heard’ data. If business rules allow it, and network 10 or 20 support this, then an API call is made to network 10 or 20 to retrieve call lists. Should they be retrieved, processing continues as if a local call log had been scanned as described in the previous paragraph.

In another embodiment, the various stored raw outputs from set 202A and 202B are processed, these include 1) other phone, this phone and direction triplets, 2) ‘what I heard’ results from notifications, reference numbers to servers and references to already stored ‘what I heard’ results. Each of these would in turn be passed to step 203 for further processing.

3.a.v. Offline Processing of Call Lists

In step 202E, lists of Phone A and Phone B are processed on servers 30 or 40 with the intention of sending notification or a ‘has app’ alternate messages to Phone A and/or Phone B. these lists optionally directly include a third field, ‘what I heard/played’ in this call to allows for faster processing by removing the need to do a ‘what I heard’ determination.

The current disclosure does not describe how these lists are generated in the first place.

The call pair and the possible ‘what I heard’ stored indication are passed twice to step 203. Once with ‘this handset phone’=Phone A, ‘other handset’=phone B and ‘direction=outgoing’, and another with ‘this handset phone’=phone B, other handset=phone A and direction=‘incoming’

Each of these will result in either a ‘has app’ generated alternate message in 215 if the ‘this handset’ phone does not have the app or a notification to ‘this handset’ in 217H if it does. The offline process and it's interaction with the ‘has app’ service is described in detail later.

3.a.vi. Call Progress Protocol

Step 202F, call progress protocol, allows additions to low level mobile phone protocols such as CDMA, GSM and CND to add ‘what I heard’ data during call setup. For instance the CDMA call proceeding message sent from the network to the MO device may be enhanced to include ‘what I heard’ information. (Which at that point in a call's progress would actually be ‘what I'm hearing now’). Likewise Call Number Delivery protocol used for caller ID may be enhanced to include ‘what I played’ information (which at that point would be ‘what I'm playing now’). (See U.S. Pat. No. 7,200,212 for example of enhancing the CND).

To be effective, the data transmitted during call establishment should have some element of ‘what I heard’, ideally at least the title of the RBT that is playing. Additionally, processing and communications during this phase of call establishment is limited, so full processing of a ‘what I heard’ is not practical.

At the maximum this ‘what I heard’ message included in a low level protocol may have complete ‘what I heard’ display Metadata.

202F proceeds to step 221 immediately to store this information in a known, accessible location and processes it no further. So on receipt of this information, 202F stores the information in a known accessible location to be picked up. It may also send a broadcast style inter-process event to listening app to pick up this information (or include it in the broadcasts).

Step 202F is embodied within the low level call establishment software apparatus within a phone.

In another embodiment step 202F is incorporated into a third party's application in this case it saves the information or broadcasts it as above, but in addition it may simply pass the information to another section of the third party app.

While the system does not generally cover how a carrier's network generates this information and sends it in the low level protocol, it does cover the case where the network, having both Phone A and Phone B's phone numbers calls the ‘what I heard’ API service on server 30 to determine ‘what I heard’.

202F may also occur more readily during a VOIP type call since the protocol and app that places/receives VOIP calls are more readily changeable. Indeed, full ‘what I heard’ service may proceed during call setup.

3.a.vii. Run of a Call App

Step 202g is a run of a third call app. This type of app on the phone places a phone call to a remote handset or receives an incoming call from a remote handset and stays active for the duration of the call. Generally every phone has at least one of these applications embodied by the phone's normal call placement app. (the app that allows you to dial or receive incoming calls). It is possible however for other apps to provide this functionality, whether for a normal voice call or for a VOIP application.

A 202G starts this type of app. it is used exclusively in conjunction with display method 217I, display within this type of app.

3.b. Determining ‘What I Heard\Played’

Once an events 202A though 202E or 204 have triggered ‘what I heard/played’, steps 203 through 214 and step 219 determine ‘what I heard/played’, determine that you did not hear an RBT or that the determination is inconclusive.

As a first step, some of the events 202A through 202E may actually have contained ‘what I heard’. If that is the case step 203 causes the ‘what I heard’ processing to be skipped, jumping to step 215.

3.b.i. Determining an RBT Authority

As a first step in determining ‘what I heard/played’, step 203A determines a carrier that is used as a simple key into the RBT authority table 100, column 102. First, step 203a tries to see if the phone number is locally known in table 180. To do this it makes an abstract match of this phone number to the phone number, phone number list or phone number range in column 181. If there is a match, column 182 is used as the carrier key and processing continues at step 205. If there is no match in table 180, step 203a contacts the phone number to carrier service 80. This service takes as input a phone number and returns the carrier that is currently servicing this number. In addition, this service returns ‘device information’ such as the phone model, operating system on the phone, screen size and so on. Some of this later information is used later in the display phase.

Step 205 starts the iterative processes of finding an RBT or information authority for the ‘carrier’ code returned in step 203A.

The process starts by searching for an RBT authority whose ‘carrier code’ column 102 contains the ‘carrier code’ retrieved in step 203A and whose ordinal is 1. The information in this record, all the records that follow it and phone A and Phone B are combined as described below to calculate an RBT using this authority. If steps 212, 203, 214 or 210 return a ‘what I heard’, then the iterative loop is exited. If this iteration does not determine ‘what I heard’, or in one variation, the determination was for a Jukebox that needs further processing’, the loop is repeated again at 205 with the same carrier column 102 match and the next ordinal in numeric sequence.

Each new RBT Authority tried returns the following 1) from column 103 whether to a) contact an audio match service (50), b) an external RBT authority (40), c) to process the results locally on any of 30, 1, 3 or 5 or d) that there is no available or remaining authority. 2) An API request rule from column 105 to pass to the appropriate authority to request processing. 3) The rule in column 106 to be used in processing the result from the RBT Authority.

If step 205 returns that there are no RBT authorities that match this carrier and the current ordinal, step 206 forwards processing to step 207 to return that there are no more authorities. This determination means any of the following 1) there were authorities for this carrier, however none of them had, in a past iteration of the ‘what I heard/played’ loop returned an RBT that was played or heard for this phone number. In this case ‘no more authorities’ means that there is in fact no RBT that was played. 2) That there were no RBT authorities as all, in which case it is possible that an RBT was played on this line, however, since this system does not have access to an authority for this carrier, we could not determine if an RBT had been played.

3.b.ii. Obtaining ‘What I Heard (or Played)’

If there is an available RBT authority Step 208 directs processing to either an RBT record based approach (209) (method 1 below) or to an audio matching approach (213) (method 2 below)

3.b.ii.1. Method 1, Determine from Stored RBT Records

Step 209 starts the RBT record based approach. Here, Phone number B is combined with the request string/rule returned from step 205 and stored in column 105 of table 100. In another variation, phone A is also combined with the string/rule.

3.b.ii.1.a. Obtain RBT Record from a RBT Record Authority

Step 209 may be performed on either the ‘what I heard’ server 30 as the RBT authority, on phone A or B, or through a remote RBT authority 40.

3.b.ii.1.a.i. Remote RBT Record Authority

If a remote authority is determined, column 105 indicates a remote authority along with what is generally a string to assemble an API request to server 40. Phone B and sometimes Phone A are inserted into the request string and sent to server 40.

Server 40 may return one of three things, 1) Direct determination of ‘what I heard/played’, 2) a raw RBT profile record for phone B or 3) that the RBT authority was capable of determining with a certainty which RBT was heard/played but that in fact no RBT was played. As illustrative example of the later, the RBT authority is an RBT advertising authority and given both Phone A and Phone B that it did not play one of its RBTs this value would be returned)

Step 209 determines what return value type is expected as a return from the remote RBT Authority by consulting with rule column 106. For a remote authority, rule column 106 has 3 rule types. 1) return value ‘raw’ is expected in the illustrative format 500 2) return value ‘what I heard expected’ in illustrative return value 520 or 3) either raw or what I heard is returned, and step 209 should look at the format of the return value to see if 500 or 520 is returned.

Step 210 determines the flow of the process based on these three possible return values.

If a direct ‘what I heard/played’ is expected or returned, 209 extracts ‘what I heard/played’ from the returned record. Illustrative example 520 shows a return of track, jukebox, info, an error indication or an empty RBT. If the record indicates that a track is returned, it would be in the format 530. If the record indicates that a jukebox is returned, it is in the format of 540, which would then contain a list of constituent tracks in form 530. If an informational type RBT is returned it is in the format 550. In another variation, only partial Metadata needed for the display section is included in the ‘what I heard’. In either case, processing continues to step 219 where the remaining Metadata is collected.

If a direct ‘what I heard/played’ is returned and there is an error or it is empty processing iterates to another RBT, returning to step 205 to proceed to the next ordinal.

If a raw record is expected or returned, processing continues at step 211.

3.b.ii.1.a.ii. Local RBT Record Authority

A local authority is indicated by column 103 set to any of: local-data, local-audio or local-enough.

For local-data, column 105 has a search type key used to access table 120. Table 120 contains the same values in Column 126 that can be returned from the API call, and thus a local RBT record authority differs little from the remote RBT record authority above. These differences include:

Access to this same data is achieved by searching for the appropriate data in table 120 rather than an API call. Here, phone B is used to search column 122, optionally phone B is used to search column 123 and the retrieved authority column 105 is used to search column 124 to obtain a record from table 120. Phone B is used only when column 105's type indicates that it should be used. Retrieved column 126 is then used in the same way as the remote RBT Authority access above.

### Local to Server 30 ‘What I Heard’ Service

As a speed enhancement, the ‘what-I-Heard’ API required of a server 40 may also be implemented as a software apparatus on Server 30. I.e. the services hosted by a remote server 40 may instead be accessed by calling a software apparatus on server 30. It implements the ‘APIs expected of server 40’ and described above, taking phone numbers as input and returning ‘what I heard’ or ‘raw’ determinations.

The use of this local service 40 is accomplished by the addition of a defined value ‘Local-code’ as a permissible value in table 100, column 102 (RBT-Authority). In that case, the ‘request’ column, 105 may contain information on directing the system to a particular local software apparatus or it may contain values that are passed to some common local software apparatus.

Step 209 would decode ‘local-code’ and direct flow to this local software apparatus.

While this feature is by no means exclusive to ‘non-RBTs’ (one could easily implement a full local RBT based ‘what I heard’ system as a local software apparatus), this feature, used in conjunction with the local phone number to carrier table (180) will enable display, using all the display methods in the system of a set of metadata based off of many phone A's calling into a single, known, phone B. (see our illustrative example below).

Local-audio and local-enough are described elsewhere.

3.b.ii.1.b. Calculating ‘What I Heard’ (and Return Values Passed to Display)

With a record retrieved from a remote or local RBT authority processing continues on that record. The record may be a raw record, in which case processing continues to step 211, otherwise it is a direct ‘what I heard’ message and processing continues in step 219.

Both these cases produce all the information needed for the display of the results starting in step 215. This needed information is specific to types or RBTs below.

In both cases all this needed information is either contained in the retrieved record or some further Metadata collection is performed.

In both cases, the process uses the record returned along with the rule pointed to by column 106 for this RBT authority to calculate the information needed. The rule itself is stored in rule table 130.

The rule table 130 is an abstract table that contains a string of rules on interpreting a retrieved record. Rules are obtained in negotiations with RBT Authorities and the system cannot predict rules or the format of retrieved records that may be revealed in the future. As an illustrative example FIG. 560 shows some possible rules. The discussion on using these rules show how these illustrative rules may be applied to illustrative retrieved records in 500, 520, 530, 540 and 550. Sections below will illustrate the use of these rules. Each of these sections also define the data that would be extracted from the retrieved records and then passed to the display section starting in 215

If the retrieved record had come from a remote RBT Authority, the retrieved rule may also indicate that the retrieved record should be stored in table 120 as a cached value to be used to retrieve the record locally at another time. There are two methods of storing this record:

With just the Phone B stored. In this case the record would be relevant to other phone A's. This is generally the case with a raw record as the configuration information describes the actions for all Phone A's that may call in. As an illustrative example, return values from a Verizon are cached in table 120 on server 30 so that a call need not be made later to the server 40 if the raw record is stored in 120 on server 30. To do this the return value from this API call stored in table 120 (column 126) with the current phone B (column 122) and a type (column 124)=‘RBT_PROF_REQ3’ (column 123 here would be empty.

With both phone A and Phone B stored. In his case the record is relevant only to this call pair. As an illustrative example, Verizon may return a ‘what I heard’ for a particular phone-A, phone B pair. Here the ‘what I heard’ return is stored in 126, phone B in column 122, phone A in column 123, and type, 124 could be ‘WHAT_I_HEAR_AB’

Once these are stored in table 120, another RBT Authority ordinal is used to retrieve the information. ‘local-data’ is set in column 103 and the request indicates whether to use ‘just b’ to search table 120, or ‘use NB’ to search.

To accomplish caching the ‘retrieve’ RBT Authority record is set to Ordinal=1 (or any ordinal one less than the ‘store’ record) and the store record is set to Ordinal=2 (or one more than the ‘retrieve’). On the first access, where the record needed is not in table 120, the ‘retrieve’ ordinal=1 RBT Authority would fail, moving on to ordinal=2 that would retrieve the record and store it. This makes it so that the next time a call comes in that needs this record, RBT Authority ordinal=1 would succeed.

3.b.ii.1.b.i. From Raw RBT Profile Record

A raw RBT profile record contains RBT settings for a phone B. These settings are combined with a set of rules for interpreting the settings and Phone A to determine which if any RBT was played for Phone A. step 211 processes these.

These rules are the same rules that the carrier network 10 or 20 use to determine the correct track to play for phone A from the same RBT record for phone B. Thus the calculation performed on server 30 will produce the same calculated RBT play as network 10 or 20 do.

There is one illustrative example of raw profile processing below for music. The same steps may be used to process other illustrative examples such as corporate RBTs (that would have a number of time-of-day rules’) or advertising RBTs that might, as an illustrative example have rules based on a phone's area code. (The API retrieval would return the same profile for any phone B and the rule would apply to any Phone A). Additionally, this raw record could have arbitrary metadata related to this call.

### 3.b.ii.1.b.i.1. Music

A music RBT system plays a music track to various callers into phone B. These tracks don't have to strictly be music, but are in-fact some audio track.

The illustrative raw music profile and rule would have a retrieved RBT record in the form of 500 and would use a rule from table 130, record 1002.

For this illustrative example, a carrier supports four features for a music RBT: 1) a per-MDN feature where the owner of phone B can enter a number of Phone A's and assign a music track to each, say ‘Let it Be’ when 555-1212 calls and ‘Love Shack’ when 444-1212 calls. 2) a time of day feature where the owner of phone B can set say ‘Sergeant Pepper’ on Mon-Fri 9 AM-5 PM and ‘Hey Jude’ on Saturday morning 10 AM-11 AM. 3) A line default, which is a track to play if neither time-of day nor ‘per-MDN’ is set and 4) a carrier wide music track such as some classical music track to be played in none of 1, 2 or 3 are set. All of these settings are stored in an RBT profile for phone B

500 shows how the schema for how this data can be sent from carrier 40 or stored in table 120. 501 is the section that describes the carrier wide default. 502 contains a track in the form of 530, a jukebox in the form of 540 or an info RBT record in the form of 550. It has a carrier default RBT (i.e. empty not allowed). Section 503 contains a line default 504 that is also a track, jukebox or info RBT, but in this case can also be empty. Selection 505 contains a list of per-MDN RBTs. each item in the list is in the form 506 which contains the phone number (507) for the phone A MDN that may call phone B and (509) the track, jukebox or RBT. Since this record is optional itself, this track/Juke/info item can't be empty. Section 509 has the time of day rules. There can be a set of rules here as described above. A rule item is shown in 510 which consist of two things, a time of day rule (511) and a track/jukebox/info item to be played if the rule is satisfied. The rule 511 is in the form of days-of-the-week and time span (i.e. M-F 9 AM-5 PM).

Track (530), Jukebox (540) and info (550) are described in the Retrieving Metadata section below.

A variation on step 211 involves retrieving partial data during raw processing; in this case 211 would retrieve the track info from table 110 or via API from a remote RBT authority using a track-identification key stored in the raw record for each possible track. Parameters to access the additional Metadata are encoded in the access values in columns 103 and 105.

Rules consist of two sections, an ‘if-then-else’ section and a ‘on result’ rule. Illustrative rule 1002 is used to interpret our illustrative record 500. The rules in 1002 are applied in order. If one succeeds then processing continues to the result section.

Rule 1 (the first rule in 1002) (rule 1 is shown in 560-1) If time of day set (511) in raw profile 500 and the current time fits in this range, then use the track (or jukebox or info track) indicated in the raw record (512). If not 2) Rule 2 (560-2) check if phone A is in list of caller IDs list (505/507), if it is use track, juke or info 508. If not, 3) Rule 3 (560-3) if the user has a ‘default RBT set (503) use track, juke or info 504. Else 4) rule 4 (560-4) says use the default AT&T ring-back in 502 (which is never empty). Rule 5 (565-5) states; however, if this all returns a jukebox, return the jukebox, but act as if there were in fact no match. (This will force the next RBT Authority). Rule 6 (560-10) states that on a successful RBT determination, store the retrieved record (cache it) in table 120.

In a ‘what I heard/played’ RBT is calculated, this ‘what I heard’ section for music will pass the following to the display section for single RBTs: 1) track name, 2) Artist name, 3) album name, 4) album image URL, 5) track preview URL. For a jukebox return (assuming that further audio processing is not done) 1) Jukebox name, 2) list of all tracks in the jukebox. Each of these has the track info for each constituent RBT. ‘Type’=music track is also passed to the display section.

3.b.ii.1.b.ii. From ‘What I Heard’ Record

The system may directly return a ‘what I heard/played’ from various sources: from an event in step 203, from a local or remote RBT authority in 209 or from an audio match in 214. In all cases 219 is executed to extract ‘what I heard’ from the message and to obtain the information needed for the display section.

There are five illustrative examples below, one for music, one for advertising, one for corporate RBTs one for non-RBT that queries a customer service PBX, and one non-RBT that produces a local to server 30 result based on dialing a particular number.

### 3.b.ii.1.b.ii.1. Music

As an illustrative example a music ‘what I heard’ includes the track info or points to the track info that is stored at a remote RBT authority or in a local store such as in table 110.

The retrieved record from this RBT Authority would be in the schema of 520. The value in 521 would be a track (a track object 530), a trackID value or a juke (jukebox object 540). Track 530 and jukebox 540 are described in Metadata below. Some or all of this data may be present.

Step 219 takes this record and is then processed using the illustrative rules 1001, 1003 or 1005 from table 130 to pass values to the display section.

Rule 1001 step 8 indicates that the retrieved record would be in what I heard schema 500 and that it should expect and extract a trackID from the record that is then used to retrieve Metadata information from a remote RBT authority via an API. Rule 1001 then indicates to apply rule 9 once the data is collected and store the results in table 120 using both phone A and Phone B. Rule 1005 would then be used to retrieve this cached value from that table. (The item stored now has all Metadata so 1005 indicates it should expect all data)

Rule 1003 is an illustrative example of an audio match on a jukebox. Here the audio match section would return a ‘what I heard’ RBT. Rule 7 indicates that the returned data has a trackID and that the Metadata for it be retrieved from the local 110 Metadata table. rule 1001 then indicates to apply rule 9 once the data is collected and store the results in table 120 using both phone A and Phone B. Rule 11 is special for an audio RBT jukebox match (and is the complimentary rule to a rule 5 that invoked audio match from rule 1002). This rule indicates what to do on success or failure of the audio match. On success rule 7 is applied to the success value (track ID then local Metadata), however, on failure, we return the jukebox that was passed in to the audio section to indicate ‘one of these RBTs were played, we don't know which’

Rule 1005 indicates that the retrieved RBT record would be in the schema 520, however it should expect that the track info in the format 530 is there or that it contains a jukebox in the format of 540. This rule is the complement of rule 1001; as a result there is no ‘store in table 120, as this would result in the record being stored twice in 120.

Once the rules have been applied and Metadata retrieved accordingly, this ‘what I heard’ section for music will pass the following to the display section for single RBTs: 1) track name, 2) Artist name, 3) album name, 4) album image URL, 5) track preview URL. For a jukebox return (assuming that further audio processing is not done) 1) Jukebox name, 2) list of all tracks in the jukebox. Each has the track info for each constituent RBT. ‘Type’=music track is also passed to the display section.

### 3.b.ii.1.b.ii.2. Advertisement

As an illustrative example, a ‘what I heard’ record for an advertisement that is played during RBT time would contain a title of the advertisement, an image of the advertisement designed to fit into the display (akin to ‘album art’) and a URL to an HTML5 snippet that is displayed when an ‘interact’ button is pressed. This is an example of an ‘enhanced-RBT’ determination where the data returned in the determination and resulting display don't limit themselves to what was heard or played but rather displays metadata possibly tangentially related to the RBT, in this case a follow-on advertisement to the advertisement RBT.

In one variation, this type of RBT may take a GPS value passed from the phone to determine a particular display to be shown based on geographic information.

An advertisement ‘what I heard’ is similar to a music ‘what I heard’ except that the retrieved record 520 would contain an info item in the form 550 or a info ID that then points to local or remote Metadata in the form of 550. The info data 1 field, 553 would contain the URL for the advertising image and info data 2 field (554) contains the URL for the interact HTML5.

An advertisement would return 1) an advertising title, 2) an advertising image and 3) a URL to an HTML5 ‘interact’ code snippet. ‘Type’=advertisement is also passed to the display section.

As an illustrative example, RBT authority record=10 describes an RBT authority that would return a phone A and Phone B and GPS based advertisement. When an RBT is determined for ‘T-Mobile’ (column 102 set to T-mobile’ in this example) a ‘what I heard’ determination is sent to server ‘ad-server-1’ using a request that adds in GPS (request column 105=‘Use-GPS’.) Rule 1005 is used to parse the return. The return is contained in a ‘what I heard’ determination with all data included. The returned data will include the name of the company, a URL to an image and a pointer to an HTML5 snippet that is displayed when an ‘interact’ button is pressed.

Ad-server-1 would return an advertisement relative to phone A, phone B, direction and GPS in a 520 data format. The retrieved record 520 would contain an info item in the form 550 or an info ID that then points to local or remote Metadata in the form of 550. Info title 552 would contain the name of the company being advertised, The info data 1 field, 553 would contain the URL for the advertising image and info data 2 field (554) contains the URL for the interact HTML5

The carrier, in this case T-Mobile, may contract the processing of RBT-advertisements to a third party, and this server may be administered by that service. In one variation, this redirection to the third party server is performed by server 40 and is out of the scope of this disclosure. In another variation, phone numbers within the carrier that have RBT-advertisement installed are download into table 180, the non-carrier table to direct any determinations for one of those phone numbers directly to the third party advertisement server. FIG. 2010 shows an example embodiment of this illustrative example.

### 3.b.ii.1.b.i.3. Corporate

As an illustrative example, a ‘what I heard’ can be a corporate RBT. This RBT would be played on lines of phones owned by the Acme Company. If a phone a calls into a phone B from say 9-5 on Monday through Friday, an RBT would be an audio track that might say ‘thank you for calling one of our employees. After the call you will be asked to rate this employee’. After the call you will see an image of the employee. The ‘interact’ button would point to an HTML5 code snippet that would allow you to rate his or her performance.

The ‘what I heard’ would be in the schema 520 pointing to an info 550. It is similar to the record returned for an advertisement. This info would contain an info title, probably the name of the employee and company name (552) customized to phone B, an image URL pointing to the image of the employee in phone B, and the URL to provide feedback about the employee.

Application of rule 1001 is similar to that of music or advertisement; however Phone B would be provided to the API so that the RBT Authority can customize the returned data in the schema of 550 with title, image and URL for employee who owned phone B

In all cases a corporate ‘what I heard’ would return a title (that usually contains the name of the employee on phone B), an image URL for this employee and a pointer to an HTML snippet for rating this employee to the display section. ‘Type’=corporate RBT is also passed to the display section.

3.b.ii.1.b.11.4. Non-RBT from Customer Service PBX.

As a diminutive case of determining ‘what I heard’, the system may be configured to return ‘what I heard’ when no RBT was in-fact heard. This is because the ‘what I heard’ record determination model merely attempts to ‘mirror’ the RBT played by network 10 or 20 by doing a shadow calculation of the RBT that could be played. This record based calculation can return any record related to this Phone A, phone B and call direction triplet. As an illustrative example, an advertisement for the company you just called could ‘pop-up’ when the call complete however you did not hear an RBT. The RBT Authority would be set up to use phone-A, Phone-B and call direction to return a relevant ‘what I heard’ return value that is a targeted advertisement for those 3 values.

This no-RBT case would use the event (202A, B, C and D) and display procedures in the system along with a ‘what I heard’ determination that is not related to an RBT played 217A through 217J. A no-RBT determination is in-place-of and not ‘in-addition-to’ an actual RBT.

In one variation, non-RBT determinations are provided by non-carrier entities and thus phone numbers for these non-RBT determinations are stored in the non-carrier table 180 resulting in processing of the determination at a non-Carrier RBT authority. In another variation, non-RBT determinations are done at a carrier in which case the decision to return an RBT, enhanced-RBT or non-RBT determination is out of the scope of this disclosure.

As an illustrative, the first entry in table 180 along with RBT Authority (table 100) record=11 describes an example that returns the agent's name, photo and direct callback information when someone calls Time Warner Cable (TWC)

Events 202A, B, C or D trigger this determination. Step 203A searches table 180 for a match on the phone number in column 181. If this had been a call ‘to’ TWC, the ‘what I heard’ software apparatus on phone A would use Phone B's number as a key. Had TWC called you, the software apparatus on phone B would use phone A, TWC's number that would appear as the ‘incoming call from’ number to as a key.

The retrieved value in column 182, the non-carrier value is then used as a key to table 100, column 102 to retrieve the RBT Authority record 11. This results in an API call to TWC server TWC-4 passing phone B for a call to TWC and phone A for a call from TWC. It also sends a timestamp so the TWC can use it as a heuristic for determining the agent that handled the call. TWC server TWC-4 would query their PBX using the passed phone A or Phone B to find the agent info, including the agent's name, photo and return contact information. The internal to TWC-4 query to the TWC PBX that determines this information is out of the scope of this disclosure.

TWC-4 returns this determination. The retrieved record 520 would contain an info item in the form of 550. Info title 553 would contain the words Time Warner Cable and the contact name, info data 1 (553) would a URL to the agent's image, and info data 2 (554), then call back information

FIG. 2008 shows an example embodiment of this illustrative example.

3.b.ii.1.b.11.5. Non-RBT from a Particular Number to a Local-to-Server-30 Software Apparatus.

Another example of a Non-RBT determination involves the use of table 180 and a local-code RBT authority record to display a particular experience based on any phone A calling a particular phone B. In this example, a person on phone A calls a voting line for, as an example American Idol to vote for Jennifer Hudson. When the call completes, information on American Idol and on Jennifer Hudson is displayed and the user has the option of downloading the song that Jennifer Hudson just sang.

This no-RBT case would use the event (202A, B, C and D) and display procedures in the system along with a ‘what I heard’ determination that is not related to an RBT played 217A through 217J. A no-RBT determination is in-place-of and not ‘in-addition-to’ an actual RBT.

For this illustrative example, the second entry in table 180 along with RBT Authority (table 100) record=12 describes this example that returns two images (American idol logo and Jennifer Hudson info) some text and two buttons, one to download the song another to go the American idol home page.

Events 202A, B, C or D trigger this determination. Step 203A searches table 180 for a match on the phone number in column 181. This matches the second record in table 180, returning ‘carrier’ ‘American Idol’ from column 182

The retrieved value in column 182, the non-carrier value is then used as a key to table 100, column 102 to retrieve the RBT Authority record 12. Record 12 indicates ‘local-code’, indicating that a software apparatus on server 30 is to be called passing it ‘phone-b’. The implementation of this software apparatus is out of the scope of this disclosure. It accepts a phone B because it may process many different experiences based on who was called. Data would be returned in a 550

This local software apparatus returns this determination. The retrieved record 520 would contain an info item in the form of 550. Info title 553 would contain the words Time Warner Cable and the contact name, info data 1 (553) would a URL to the agent's image, and info data 2 (554), then call back information

Item 2009 shows an embodiment of this illustrative example.

### 3.b.ii.2. Method 2, Audio Recognition

The system supports audio matching of a clip recorded on phone A that was recorded from the time the call started to the time the call was ‘picked up’ against a collection of clips. In the system the audio matching service is treated as an RBT Authority. It may be used as the primary authority for a carrier or it may be used as a back-up authority should another RBT return no match or ‘ambiguous’ match. This later case of ambiguous match is illustratively a jukebox, but if could be other small sets of possible audio files.

The system supports two types of generation of the collection of clips for which to match against: 1) offline or 2) ‘on-the-fly’. In offline, feature extraction of the reference clips occurs at some time before the match is attempted. In the ‘on-the-fly’ configuration, the system takes a list of reference clips and extracts their features in real time, just before it attempts to match against the just-recorded clip.

The collection of extracted clips is stored in table 140.

Audio matching depends on its setup as an authority and whether phone A supports the required events to start and stop a recording and that supports the actual recording of the incoming audio stream from the time the user starts the call to the time the call is ‘picked up’. Steps 201A, 201B and 201C are only performed if all this is true.

In step 201A the app registers to receive a ‘call placed’ event. On receiving this event it start recording the incoming audio stream in step 201B. The app also registered for receiving the ‘call connect’ event. On receiving this event in step 201C the app stops the recording in 201D that was started in step 201B. The app then stores this recorded clip for possible use. It is possible, should there be no audio RBT authority, that this clip is not used in the ‘what I heard process’. In all cases it is discarded after ‘what I heard’ processing occurs.

Processing is directed to step 213 when 208 sees an RBT Authority record with the RBT Authority, column 103 set to ‘local-audio’ to use local audio processing, or column 103 indicates a server 50 to contact and the request in column 105 indicates that audio processing is performed. Both remote and local proceed as follows:

Step 213 is entered with 1) a recorded clip 2) the carrier for phone B and 3) the jukebox calculated from the previous RBT authority.

It is also passed 4) the value of RBT authority column 105, the request column, with an indication on how to process this list. For audio processing the values in this column encode the following: a) collection size to use: values include ‘carrier’, which indicates that the match should occur against clips marked with ‘carriers’ to indicate a match of just carrier or ‘jukebox’ to indicate that the list should match against carrier and the records in 140 whose ‘search unique ID’ are equal to the trackID in the passed RBT list. And b) a flag indicating if ‘offline’ or ‘on-the fly’ is to be used.

If ‘on the fly’ is indicated, step 213 extracts features from the reference clips before matching. If at the same time, ‘carrier’ is indicated, records from 140 are selected where column 142 is the passed carrier and the value in signatures is a URL to a reference clip instead of the signature itself. This becomes the list of on-the-fly clips. If at the same time ‘jukebox’ is indicted, the passed jukebox list has potential tracks in it. Each of these tracks contains 536, the URL of the track itself. Step 213 then takes the list of on-the-fly clips, and uses the audio matching service to produce a list of potential signatures

If ‘offline’ is selected, then if at the same time ‘carrier’ is indicted, all records from 140 are selected where column 142 is the passed carrier. This is the list of potential signatures. If at the same time, ‘jukebox’ is indicated, then all rows in 140 that match both carrier and whose search unique ID (143) is one of the tracks in the passed jukebox list (536) becomes the list of potential signatures.

The list of potential signatures from either offline or on-the-fly processing produces the list 904

Step 213 now prepares the recorded clip for match. Many carriers add a ‘please enjoy the music while your party is reached’ audio clip to the voice stream. A recorded clip during a phone's ringing period would include this (901). This clip is also administrable by the user and may or may not be played. for each particular carrier we make a copy of a truncated piece of the recorded clip containing only the number of seconds it takes to play the carrier phrase and remove anything after that (906) we then match 906 to a pre-analyzed clip of the phrase in 905 If there is a match we produce a clip without the phrase 903.

In another variation, the ‘please enjoy’ phrase may have a so called ‘audio water mark’. These are background, unheard frequencies combined with an audio clip that can be used to match a clip regardless of the actual words. Audio match processing would remove the part of the clip that contained the watermark as it did above. The watermark is shown in 907.

If there is no match to 905 we match the full clip 902 to 904, if there was a phrase match, we match the truncated clip 903 to 904. A match to either of these clips to 904 produces an explicit song that was heard on phone A and thus a record in table 140. Columns 145 and 146 are returned and passed to 219 so that the rule for this RBT authority can use these values to access the associated Metadata in table 110. Step 219 was discussed above.

If we did not have a match, then if this was a Jukebox match and the rule in this RBT Authority indicated to return the original jukebox if there were not a match we return the original jukebox (itself to be processed by 219 if needed). Otherwise we return ‘no match’ and 214 causes us to move on to the next RBT Authority if one exists.

### 3.b.ii.4. Retrieving Metadata and its Format

Metadata in the system is any of the information associated with a ‘what I heard/played’ determination. In one embodiment it also contains the actual RBT played in the form of a playable audio track. Metadata is passed to the display section. It is a different set of data for different types of ‘what I Heard’ determinations such as music, ad or corporate above. However it is treated generically, except for a few exceptions noted throughout until it is actually displayed.

Metadata can be 1) part of a ‘what I heard’ determination. This includes notification events in 202B, in ‘what I heard’ determinations or raw record determinations returned from server 40 or contained in records stored in 120. (these records in 120 may in turn have come from 202B or server 40, or through other processes not described herein, 2) be explicitly requested via an API request to server 40 by server 30 passing in an ID and getting Metadata on the return 3) be contained in table 110 and searched for by a data type column 112 and ID column 113, 4) be returned by server 30 in an API request for Metadata from a phone A or B (which in turn may call RBT Authority 40)

Metadata is an abstract collection of bytes that is then extracted from its source by using a schema to parse the data. This collection of bytes may be returned in API calls or it may be stored as a collection of bytes in 120. After a parse it then stored in a form, such as an array, structure or object that can be used by the display section. We will simply refer to the fields in these items and not discuss its specific implementation. A ‘type’ is also returned to the display section, illustrative examples include ‘music track’, ‘advertisement’, or ‘corporate RBT’.

The specific Metadata needed and displayed by carriers may change over time. We have provided illustrative examples in the form of schema in 530, 540 and 550.

530 is an illustrative example of a music track, fields include Track ID (531) a number that uniquely identifies the track in an external catalog to be used by function (described in inventor's concurrently filed application, entitled, “METHOD FOR SENDING AND RECEIVING METADATA CONTAINING REFERENCES TO DIGITAL MEDIA OR CONSUMER GOODS BETWEEN CALLING PARTIES,” inventor: Martin Gindi, attorney docket no. 82227.8002.US01, filed _{——————}, which is incorporated herein by reference in its entirety), Track Name (532) a text string with the name of the identified track, Track artist (533), a text string with the name of the artist of the identified track, Track album (534), a text string with the name of the album, Track Album art or URL (535) the actual image in-lined with the data or a URL pointing to an image associated with the album associated with this track. Track Clip or URL (536) the actual audio clip or a URL to the track that was just identified. These values are passed in associated fields to the display section once they are parsed.

550 is an illustrative example of a more generic form of the Metadata that can be displayed on a ‘what I heard/played’. It is used for such things as the corporate RBT described above or the advertising RBT, also described above’. fields include info ID (551) a number that uniquely identifies the info to some in an external entity to be used by function, Info Title (552) a text string describing what was heard, generic data in 553 and 554 (there could be more of these fields as needed by the type of thing heard.) In the advertising RBT example 553 is a URL to an image for this ad and 554 is a URL to an HTML5 snippet. These values are passed in associated fields to the display section once they are parsed.

540 is an illustrative example of a jukebox. For our purposes a jukebox may be any collection of individual tracks one of which may have been heard. This collection illustratively consists of tracks in the form of 530 or 550. fields include Jukebox ID (541) a number that uniquely identifies the jukebox to some in an external entity to be used by function, Jukebox Title (542) a text string describing this jukebox, 543 is a list of individual items in this jukebox, 544 is an individual item in the list and 545 is the data in the form of 530 or 550. There may be many 544's and 545's in the list. The title and ID are passed along with an array or some other type of list of the values in 554 and 545 to the display section once they are parsed.

Metadata is collected as needed in step 211, when the raw record doesn't contain enough information, and step 219 when a ‘what I heard’ determination doesn't contain enough information.

Additionally the special ‘local-enough’ value is used to possibly further process full or partial ‘what I Heard’ indications returned during the ‘event’ phase (all the steps 202). Here, the request and rule in the RBT authority indicate what to do with these indications.

### Actions Relevant to the ‘What I Heard’ Determination.

The metadata, or the rules associated with a particular metadata return may include reference to an action that can be performed as a result of this ‘what I heard’ determination. RBT determinations may include actions such as ‘rate’, purchase full track, recommend a new one and so on. A determination for American Idol voting line may include the action to get the track just sung by the person you voted for or have a link to americanidol.com

Various illustrative examples throughout this disclosure describe these actions, usually associate with the word ‘button’ as described in, amongst other sections, the sections labeled: “Advertisement”, “Corporate”, “Non-RBT from a particular number to a local-to-server-30 software apparatus” and with the description labeled “widget”.

As an illustrative example, the return of track-info, 530 schema used in conjunction with rule 6 in table 560 that ‘rate, recommend, buy full track’ are displayed. Or that various rules such as rule 14 in table, associated with an info scheme 550 return includes two buttons that have html actions and words to put on the button. Additionally, html5 return values described throughout this disclosure may contain these actions buttons and code for the actions themselves.

The current disclosure is responsible for the display of the action associated with the ‘what I heard’ determination and to store relevant information that may have come with the button when the button is pressed. The actual actions such as rating, recommend, get the American idol song are out of the scope of this disclosure.

### 3.b.ii.5. Location of Execution of ‘What I Heard’ and APIs

Execution of ‘what I heard’, step 203 through 214 and 219 are designed to be highly distributed. As illustrative examples of combinations that can occur; all these steps may occur on server 30, all these steps may occur on a phone A or phone b, some of the steps on phone A/B and some on server 30, some on phone A/B with API requests of 80 and 40, or server 30 incorporated in server 30, with server 40 providing services to phones A/B. Server 30 can act as a ‘what I heard’ service to third party entities 95. Audio processing could occur on server 50 or on phone A/B. server 50 may reside on server 30.

If the service resides on phone A or B, or 40, all the database tables shown as connecting to server 30 may reside in phone A or B as well on server 40.

Servers 30, 40 and 50 include or are expected to provide API services to the other entities in order to effect this distribution.

3.b.ii.5.a. APIs Provided by Server 30

When steps 203 through 214 and 219 execute on server 30, server 30 provides APIs that may be accessed by Phone A or B, server 40, third parties 95 or network 10 or 20. These APIs include 1) what-I-Heard/played and 2) get meta-data.

The ‘what I heard/played’ takes as input Phone A, Phone B and optionally the recorded clip from steps 201A to 201D. It returns ‘what I heard/played’, an error or partial success for a jukebox, indicating that the calling entity could do audio processing if it so desired. Additionally this API may optionally take ‘carrier’ (for when it is called from server 40 or 95). Server 30 provides this API service by processing all the steps 203 through 214 and 219 using the appropriate defined RBT authorities for phone B, contacting server 40, 50 and 80 as needed.

When the API service is performed on server 30, it enters at step 204 and exits via 217g.

‘Get Metadata’ provides Metadata as defined above and used in steps 211 and 219 when those steps are executed on phone A or Phone B. phone NB would call this service whenever it only has the title or ID of a ‘what I heard’ to retrieve the remaining Metadata needed and the Metadata does not reside on phone A or B. ‘get Metadata’ takes as input any or all of the following; a ‘date type’ (e.g. track or info,), an ID, and/or partially retrieved information such as ‘title’ or ‘advertising company’. It returns Metadata associated with the request. Server 30 searches table 110 using data type and ID and sometimes accessing the data itself to search for matches on title. It may also search table 120 for matches on the data. Additionally server 30 may pass the ‘get Metadata’ call on to server 40.

In another variation ‘get Metadata’ may be called from server 40, 50 or third party 95.

The ‘what I heard’ API to server 30 supports phone numbers passed in ‘global dial plan’ format or a string or binary value. See ‘phone numbers’ section below for details.

The following are implemented as APIs on server 30 if business rules require them. These are all related to various global phone number verification schemes. 1) ‘verify request’ takes as input a global phone number. It stores the global phone number and sends a verification text message to that phone number via text service 97. 2) ‘Verify check’ is called at a later date to return the verification status of a passed global phone number. It returns the status, ‘pending’ or ‘verified’ to the user. 3) ‘Store unique/phone pair’. Stores the pair of unique number and global phone number. 4) ‘Get phone via unique’ takes a unique number and returns the stored global phone number.

As another variation, a GPS value, usually containing the location of the current handset may be included in the API call to server 30. This value may be used in rules and request values for a local RBT authority or for passing on this value to a server 403.b.ii.5.f. APIs on-the-phone

The ‘what I heard’ service that is resident on the phone may be accessed by third party apps on the phone (on phone versions of 95) in a number of ways.

Binary ‘what I heard’ service. here, steps 204, 203A, 205 through 214, 219 and the return 217G are compiled into a binary deliverable for each type of phone OS that is supported by the service. The third party app would then include this binary deliverable in their distribution. The third party will be provided with a specification on the use of this API, values to pass and parameters to expect on return. The API accepts Phone A and Phone B as input and optionally a recorded clip of the RBT heard. It returns ‘what I heard’ display Metadata, or an error.

Broadcast with ‘what I heard’. 220A, ‘what I heard’ broadcast events distribute on-phone ‘what I heard’ display Metadata to other apps. See that section for how they are implemented. There are three ways a third party app may access these services; 1) register for an asynchronous event that will deliver the ‘what I heard’ display Metadata within the event. 2) Register for a ‘what I heard’ asynchronous event that indicate that the third party app should access a data store to retrieve the ‘what I heard’ display Metadata, 3) the third party app polls a data store that contains ‘what I heard’ display Metadata. The selection of the method for a particular app depends first on the capability of 220A as implemented on a particular phone, and then, given the choices of method available on that phone, business rules for the third party app.

Additionally, a third party app may pick up ‘what I heard’ display Metadata from the output of 220B, the call log, and 220C, the address book. The setup and use of these data stores is dependent on the phone. Additionally, depending on phone capabilities, 220A or 220B may not be implemented.

3.b.ii.5.b. APIs Provided by Server 40

As noted, the services on server 30 may be physically located on server 40. In this case, server 40 provides all the APIs described in 30 above.

Certain Server 40 RBT Authorities may not accept global dial plan phone numbers, instead requiring a string or binary value. Server 30 supports a one-to-one translation scheme to translate these before sending. (See notes on phone numbers below)

The following are provided and used as APIs on server 40 if business rules require them. These are all related to various global phone number verification schemes. 1) ‘Carrier login’ takes as input an already registered user ID and password for the carrier account. The login returns various user values. Only the global phone number is extracted from this and saved

3.b.ii.5.b. APIs Provided by Server 50

When steps 213 and 214 are executed on server 50, server 50 provides a single ‘Audio-ID’ API to server 40 or to phones A and B and in other variations to server 40 and third party 95.

The ‘Audio ID’ API takes as input all or some of; 1) the clip to be ID'd, 2) the jukebox being searched, 3) carrier, 4) collection size (carrier or Juke), 5) offline or on-the-fly indication, 6) please calculate Metadata. Input 1 thorough 5 relate directly to values discussed above in the audio ID section, step 6 optionally forces step 219 to be performed. In this case server 50 contacts server 30 for Metadata before returning results. The ‘Audio ID API’ returns 1) data type and ID of ID'd track or 2) the Metadata for the track or 3) no id made.

3.b.ii.5.d. APIs Expected of Networks 10 and 20

In some circumstances depending on business rules and technical need, network 10 or network 20 may provide lists of call logs that access tables 10A or 20A, the list of calls, incoming, outgoing and missed as recorded by the network.

If it exists, the API illustratively it takes as input a phone number, and returns recent phone calls. It may implement this as one call for each type of call action, i.e. incoming to this phone number, outgoing from this phone number or missed calls to this phone number, or it may return all types at once. It may allow for ‘all calls’ to be returned or just calls since the last time the app was called.

3.b.ii.5.c. APIs Expected of Server 40

As part of the processing distribution in the system, certain APIs may be needed from server 40 to server 30 or phone A/B. These server 40's are operated by differing entities worldwide. The APIs provided, if any, by these server 40s and thus the details of these APIs can only be described in illustrative fashion. As described above, server 30 as well as phone A/B may provide ‘what I heard’ service without calling server 40 at all.

The following are broad categories of illustrative APIs provided by servers 40.

Raw record: this API takes as input a phone B and returns a raw RBT record that is processed in step 211. This returned record may contain Metadata for the various RBTs or jukeboxes within the raw record or it may provide ID codes that need to be resolved either on server 30 or phone A/B or by an additional API call to server 40.

What_i_heard: this takes as input phone A and Phone B and directly returns ‘what I heard’. This returned record may contain Metadata for this ‘what I heard’ or it may provide ID codes that need to be resolved either on server 30 or phone A/B or by an additional API call to server 40.

Get_Meta_Data: API service provided by server 40 similar to that described above with server 30. Server 30 may pass the request to its API on to server 40.

All of these API returns from server 40 may be cached in table 120 or 110 on server 30 and in some variations on phones A and B.

Depending on business rules a server 40 API may also accept a GPS value for the server 40 to use in determining ‘what I heard’ or as a parameter in retrieving a raw record.

3.b.ii.5.d. APIs Expected of Notification Service 60

Service 60 provides the ability to send asynchronous notifications to phone A and B.

The API provides all or some of the following: 1) the phone a way of registering and sending its own phone number along with the registration, 2) callback or polled API from a server to retrieve the registration event with the phone number 3) an API that the server may call to send a notification. The specific format of these values and the exact interaction with this API is defined by the notification service provider. The system will adapt accordingly to use these values.

3.b.ii.5.d. APIs Expected of Phone Number to Carrier Service 80

Service 80 provides phone number to carrier information to server 30 or to phone A or phone B.

The API takes as input a phone B phone number and returns a carrier name suitable for matching column 102 in the RBT Authority table. The specific format of these values and the exact interaction with this API is defined by the phone number to carrier information service provider. The system will adapt accordingly to use these values.

3.b.ii.5.d. APIs Expected of ‘has App’ Service 90

Service 90 provides ‘has app’ service. This API and service is described in detail below in ‘When Other Side does not have app’

3.b.ii.5.d. APIs Expected of the Text Message Delivery Service 97

Service 97 provides text message delivery service for server 30 directly or through the ‘has app’ service 90.

The API takes a destination phone number and text for a text message. The specific format of these values and the exact interaction with this API is defined by the text message delivery service provider. The system will adapt accordingly to use these values.

3.b.ii.5.e. Notes on ‘What I Heard’ Execution on Phone A or Phone B

There are some special considerations for starting the whole what I heard process from the phone and for running ‘what I heard’ on the phone.

There will be a number of variations of the complete system running on a phone depending on business needs and phone capabilities. These variations include the ability to generate events 201A, B and C and 202A, A, B, C and D. Some phones may have full to partial implementations of the steps 203A through 214 and 219 depending of the phone's capability and business needs. Many will have some version of the RBT Authority table, while others may have copies of most of the tables that exist on server 30. Some go to server 30, others to server 40. Some may implement a version of server 50 on the phone. Many different versions of the App will exist on many different phones all with these different variation.

An RBT Authority table usually exists on the phone and is queried to start the process of ‘what I heard’. It has two special values ‘enough’ and ‘track info’ for use with 202B. Other than that it is started at ordinal=1. Some phones may include step 203A to help select an RBT Authority, some may skip these. If step 203A is performed phone A or B contacts phone to carrier authority 80 directly. The records in the RBT Authority allow contact to servers 30, 40 and 50 as needed

There may be a RBT Authority on phone A or B and another on server 30. An illustrative example of this would have the phone's RBT Authority table indicating that it should call the RBT authority API on server 30 with a ‘What I heard’ request. Then the RBT Authority table on server 30 would indicate that it would first call server 40 with a raw request. server 30 would do this, calculating the actual RBT played from the record it gets from 40, returning a ‘what I heard’ to phone A or B

Steps 202A, B, C and D start on the phone. Depending on a phone's capability all or some of these may be implemented. Each of these has certain data available to them and each would then require different things of the ‘what I heard’ system,

202A, call complete events have phone A and phone B and thus need to call a full ‘what I heard’ service. An RBT authority with ordinal=1 is started to process this. Step 203 is executed on the phone and always directs flow downward though 203A (203A may or may not be implemented on the phone, so it proceeds to 205.)

202B, 202B and 202C have many variations of data: they may only have ‘the other side's phone number, they may have an ID indicating what was played or they may have the full Metadata. If full data is included an ‘enough’ record is searched in the RBT authority list. If partial data, a ‘track info’ item is searched in the RBT Authority list. Otherwise an RBT authority with ordinal=1 is started to process these events. Step 203 directs flow to ‘what I heard’ if any ‘what I heard’ data is passed and step 219 would do the ‘enough’ and ‘track info’ processing, otherwise flow is directed downward though 203A (203A may or may not be implemented on the phone, so it proceeds to 205.). Note that 202b may include a number of individual phone call records; each of these would be processed in turn.

An Audio server 50 may be implemented on the phone. In this case a table 140 may be installed on the phone or it may implement an ‘on-the-fly’ only version of the service.

3.c. Display Methods for ‘What I Heard (or Played)

Having obtained ‘what I heard’ Metadata for one or more RBTs. as well as phone A, Phone B and direction from events 202A thought 202D, the information is displayed to the user on either phone A or Phone B. in addition ‘carrier’, calculated in 203 and ‘RBT Authority’ calculated in 205.

Depending on the capabilities of particular phones and business needs the software apparatus on Phone A or Phone B will incorporate one or more of the methods 217A through 217F to display this Metadata. Furthermore some display decision may occur in real-time by querying a phone's own capabilities or consulting with device information returned from the phone number to carrier service (80) or the has app service (90) None of the combinations of all or some of the display method are mutually exclusive and each stands on their own.

The user may switch display methods manually. as an illustrative example, the widget may display a small part of the last ‘what I heard’ and some action of the user may cause the ‘normal phone app’ display to show more of it.

All the data collected as Metadata related to the RBT played as well as Phone A, Phone B and direction can be displayed using each of the display methods. The actual data displayed on phone A or phone B is dependent on business rules for a particular implementation. As illustrative examples, for each display method we will show how a string or table in the form ‘(1) outgoing (or incoming or missed) call (2) (to/from) (3) ‘George’. You (4) heard (played) (5) RBT/Jukebox, (6) press ‘here’ for more information. (7) An image related to ‘George’ will also be displayed. Each of these numbered fields are displayed and described below. Collectively this string or array is ‘what I heard’ visual display.

(1) Outgoing (or incoming or missed) was collected during even 202A through 202D and stored as ‘direction’. It is directly displayed.

(2) to/from. If direction=‘outgoing’ the word ‘to’ is displayed. Otherwise ‘from’ is displayed

(3) Is who is called or being called from? Business rules dictate if the phone number is used here or a person's name, such as ‘George’ is displayed. If it is a phone number that value is directly inserted. If it is a person's name it is obtained from the phone's address book. The address book on a phone may be viewed as a database with a key value that may be someone that is stored in a phone's address book. ‘George’ may be obtained by using phone A or phone B as a key into the table. If call direction=outgoing phone number B is used as the displayed number or key into the address book. If call direction is other than ‘outgoing’ then call phone number A is used as the displayed number or key into the address book.

(4) If direction=outgoing then ‘heard’ is shown, otherwise ‘played’ is shown.

(5) Is the ‘what I heard’ RBT itself. For a music track it is track title (532), track artist (533) and track album (534), as an illustrative example it might say track title by track artist on track album. For ad and corporate RBTs it is ‘info title’ (552).

As an illustrative example, should the ‘what I heard’ process return ‘ music Jukebox’ it indicates that it could not determine, with a certainty which of the constituent tracks were played. The display section has the title and image associated with the overall jukebox. It also has the track information (title, artist, album, and image) of each constituent track. as a general mater it can display this information 3 ways; 1) display the Jukebox title and image, 2) display the list of titles, artists, albums and album images, with words to the effect of ‘you heard one of these’, or 3) a ‘button’ element on the screen, usually in conjunction with #1 to further display the constituent tracks. We will discuss the relevance of each of these in illustrative examples for music RBTs for each method below

(6) There is often an action associated with the RBT. However the current disclosure is responsible for collecting data so that further interactions on this RBT may be identified in a catalog of objects known to other services and other phones. As illustrative examples, the following is passed for each of the illustrative Metadata examples: (1) for a music track, the track ID (531) may be used to identify this music track along with the ‘carrier’ and ‘RBT Authority’. Alternatively, Track Name (532), Track Artist (533) and Track Album (534) may be combined to identify this music. (2) For a jukebox, Jukebox ID (541) along with the ‘carrier’ and ‘RBT Authority’ may uniquely identify this Jukebox. (3) for Ad RBT and Corporate RBTs, Info ID (551) along with the ‘carrier’ and ‘RBT Authority’ may uniquely identify this Ad or Corporate RBT. Additionally, the pointer URL stored in 553 or 554 may encode enough information that the originator can use to uniquely identify this track.

Additionally all ‘what I heard’ determinations may also simply pass the full set of Metadata on to this action section for additional display and interaction.

(7) The image or the image URL is in the Metadata. If the image is includes it would be in line binary data in the Metadata. If it is a URL, the phone retrieves the image by accessing the URL included and using the results as an image. For a music track the image or URL is stored in 535, for a Jukebox it is the jukebox image in 546, for an ad or corporate RBT it is stored in 553 or 554.

The ‘what I heard’ app allows for various events to trigger ‘what I heard’ processing on the phone. These events 202A through 202D cause the display action 217A through 217F. Each of the sections below on each of these display actions will describe how the event and subsequent ‘what I heard’ processing would occur and how its completion would cause the ‘what I heard’ visual display to be updated with the correct information.

The display options represent specific embodiments of events and ‘what I heard’ processing into a software apparatus. The sections below will describe those embodiments.

3.c.i. Widget

For 217A and its associated FIG. 300 the widget, the system displays the ‘what I heard’ visual display in a passive screen location within a container on the phone's home screen. Alternately, this widget may also be included the screen space of another app (an ‘in-app’ widget’). Visually, the ‘what I head’ visual display in the widget is updated within a few seconds of call termination with the ‘what I heard’ visual display of the last call.

For illustrative purposes a home screen widget contains parameters that define the size the widget relative to the full screen size. It generally takes a fraction of the overall screen size. Some phones allow the user to place the widget wherever he or she desires at different spot on the screen. Others are positioned absolutely. Some systems allow them to be manually installed and deleted, others do not. In-app widgets are widget containers that are not displayed on the home screen, but rather in the container of another, third party app. this app controls location of the in-app widget within the app.

Whether home screen or in-app the operating system that the widget resides allows an event to be caught via a callback or event catcher or a poll to occur in order to update the ‘what I heard’ visual display. additionally, to allow interaction after ‘what I heard’ is displayed the operating system allows certain areas within the widget area assigned to the ‘what I heard’ app to be ‘touched’ for selection purposes or to allow some other manual means of selecting controls.

For 202A in a widget, the call completion event registers for call completion events as described above. This call completion event may execute within the execution space of the widget or it may be a separate executable.

When the event fires, If this is embodied in a separate executable, that executable would asynchronously start ‘what I heard’ processing. When completed it sends a ‘what I heard’ completion event to the widget, or it deposits the results at a location where the widget's poll mechanism picks it up. If an event was sent, the widget would update the area designated for the ‘what I heard’ visual display. If a data poll, the widget would pick up the results saved on the next poll and update the area designated for the ‘what I heard’ visual display.

If the call completion event is processed within the widget execution space itself the call completion processing can occur asynchronously or synchronously. Asynchronously, the call completion event 202A starts a thread (or it causes the main thread to execute) ‘what I heard’ processing. Once completed this asynchronous processing updates the area designated for the ‘what I heard’ visual display. In synchronous processing, the widget service on the phone allows for URLs to be processed at some scheduled time. On receiving a 202A event, processing continue until the middle of step 209. In that step the URL to contact the remote RBT authority is calculated and passed to the widget synchronously processing handler for execution sometime in the future. The widget mechanism sends the URL and then notifies the app to continue in the middle of step 209 which processes the resulting ‘what I heard’ or raw response. The widget would then update the area designated for the ‘what I heard’ visual display.

Event 202B, an external notification. As noted, these events have, some, all or no data included with them. In the case of ‘no data’, processing of step 202B described how the call log is scanned for new calls. This would result in ‘some’ of the Metadata being retrieved and processing proceeds as described below. This would be done within the widget's executable or separate executable as described in 202A. A 202B event may also have multiple phone calls included. Each is processed in turn. Alternately the call log API on networks 10 or 20 is called to scan for the same purpose.

If the event has all the Metadata needed for a ‘what I heard’ visual display this information is immediately displayed in the area designated for the ‘what I heard’ visual display in the widget

If there is partial data, a complete ‘what I heard’ cycle occurs exactly as described with a 202A event in a widget.

Event 202C, running an app, does not directly start processing in a widget and is not considered here.

Event 202D, a periodic poll, the widget picks up ‘what I heard’ data from some external event or notification stored for its retrieval or it scans the call log for recent call. The periodic poll is started within the widget execution space, when the poll is triggered, the widget process this the same way as 202B; if there was all the Metadata waiting for the widget when the poll occurs it is directly displayed. If there is partial data, it continues as per a 202A event.

Event 202F, call progress protocol is not directly relevant to this display method (i.e. it does not trigger this display method directly), rather it stores ‘what I heard’ data in a known location that me be picked up by this display method.

Event 202G, run of a call app, is not relevant here as it is only relevant to display method 217I

In another variation the call log, or latest calls may be retrieved via API from networks 10 or 20. These logs at a minimum have phone A, phone B and call direction and may contain more ‘what I heard’ data. If business rules allow it, and network 10 or 20 support this, then an API call is made to network 10 or 20 to retrieve call lists. Should they be retrieved, processing continues as if a local call log had been scanned as described in the previous paragraph.

Depending on space allocated to the current ‘what I heard’ visual display for the widget on a particular handset, all or some of the sample string and image are displayed within the area reserved for the widget. If it is not fully displayed, a control button touched or navigated to allow for more of the information to be displayed. For jukeboxes, the jukebox title is displayed. If there is room and a specific track had not been determined, all constituent tracks are displayed, or a control button touched or navigated to allow all constituent tracks to be displayed.

This widget software apparatus stays active once installed on the phone by the user. It processes events 202A, 202B or 202D in a continuous loop using the execution mechanisms described herein. Depending on business rules, the widget may continue to display previous ‘what I heard’ determinations on the same widget area.

As further ‘what I heard's are displayed within the widget, these newly arrived items displace older ones or go further down in scroll lists. The specific rules for displacement are determined by business rules, phones, and phone screen size.

The widget allows transition to the normal phone app display mechanism 217E by doing a ‘run app’ 202C and may be triggered by an ‘interact’ button or some other button. The widget process deposits the ‘what I heard’ Metadata result in a location that may be picked up on the execution of 202C.

Depending on business rules and the phone, it may send an inter-process event for any other process that may be listening indicating that this Metadata is available. The Metadata itself may be part of those inter-process messages. On certain phones, this inter-process message may also start the ‘what I heard’ app. this is treated as a ‘run app’ (202C)

Exiting the widget would stop display of ‘what I heard’ on the phone's screen, however the background processing with events 202A, 202B and 202D may continue to occur and collect data associated with each for display later by re-invoking the widget 217A or with the normal phone app display 217F.

FIGS. 2001 and 2005 show illustrative embodiments of the widget display method:

What I heard widget (2001): Illustrative embodiment of the widget display method, 217A showing a real time display of ‘what I heard’. This shows ‘what I heard’ Metadata including Album art, track title, artist name and album. This example also shows an interact button related to interacting with the current ‘what I heard’. Also shows a display of past ‘what I heard’ and ‘what I played’ results.

What I Played Widget (2005): Illustrative embodiment of the widget display method, 217A showing a real time display of ‘what I played’. This shows ‘what I played’ Metadata including Album art, track title, artist name and album. This example also shows an interact button related to interacting with the current ‘what I played’. Also shows a display of past ‘what I heard’ and ‘what I played’ results.

3.c.ii. App POP UP

For 217B, the app pop up, one of the events 202A, 202 B or 202D causes an app to become visible on the main display of the phone. This app then shows ‘what I heard’ or played. The pop-up may take up all of the display normally reserved for regular applications or it can pop-up over a small area of the display over the image that had been visible prior to the pop-up.

FIG. 320 illustrates the pop-up. In FIG. 320 it is shown as sliding in from the bottom. This is one illustrative example. Illustratively it may also appear without a transition, slide in from the left or right, spin or fade in, or parts of it can slide in from various directions or it can rotate in. The specific transition is a business decision and it based on the phone's capability.

Depending on business rules and whether the phone's OS supports it, 217B is often available in conjunction with other display methods. (i.e., both a widget and a pop-up). Depending on business rules, 217B may be activated or deactivated by the user or continually activated without the ability to turn it off.

When the pop-up is activated for use, processing at various points in the event-to-‘what I heard’ path cause the phone's operating system to execute the app and to cause it to become visible. Processing then continues to display the ‘what I heard’ visual display.

In all modes, the app configures itself to allow the OS to activate it on receipt of a certain event as described below.

For 202A in a pop-up, the call completion event registers for call completion events as described above. This call completion event may be the event that activates the app or the call completion event may activate a separate executable.

If the call completion event causes the app to become visible, then the app spawns a separate thread to perform the ‘what I heard’ service. While this thread runs a visual ‘processing’ visual is shown (conventionally these are rotating arrows, but it may be many things). Alternately, ‘what I heard’ may run in the main thread. On completion of ‘what I heard’ the processing visual display is removed and the pop up would then update the area designated for the ‘what I heard’ visual display within the pop-up window.

If the call completion event is sent to a separate executable, that separate executable may, depending on business rules and the phone's capability, after storing the phone numbers and call direction, immediately send the app activation event. Processing continues the same as the previous paragraph. Alternately, complete ‘what I heard’ processing may occur in the separate executable. If that is the case, once the separate executable completes and has collected all the Metadata for the ‘what I heard’, the Metadata is stored by this separate executable at a location that the pop-up may pick up, then the separate executable sends the activation event to the pop-up. The pop up would then update the area designated for the ‘what I heard’ visual display within the pop-up window.

Event 202B, an external notification: As noted, these events have, some, all or no data included with them. In the case of ‘no data’, processing of step 202B described how the call log is scanned for new calls. This would result in ‘some’ of the Metadata being retrieved and processing proceeds as described below. This would be done within the pop-up's executable space or in the separate executable as described in 202A. A 202B may have multiple phone calls returned, in which case, each are processed in turn. Alternately the call log API on network 10 or 20 is called to scan for the same purpose

If the event has all the Metadata needed for a ‘what I heard’ visual display this information is immediately displayed in the area designated for the ‘what I heard’ visual display in the pop-up

If there is partial data, a complete ‘what I heard’ cycle occurs exactly as described with a 202A event in for a pop-up.

Event 202C, running an app, does not directly start processing in a pop-up and is not considered here.

Event 202D, a periodic poll, is processed in a separate executable to start. The separate executable registers for a call-back at some interval. This separate executable picks up ‘what I heard’ data from some external event or notification stored for its retrieval or it scans the call log for recent calls. As with 202A in a pop-up, this separate executable may completely process ‘what I heard’, or it can pass information to the pop-up to continue execution. In either case it sends the activation event to the pop-up.

Event 202F, call progress protocol is not directly relevant to this display method (i.e. it does not trigger this display method directly), rather it stores ‘what I heard’ data in a known location that me be picked up by this display method.

Event 202G, run of a call app, is not relevant here as it is only relevant to display method 217I

In another variation the call log, or latest calls may be retrieved via API from networks 10 or 20. These logs at a minimum have phone A, phone B and call direction and may contain more ‘what I heard’ data. If business rules allow it, and network 10 or 20 support this, then an API call is made to network 10 or 20 to retrieve call lists. Should they be retrieved, processing continues as if a local call log had been scanned as described in the previous paragraph.

‘What I heard’ visual Metadata display in the pop-up is the same as the widget above, however there is generally more space on the screen for the display, so depending on screen size and business rules, much more can be displayed. Depending on business rules and screen space the pop-up may display previous ‘what I heard’ determinations that were stored by the pop-up process or other what I heard processes.

This pop-up software apparatus is meant to display the results of the current ‘what I heard’, and optionally some previous ‘what I heard determinations’ it is either dismissed by the user, or is caused to be dismissed depending on business rules by other events in the system such as a screen timeout or preemption by another app. A version of this preemption occurs when a phone call is placed or received resulting in the dismissal of the current version of the pop-up. After the call is competed, another 202A, 202B or 202D would trigger a new pop-up.

The pop-up allows transition to the normal phone app display mechanism 217E by doing a ‘run app’ 202C and may be triggered by an ‘interact’ button or some other button. The pop-up process deposits the ‘what I heard’ Metadata result in a location that may be picked up on the execution of 202C. Depending on business rules and the phone, it may send an inter-process event for any other process that may be listening indicating that this Metadata is available. The Metadata itself may be part of that inter-process message. On certain phones, this inter-process message may also start the ‘what I heard’ app. this is treated as a ‘run app’ (202C)

Exiting the pop-up does not stop the background processing of events 202A, 202B and 202D. These continue to occur and collect data associated with each for display later by running the app with 202C.

FIGS. 2000 and 2004 show illustrative embodiments of the pop-up display method:

What I heard pop-up (2000): Illustrative embodiment of the pop-up display method, 217B showing a real time display of ‘what I heard’. This shows ‘what I heard’ Metadata including Album art, track title, artist name and album. This example also shows an interact button related to interacting with the current ‘what I heard’. Also shows a display of past ‘what I heard’ and ‘what I played’ results.

What I Played pop-up (2004): Illustrative embodiment of the pop-up display method, 217B showing a real time display of ‘what I played’. This shows ‘what I played’ Metadata including Album art, track title, artist name and album. This examples also shows an interact button related to interacting with the current ‘what I played’. Also shows a display of past ‘what I heard’ and ‘what I played’ results.

3.c.iii. Notification Style Displays

Displays 217C, Notification bar, 217D, Drag down notification and 217F and Numeric badges represent ways of displaying out-of-band messages to a phone user. (Background: on some phone's notification events as described in 202B and the notification display on the phone are collectively referred to as the ‘notification system’, and are sometimes used in tandem, but in-fact there are always two separate concepts.). The implementation of these three types of displays in the what-I-heard app is similar and differs only in the final display step.

They share the characteristic in that only a small amount of information is displayed to the user and are coupled to some action, supported by a phone's operating system, to allow an associated, fuller application to be run to find out more information. As a result, they will, depending on size, show a smaller part of the ‘what I heard’ meta-data and allow a larger application to be run to show the remaining information.

FIG. 310 shows a 217C navigation bar and a pop-up alternate. In this display, the notification bar may be used on phones that support a small amount of screen space, sometimes, the top of the phone to display small text and graphic messages. Alternately, some phones produce a small temporary pop-up that fades shortly after appearing. These two methods are equivalent. The ‘what I heard/played’ message is displayed here. In a number of phone operating systems, this bar or pop-up is not actionable, that is, the larger app to see more of the information cannot be launched from the navigation bar, instead, they require the user to go to the drag-down display (217D). Should a phone however support direct app launch from this area the procedure described here supports it.

FIG. 330 shows a 217D drag down notification. In this type of display ‘what I heard’ is seen when the phone owner takes an action to view a list of notifications on his or her phone. Often this is performed by a ‘drag down’ finger action, but it can in fact be other actions, illustratively including a button press, or navigation to a location and pressing select. Depending on the phone, the ‘what I heard’ notification displayed here allows the larger application to be run to see more information or to interact with the RBT.

FIG. 340 shows a 217F badge. In this display mechanism, no direct information about ‘what I heard’ is displayed to the user. Instead, a small circle or other type of display is shown next to the icon on the phone that launches the ‘what I heard’ app. The icon's presence and count indicate that there have been ‘heard RBTs’ since last the app was run’. The phone's user knows this convention and launches the app to find what RBTs have arrived.

Note: this section does not cover systems that display text, or graphics as notifications within the phone OS framework itself, later requiring the user to take an action to start the app . . . I.e. a system where notifications are displayed on the phone without being sent directly to the app if the app is not running. In that type of system the notification display of the OS displays the message without involving the ‘what I heard’ software apparatus. The follow-on manual start from these types of external display notification is treated as a ‘run app’ 202C. This section also does not cover OS badge systems that increase a badge value without calling the app to increase the badge.

202A, 202B and 202D are embodied in these display types as a background process. The OS is configured to execute this background process on receipt of any of these events. In another variation, the software apparatus is run manually or automatically at startup and it puts itself in the background. In this variation the background process registers that it is waiting for 202A or 202B events, or it sets a timer to trigger a 202D at specified intervals.

For 202A, the call completion event registers for call completion events as described above. When a call completion event fires, the background process retrieves phone A, Phone B and direction and starts execution of ‘what I heard’ in the background. Upon completion it displays the ‘what I heard’ visual display as described below.

Event 202B, an external notification. As noted, these events have, some, all or no data included with them. In the case of ‘no data’, processing of step 202B described how the call log is scanned for new calls. This would result in ‘some’ of the Metadata being retrieved and processing proceeds as described below. This would be done within the background process. A 202B event may contain many phone calls, each are processed in turn. Alternately the call log API on networks 10 or 20 is scanned for the purpose.

If the external notification has enough data as defined by business rules (or it has all possible data) then this would directly result in the display of ‘what I heard’ visual display as described below. Upon completion it displays the ‘what I heard’ visual display as described below. If it did not have enough Metadata to display the background process starts execution of ‘what I heard’. Upon completion it displays the ‘what I heard’ visual display as described below.

Event 202C, running an app, does not directly start processing in a widget and is not considered here.

Event 202D, a periodic poll, the background process picks up ‘what I heard’ data from some external event or notification stored for its retrieval or it scans the call log for recent call. The periodic poll is started within the background process' execution space, when the poll is triggered, the background process processes this the same way as 202B; if there was all the Metadata waiting for the background process when the poll occurs it displays the ‘what I heard’ visual display as described below. If there is partial data, the background process starts execution of ‘what I heard’. Upon completion it displays the ‘what I heard’ visual display as described below.

Event 202F, call progress protocol is not directly relevant to this display method (i.e. it does not trigger this display method directly), rather it stores ‘what I heard’ data in a known location that me be picked up by this display method.

Event 202G, run of a call app, is not relevant here as it is only relevant to display method 217I

In another variation the call log, or latest calls may be retrieved via API from networks 10 or 20. These logs at a minimum have phone A, phone B and call direction and may contain more ‘what I heard’ data. If business rules allow it, and network 10 or 20 support this, then an API call is made to network 10 or 20 to retrieve call lists. Should they be retrieved, processing continues as if a local call log had been scanned as described in the previous paragraph.

The Metadata needed for the display having been collected, it can be displayed in the required mode;

In a 217C notification bar display a text string that is a proper subset of the illustrative display string is passed to the OS API that displays the information in the notification bar or as a ‘pop-up’ notification window. On some phones a small icon may also be displayed. On some phones this area or pop-up is selectable so the user may see more information. On other phones a 217D display is also needed to allow the user to see more information. In some variations the call to the OS that produced 217C also stores the same message in a 217D type display.

In 217D, a drag-down notification, a text string that is a proper subset of the illustrative display string is passed to the OS API that displays this information in the drag-down list. Selection of this ‘what I heard’ item in the drag down list allows the user to see more information.

In 217F a badge, the OS feature that displays badges is called. Depending on the phone, this feature takes either an absolute value or an increment command. In some variations the called activates the badge, in others; a non-zero value for the badge count automatically displays the badge.

The Metadata information needed for a badge is minimal. Depending on the phone and business rules, it need only be the fact that a call has occurred. Upon receipt of this information, if needed the ‘what I heard’ software apparatus activates the badge. If an incremental OS call is supported it is called, if a numeric value is needed the background process keeps a count, adds one to it, and passes it to the OS feature. Reading of the any of the ‘what I heard’ Metadata requires the app to be started with as 202C.

Badges are reset when the software apparatus started in 202C executes.

This background process stores the Metadata collected in all cases. All of these cases require a start of the app via a 202C to read the data. For a 217C this may occur with a selection on the notification bar or pop-up. For 217D it is a selection from the drag-down list, for a 217F it is the regular ‘launch’ app mechanism on the particular phone.

In one variation, when the ‘normal phone app’ (217E) is active when these background processes receive ‘what I heard’ information, no display is sent to the notification bar, notification pop-up or drag down notification, instead, Depending on business rules and the phone, it sends an inter-process event to the running 217E. The Metadata itself may be part of those inter-process messages.

This background process software apparatus stays active once started; it processes events 202A, 202B or 202D in a continuous loop using the execution mechanisms described herein. If the process is stopped, then the system is incapable of displaying 217C, 217D or 217E displays

3.c.v. Run App

In 217E, Normal phone app, the last ‘what I heard’ is shown within the ‘normal’ area of an app for a particular phone. Previous ‘what I heard’ Metadata may also be displayed. For most phones this is full screen minus the annunciator area at the top, but it can be a smaller portion or a window. It may also display older RBTs.

A 217E display starts with a ‘run app’ (202C), however, once 217E is active on the phone, 202A, 202B and 202D events may be sent to it and will update the ‘what I heard’ display accordingly.

202C is started manually by the user from: 1) the phone's app selector menu, 2) the phone's notification bar, notification pop up (217C) or drag down notification (217D) 3) by requesting more information from the widget (217A) or pop-up (217B). 4) Startup by another app on the phone, possibly with startup parameters containing Phone A, Phone B and direction. It may alternately pass a contact record from the phone's address book.

With the app started by a 202C the software apparatus checks for the following depending on business rules and phone capability: 1) ‘what I heard’ Metadata, with various amounts of Metadata that had been deposited by 217A, 217B, 217C, 217D and 217F displays. 2) Queued phone operating system notifications, 3) the phone's call logs in 1A, 3A, 5A. 4) The call log API on networks 10 or 20. 5) Startup parameters that contain phone A, phone B and direction. If just phone B is provided, phone A is set by 202C to ‘this phone’, and call direction is set to ‘outgoing’. 6) Pointer to a contact record passed at startup. Here the phone number for phone B is extracted from the contact record passed and A is set by 202C to ‘this phone’, and call direction is set to ‘outgoing’

Once the app is up it then responds to 202A call completion or 202B external notifications. It may implement its own 202D periodic poll to check the call log, access the call log API on network 10 or 20 or to check for newly deposited Metadata. Additionally a manual ‘refresh’ button may check the call log or check for newly deposited Metadata.

The normal phone app display (217E) is executed as a foreground executable by the operating system. Optionally ‘what I heard’ retrieval may proceed in a new thread. Additionally event 202A, 202B and 202D may be executed in background threads.

In some variations, what I heard Metadata was deposited by 217A, 217B, 217C, 217D or 217F or may be deposited by 217E itself. All of these may deposit Metadata in various states ranging from just Phone A, Phone B and call direction, to full Metadata. Likewise queue stored phone OS notifications may have some or all of a ‘what I heard’ Metadata. Scanning the call log results in a phone A, Phone B and call direction. Calling the call log API on networks to or 20 may have phone A, phone B and direction up to full Metadata.

All the initial activations of the 217E process may display a number of ‘what I heard’ items in a loop. There may be a number of deposited ‘what I heard’ Metadata items, a number of queued OS system notification and/or a number of new calls in the call log and/or calls from accessing the call log API on network 10 or 20. Each one would be processed as follows.

For deposited data the process looks at an agreed upon storage location, an in-memory location or the contents of an app startup message. For queued system messages, the process indicates to the OS that it is processing stored OS notification events of a specific type. The OS then sends these stored OS events to the process. For a call log the process scans the incoming, outgoing and missed called lists for calls it has not processed. The process keeps a bit on each call pair to indicate it had previously processed this call pair.

Each of these variations in the way ‘what I heard’ is obtained when 217E starts may contain all the Metadata needed for the ‘what I heard’ display or will need to have additional ‘what I heard’ processing. If there is enough data as determined by the business rules each of these ‘what I heard's visual displays are shown within the area allocated for them in the ‘normal phone app’ location.

If further ‘what I heard’ processing is required, depending on the phone and business rules the processing may occur in a separate thread or in-line to the main process. Additionally should business rules or the phone require it, a thread may be spawned for each needed ‘what I heard’ request or one thread would handle all requests in sequence. After each process is completed, these ‘what I heard's visual displays are shown within the area allocated for them in the ‘normal phone app’ location.

Startup processing clears the badges if they were present.

Once the startup processing has completed, the user may remain in the app and ‘what I heard’ displays will be automatically (or manually) updated by the following: 1) a call completion event 202A, 2) an external notification sent directly to this process (202B), 3) a periodic poll to pick up new call log information (202D for call log), 4) a periodic poll to pick up Metadata deposited by other processes (202D for Metadata scan), 5) manual ‘refresh’ button to perform both types of poll at this time 6) an inter-process event with Metadata or an indication that ‘what I heard’ Metadata may be picked up. 7) A periodic poll to pick up new call log information through the call log API to networks 10 or 20.

1) For 202A, the call completion event registers for call completion events as described above. The ‘what I heard’ app arranges for a call back or for event processing. On receipt of the call back or event, depending on business rules and phone capability, a thread is started to do ‘what I heard’ processing, or ‘what I heard’ processing is done in-line. On completion of either of these, ‘what I heard's visual displays are shown within the area allocated for them in the ‘normal phone app’ location

2) For a 202B, external notification, the ‘what I heard’ app registers to receive the external notification events. On certain phones, this act of registering (or sometimes the fact that the app itself is alive) cause these external events to be sent to this ‘what I heard’ app and not sent any longer to a background process that registered for a 202B (i.e. process that were part of 217A, 217B or 217C displays. additionally some phones will stop the events that went to the OS external notification displays from going there, instead sending them to the ‘what I heard’ app.

On receipt of this external notification event, depending on business rules and phone capability, a thread is started to do ‘what I heard’ processing, or ‘what I heard’ processing is done in-line. On completion of either of these, ‘what I heard's visual displays are shown within the area allocated for them in the ‘normal phone app’ location.

A 202B event may contain many phone calls, each are processed in turn.

3) On a periodic poll of the call-log, call logs 1A, 3A or 5A are scanned for new calls since the last check of the call-log. on detection of a new call, depending on business rules and phone capability, a thread is started to do ‘what I heard’ processing using the retrieved Phone A, Phone B and direction, or this ‘what I heard’ processing is done in-line. On completion of either of these, ‘what I heard's visual displays are shown within the area allocated for them in the ‘normal phone app’ location.

4) On a periodic poll for deposited Metadata the depository is scanned. This Metadata may have come from 217A, 217B, 217C, 217D or 217F. For each deposited Metadata found, each may contain all the Metadata needed for the ‘what I heard’ display or will need to have additional ‘what I heard’ processing. If there is enough data as determined by the business rules each of these ‘what I heard’ visual displays are shown within the area allocated for them in the ‘normal phone app’ location.

If further ‘what I heard’ processing is required, depending on the phone and business rules the processing may occur in a separate thread or in-line to the main process. Additionally should business rules or the phone require it, a thread may be spawned for each needed ‘what I heard’ request or one thread would handle all requests in sequence. After each process is completed, these ‘what I heard's visual displays are shown within the area allocated for them in the ‘normal phone app’ location.

5) On a manual ‘refresh’ button press. When the manual button with the app is pressed, depending on business rules and the phone, the same processing for a periodic poll of call log and/or periodic poll for deposited Metadata depository is performed immediately.

6) For a receipt of an inter-process message, the ‘what I heard’ app registers to receive an inter-process communication this IPC may originate from any of the background event processing in separate processes that are part of 217A, 217B, 217C, 217D and 217F. This IPC may have full or partial Metadata contained within the IPC mechanism or it may signal that the ‘what I heard’ app should scan the ‘what I heard’ depository for what I heard Meta. Data in both the IPC itself and picked up Metadata may have enough ‘what I heard’ information or not. Processing on this data continues as per the ‘polls’ above.

7) On a periodic poll for call log updates via API from network 10 or 20. For each deposited call found, each may contain all the Metadata needed for the ‘what I heard’ display or will need to have additional ‘what I heard’ processing. If there is enough data as determined by the business rules each of these ‘what I heard’ visual displays are shown within the area allocated for them in the ‘normal phone app’ location.

Business rules, phones, and phone screen size determine how much of each ‘what I heard’ visual display derived above and how many of these are displayed. Depending on business rules, phones, and phone screen size to the current ‘what I heard’ visual display for the running app on a particular handset, all or some of the sample string and image are displayed within the area reserved for the running app. If it is not fully displayed, a control button touched or navigated to allow for more of the information to be displayed. If there is room, all constituent tracks are displayed, or a control button touched or navigated to allow all constituent tracks to be displayed. If business rules dictate it, an ‘interact’ button allows further interaction with this track.

As further ‘what I heard's are displayed after the app has started, these newly arrived items displace older ones or go further down in scroll lists. The specific rules for displacement are determined by business rules, phones, and phone screen size.

Exiting this ‘what I heard’ 217E app displays whatever the phone's OS is set to display. I.e. it may return to the drag down if the OS does that after spawning a process from there, it not the phone returns to wherever it normally would.

Exiting the pop-up does not stop the background processing of events 202A, 202B and 202D. These continue to occur and collect data associated with each for display later by running the app with 202C again.

Event 202F, call progress protocol is not directly relevant to this display method (i.e. it does not trigger this display method directly), rather it stores ‘what I heard’ data in a known location that me be picked up by this display method.

Event 202G, run of a call app, is not relevant here as it is only relevant to display method 217I

FIGS. 2002 and 2006 show the run-app display method with full graphics. FIGS. 2003 and 2007 show the run-app display method with just text.

What I heard Graphic App (2002): Illustrative embodiment of the running app display method, 217E showing a real time graphical display of ‘what I heard’. This shows ‘what I heard’ Metadata including Album art, track title, artist name and album.

What I Played Graphic App (2006): Illustrative embodiment of the running app display method, 217E showing a real time graphical display of ‘what I played’. This shows ‘what I played’ Metadata including Album art, track title, artist name and album.

What I Played pop-up (2004): Illustrative embodiment of the pop-up display method, 217B showing a real time display of ‘what I played’. This shows ‘what I played’ Metadata including Album art, track title, artist name and album. This examples also shows an interact button related to interacting with the current ‘what I played’. Also shows a display of past ‘what I heard’ and ‘what I played’ results.

What I Played Text app (2007): Illustrative embodiment of the running app display method, 217E showing a real time a ‘just text’ display of ‘what I played’. This shows ‘what I played’ Metadata including track title, artist name and album.

3.c.vi. Phone Call App.

Display method 217I, the phone call app, is exclusively run by step 202G, the run phone call app event. Please see the description of 202G for starting this type of app.

In this type of app, ‘what I heard’ display Metadata may be shown both during call establishment as well as after the call.

The main characteristic of this type of app is that it is written and embodied by a third party. The current disclosure describes the methods that this type of application would use to display ‘what I heard’ display Metadata.

During the call establishment phase of these third party there are two options for obtaining ‘what I heard’ display Metadata. Event 202F, the call progress protocol event, or by the third party app acting like a third party app 95 by calling the ‘what I heard’ API.

An event 202F during call establishment would have deposited the collected ‘what I heard’ display Metadata at a known and accessible location. The call app retrieves this information from that location. Alternately the app may have registered for the broadcast event that event 202F may broadcast. The obtained Metadata may have some or all display Metadata depending on what was transmitted during call establishment.

A call to ‘what I heard’ during call establishment may take two forms: a call to on-the-phone ‘what I heard’ binary API, or use the ‘what I heard’ API on server 30. in both cases, the third party app sends phone A and phone B values and is returned full ‘what I heard’ display Metadata.

After the phone call the third party phone call establishment app has other options.

It may use the data from the deposited Metadata or the broadcast event 202F as described ‘during the call’ above. Or it may call the ‘what I heard’ API, also as described ‘during the call’ above

It may receive full Metadata stored or broadcast by the ‘what I heard’ software apparatus in 220A. If it is to receive the broadcast event the third party app registers to receive this event prior to its use. If it polls the Metadata store it is up to the third party app to decide when to poll.

It may register with the phone OS to receive call completion similar to 202A and then call the on-phone or on-server-30 what I heard service.

In all these cases the third party app would be in possession of a set of full ‘what I heard’ display Metadata.

For both during call establishment and after the call, it is up to the third party app to decide how much of the ‘what I heard’ display Metadata is displayed and when it is displayed.

3.c.vii. ‘What I Heard’ on-Phone Data Distribution

Step 217J distributes the results of ‘what I heard’ determinations to other apps on this phone. They share this step 217J because they interface to the flow of the ‘what I heard’ software apparatus in the same way.

Step 217J may be implemented on the phone as a further step of the ‘what I heard’ determination embodied in the various display methods 217A, 217B, 217C, 217D, 217E and 217F. Each of these descriptions explained various embodiments of the ‘what I heard’ determination. E.g. the background process for processing external notifications. If any or all of 220A, 220B and/or 220C are implemented on a phone, then they are called immediately after the ‘what I heard’ determination and are not directly related to the display method that may embody it (in other words 220A, 220B and 220C may occur in addition to any actual display method.)

Separately 217J and its sub steps 220A, 220B and 220C may also be implemented by themselves without 217A, 217B, 217C, 217D, 217E, and 217F on phones that allow background processing and for which business rules allow it. Here a background process implements the various background processes described in those display methods does not implement the final display step. E.g. the background call processing described in the app-pop-up for call completion events would run, however the final ‘pop-up’ would not occur, instead 217J and one of its sub-steps would run.

### 3.c.vii.1. Broadcast and General Data Store

Step 220A uses a phone's data distribution model to distribute ‘what I heard’ display Metadata to other apps on the phone that may be interested in ‘what I heard’ information such as those that described in 217I, the call app. These data distribution models allow one app on a phone to distribute data to another app on that same phone.

These data distribution models vary greatly from one phone operating system to another. Broadly they fall within the following illustrative types: 1) Inter-process broadcast type events that include the data, 2) specific process directed events. 3) Passive data stores that are polled, 4) passive data stores that have ‘data changed’ events distributed. 5) Private App A, calls App B, passing it data. Depending on phones and business rules one or more of these may be implemented on a particular phone.

Inter-process broadcast type events that include the data: In this type of distribution model various receiving apps register for a particular broadcast event. The sending app registers that it is the source of these broadcast events. When data is available to be distributed, the sending app places the data in a broadcast call. The phone OS then arranges for all registered receivers to receive the broadcast event and to collect the distributed data. As embodied in the ‘what I heard’ software apparatus on a phone, it registers as the sending app and when ‘what I heard’ display Metadata is available it places it in a broadcast call.

Specific process directed events or messages: In this type of distribution model the sending app does the work of distribution, here, possibly by pre-arrangement, or possibly by a run-time registration, the sending app sends an inter-process message to one of a list of apps waiting for the event or message. Some phones support the transmission of data within the event or message. On other phones, the data is deposited in a pre-arranged location for the processes to pick it up. These calls by the sender may be traditional API calls or they may be formatted as URLs that the phone OS can deliver to registered types. As embodied in the ‘what I heard’ software apparatus on a phone, it has compiled in the pre-arranged receiver apps or accepts registration events from them. When ‘what I heard’ display Metadata is available it deposits that data in the agreed upon location if needed. It then sends events or message in turn to each pre-arranged receiver or registered receiver. If supported it includes the ‘what I heard’ display Metadata in the event or message call.

Passive data stores that are polled: In this type of distribution model the sending app places the data in a pre-arranged location. Sometimes the phone OS provides this common store in a structured manner, (e.g. as relational database or a data dictionary); others simply provide a storage location for which all applications have permissions to access. After the sending app places the data here, the receiver periodically checks for data stored here and accesses it if it sees it. As embodied in the ‘what I heard’ software apparatus on a phone, when ‘what I heard’ display Metadata is available it deposits that data in this store.

Passive data stores that have ‘data changed’ events distributed: This type of distribution is a combination of numbers 1, 2 and 3 above. In this type of distribution model the sending app places the data in the same passive data store as 3, then uses the broadcast or specific process directed events in 1 or 2, however it does not include the data in these events. As embodied in the ‘what I heard’ software apparatus on a phone, it firsts deposits the data as in 3, and then sends events as described in 1 and 2

Private App A, calls App B, passing it data: In this type of distribution model the sending app starts (executes) the receiving app, passing it the data in the startup call. When ‘what I heard’ display Metadata is available it places the data in the execution parameters and executes the pre-arranged app. It may also do this function when a ‘what I heard’ software apparatus user selects a particular action and reasonably expects to be directed to a different app. As an illustrative example, the ‘what I heard’ software apparatus might display ‘run this app’ button on an advertising RBT. On pressing it this advertising app is run and the ‘what I heard’ determination is passed to it.

### 3.c.vii.2. Address Book

Step 220B. Address book. This display method adds ‘what I heard’ and ‘what I played’ to the phone's address book seen by users and which may be accessed by other apps. The address book displays the name, device type (mobile, home etc.) picture and other contact information associated with a phone number. Additionally, a ‘call to action’ is sometimes available for various registered phone call and other contact related additions to the call log.

Step 202C populates the results of ‘what I heard’ and ‘what I played’ into the one contact entry associated with the contact. As an illustrative example the contact entry for ‘George’ on a particular phone would read “George played ‘Let It Be’ for you (this is the ‘what I heard’) and ‘you played ‘Love Shack’ for him when he calls’ (this is the ‘what I played’). It should be noted that the ‘what I heard’ service populates the contact list in a random access, random time manner. That is, as a user calls and is called from a contact the data is stored in the list (or updated as needed). This results in the information being spotty in the address book. If available it would also add a ‘call to action’ to start up the ‘what I heard’ software apparatus.

There are two types of embodiment of this display method; 1) the phone OS provides a facility for third party apps to add this information to the address book and 2) ‘what I heard’ functionality is integrated by the phone owner when the phone is manufactured into the address book.

1) Phone provides facility. For this, the phone OS provides a way for a new contact information provider to register with the contact system. The ‘what I heard’ software apparatus does this, also indicating that it should be called via a 202C with the contact record when the OS provided call to action for this contact provider is selected by the user.

After registration ‘what I heard’ or ‘what I played’ data is provided in one of two ways;

A) Inserted into the address book directly from the ‘what I heard’ software apparatus. In this case the ‘what I heard’ software apparatus calls the API provided for this purpose by the phone OS, providing ‘what I heard’ or ‘what I played’ text and/or image to be inserted into the contact who’ phone number is the other side of the current call (phone B for an outgoing call or Phone A for an incoming or missed call)

B) The phone OS expects the provider of contact information to provide a call-back to return the information that it will display on a contact in the address book. In this case, the ‘what I heard’ software apparatus stores ‘what I heard’ or ‘what I played’ determinations in table 170. When 220B executes for the current determination, it does an insert or update operation on table 170 with 171=phone number, 172=the actual text string derived from the ‘what I heard’ display Metadata for this type of determination. An illustrative example 172 is set to: ‘played ‘Let It Be’ for you’. 173=call direction of ‘outgoing’ or ‘incoming/missed’. An insert inserts these three things, and update uses 171 and 173 as keys, replacing 172 if needed.

As required by the phone OS for this type of address book contact service, the ‘what I heard’ software apparatus provides a call back to provide the information to be displayed with this contact from the ‘what I heard’ system. This callback extracts the phone number for this contact and uses it to search column 171. If one record is returned (an ‘outgoing’ or ‘incoming/missed’), just that column 172 is returned as the information to display. If two records are returned, the two strings 172 are concatenated to produce a sentence about the incoming and outgoing determination.

2) Integrated with the phone's manufacturer. The specifics of integrating with a particular phone manufacture cannot be determined, however broadly the integration points and methods are similar to the phone OS provided facility; 1) A means for the address book to call the ‘what I heard’ software apparatus on a call to action with a contact record, or with just phone B. 2) a means to store determinations into the address book using the phone number of the other side as a key or by a callback.

### 3.c.vii.3. Call Log

Step 220C. Call log. This display method adds ‘what I heard’ and ‘what I played’ to the phone's global call log seen by users and which may be accessed by other apps. A call log is the list of incoming, outgoing and missed calls on a phone that usually show the phone number, name of the contact, picture, date and call direction. Furthermore, a ‘call to action’ is sometimes available for various registered phone call and contact related additions to the call log.

Step 220C adds ‘what I heard’ to this display on outgoing calls and ‘what I played’ on incoming and missed calls. If available it also adds a ‘call to action’ to start up the ‘what I heard’ software apparatus.

A call log display generally has two components, the call information itself and a reference to the contact from the phone's address book associated with this call. The contact information is provided in ‘address book’ 220B facility described above.

The call log update may occur in two ways:

1) The ‘what I heard’ software apparatus accesses the call log and inserts this information: it should be noted that since the ‘what I heard’ software apparatus is run in some circumstances immediately after a call completes, the call log record from the phone's call log is most likely the last record inserted. As such 220C scans the call log for a match on phone number for the other side and call direction. It then updates only the first record that matches with the ‘what I heard’ or ‘what I played’ text as derived by business rules from the ‘what I heard’ display Metadata.

2) The phone's call log software queries the ‘what I heard’ software apparatus for the ‘what I heard’ or ‘played’. Here the ‘call back’ procedure in 220B described above with its use of table 170 is used. Instead of a contact record being passed by the phone OS as the query, phone A, Phone B and direction are passed to access table 170. This would result in only one record because direction is also passed.

4. When Other Side does not have App

The ‘has app’ service, 90, is integrated into the ‘what I heard’ service to a) send ‘what I heard/played’ indications to phones that do not have the ‘what I heard’ software apparatus and b) to encourage owners of phones that are capable of downloading the software apparatus to do so. In both cases it does so by sending text messages or postings to third party social network sites. The ‘has app’ service is optional in the flow of ‘what I heard’ and its use depends on business rules.

The ‘has app’ service 90 is treated as a black-box for our purposes, however the inputs, configurations and outputs needed for the service to perform the functions needed are described below.

The ‘has app’ service 215 executes in three variations. In one variation, 215 is integrated into the API ‘what I heard’ service running on server 30. In another variation it executes within the ‘what I heard’ process on phone 1, 3, or 5. In a third variation it is used as part of the ‘offline processing service’, 202E on server 30. In all cases the ‘has app’ service 90 is called with certain inputs, configurations and outputs. When service 90 is called from server 30, it executes in two modes: 1) ‘service mode’ when the ‘what I heard’ API provided by 30 is called as a service to other servers, 40 or 95 or from the offline processing service, 2) ‘phone mode’ when the ‘what I heard’ API provided by server 30 is called from phone 1, 3 or 5. Both these modes will be described together below, with differences in the modes defined. The inputs, configurations, and outputs provided the ‘Has App’ service 90 when called from 1, 3 or 5 is the same as when called in ‘phone mode’ from server 30. These will be described only in the context of ‘phone mode’ from server 30.

The API call for both modes sent to server 30 has the following additional parameters over the normal ‘what I heard’ service is provided when business rules call for the ‘has app’ service. 1) The ‘request has app service’ bit set to true. Let us call this parameter 4-1. 2) The human readable name for the owner of this phone. Let us call it 4-2. This name was obtained either from a known location on the phone or the ‘what I heard’ app asks for it at the time of first installation of the app. If it is empty, the phone number of the other side.

When called in ‘phone mode’ the following additional parameters are provided: 1) logged in credentials to any potential social networking alternate delivery. Let us call this parameter 4P-1. The phone obtains these credentials by directing the user to log into the appropriate social networking provider and having that provider return the log in credentials. Alternately the user may provide a user name and password for the service and pass it in the ‘what I heard API 2) handles or addresses of the person on the other side of the call relevant to the social networking provider. Let us call this parameter 4P-2. The phone collects the handle or address by using the other side's phone number to search an appropriate contact catalog on the phone. 3) Depending on business rules, a ‘force manual’ bit that directs the ‘has app’ service to allow the user on the phone for which this API is called to manually send the ‘what I heard’ message to the other side or, alternately, to allow server 30 to automatically send the message if it is capable of doing so. Let us call this parameter 4P-3.

Should parameter 4-1 be true, server 30 passes parameters 4-2, 4P-1, 4P-2 and 4P-3 along with these additional parameters to service 90: 1) the other side's phone number as was provided in the ‘what I heard’ API. Let us call this 4P-2) Text strings for various alternate delivery methods for which the ‘what I heard service may choose’. Each of these text strings contain: words that, according to business rules contain ‘what I heard’ Metadata and this phone's number or name (4-2) and a URL pointer. illustrative variations on these alternates and the type of alternate ‘what I heard message’ that can be sent include; a) other side's device is capable of downloading a version of the ‘what I heard app: a text message with a URL to an on-phone app catalog and a pointer to the app itself so the user can download the app. Call this 4T-1. b) Other sides may receive text messages but can't have the app: a text message with URL pointing to web server 96. The URL encodes the title, artist, album of the track and the remote's phone number or 4-2. Call this 4T-2. c) Various strings, each appropriate to a social networking provider containing the similar URL to web server 96 or to pages within a social network. Call this 4T-3

As an illustrative example, the ‘has app’ service 90 will be configured with the following cascading logic: 1) if other side has app, do nothing and return ‘has app’. 2) If the other side is capable of running the app and their carrier rules allow for text messages, send a text message 4T-1. 3) Otherwise, if the remote can receive a text message and their carrier rules allow for text messages, send text message 4T-2. Otherwise 4) if social networking credentials were supplied in 4P-1 send to the user on that social network site as supplied in 4P-2. These messages are sent in step 218. In all these cases, had the ‘force manual’ 4-3 bit been set to ‘on’, the text strings and an indication as to which communication channel (2-4 here) should be used are returned to the phone so that user may manually send the message to the phone that does not have the app.

Has app service 90 will return the following to step 215: 1) Remote has app already. Let us call this 4R-1, 2) the other side does not have app but the service 90 has in some way sent a ‘what I heard’ message. Let us call this 4R-2, 3) the other side does not have the app and enclosed is a message that should manually be sent from the phone as just described. Let us call this 4R-3. 4) There is no way of getting a message to other side. Let us call this 4R-4. If ‘has app’ 90 has been called directly from a phone 1, 3 or 5, return these values to the phone. If ‘has app’ 90 was part of the API call that had the ‘request has app’ service 4-1 set, return these values as part of the API call. If called as part of the ‘offline processing service’ 202E, return these values to the offline process for the appropriate side of the call.

As illustrative examples, ‘has app’ is used in the following situations. 1) During ‘offline processing 202E for both sides of the recorded call pair. 2) During ‘what I heard/played’ processing that originates from phones 1, 3 or 5 for the ‘other side’ of call. (Phone A if called from phone B or phone B if called from phone A). 3) API call from 40 or 95 for both sides of the call pair

### 5. Notes on ‘Offline List Processing on Server 30’

The ‘offline list processing’ started in step 202E and run on server 30, processes lists of phone call pairs between phones A and Phones B. It sends ‘what I heard’ messages to Phones A, and ‘what I played’ messages to phones B. it sends external notifications via 217H to phones that ‘has app’ and uses the ‘has app’ service to send alternate messages via 218.

A list of calls that have completed is provided to server 30. Process 202E iterates through this list. Additionally the process selects first phone A, then phone B and performs its function on both in turn.

202E performs one ‘what I heard’ indication for the pair, as the ‘what I played’ as seen on phone B is the same as ‘what I heard’ on phone A. To do this it does a ‘what I heard’ determination (outgoing call) with Phone A and Phone B as values. The ‘what I heard’ service, entered in 204 and proceeding with steps 203A, 205 through 214 and 219 proceed as described above, collecting ‘what I heard’ display visual Metadata for the pair if an RBT (or non-RBT type display) is indicated. If nothing is returned from the determination in 207, processing moves on to the next pair. This processing continues until there are no more pairs.

As a performance improvement the list may already include some or all the ‘what I heard’ display Metadata of a predetermined ‘what I heard’ determination for the call pair. Should this be partial Metadata, the process enters at 203, sending control immediately to 219 to get more information.

In either case should there be a ‘what I heard’ determination, ‘has app’ is processed in turn for phone A, then for Phone B, passing the following parameters: 1) the phone number to check (Phone A or B in turn) is passed as parameter 4P-4. 2) No social network service is used so 4P-1 and 4P-2 are null. 3) Force manual 4P-3 is always false, that is it is an automatic send from server. 4) 4T-1, the text message when the other side ‘can have’ the app but doesn't is set as per above (without a name 4-2, instead the other side's phone number is inserted there). 5) 4T-2, the text message when the other side ‘can't have the app’ is set per above (also with 4-2 being the other sides phone number). 6) 4T-3, social networking messages are set to null.

The ‘has app’ service is configured as above. the ‘has app’ service will send out a text message to the other side if it does not have the app and the carrier allows these messages and the phone allows text messages as described above. These messages are sent out via 218.

If the phone device supports notifications and the return value was ‘has app’ (4R-1) an external notification is sent from server 30 through notification service 60 to the phone being processed. This notification contains as much Metadata retrieved from the ‘what I heard’ service as the notification can hold. It also contains human readable messages if the device type requires that. (if all the Metadata cannot fit, a track-ID) is provided so that the what I heard processing on the phone can pick up the Metadata via an API call to 30

6. Notes on Phone Numbers, Including Phones that May not have Access to Phone Numbers

The term ‘Phone Number’ has been used throughout to mean either a number within the global dialing plan or a private string or binary digits used for addressing. For a number in the global dialing plan, this number is characterized as a string of digits and certain special characters such as ‘+’, ‘*’ or ‘#’ that allow a phone user to place a phone call to another land line or mobile phone throughout the world. For a private string or binary digits it can be, illustratively, any random collection of characters such as an email address or string of hex digits. This number may also be a special coded address special to a notification system 60

Phones that run the ‘what I heard’ software apparatus may not have access to the phone's own global phone number. If that is the case then the ‘what I heard’ software apparatus might have access to a unique private number that the phone OS assigns to this device, such as a serial number or other uniquely defined number or if it does not have any unique OS provided number, a unique number may be generated by the ‘what I heard’ software apparatus.

Many carriers' server 40 use global dialing plan numbers in the API's, however some may use private strings or binary digits and thus may require these on RBT Authority calls.

The ‘what I heard’ system operates in two distinct modes. In one mode, all calls are within the same network 10 i.e. from phone 1 or 2 to phone 3 or 4. In this scenario the ‘phone number’ for Phone A and Phone B throughout this document may be either a global dialing plan number or a private string or binary value.

When calls however traverse two networks a common reference is used between them. If any of the networks serviced by the ‘what I heard’ service operate using the global phone number system, other numbers will be normalized to global phone numbers. Additionally, on phones that do not provide access to their own global phone number and if there is just one network, numbers will normalized to the global phone number

To support this, the following is provided: 1) a mechanism to obtain a global phone number if the phone cannot get its own global phone number. 2) mechanism for certain users of the ‘what I heard’ API to provide private strings or binary values and have them translated to global numbers, 3) a mechanism to translate global phone numbers to private strings or binary values on calls to RBT Authorities.

6.a. Mechanism to Obtain a Global Phone Number if the Phone Cannot Get its Own Global Phone Number

If the phone does not allow the ‘what I head’ software apparatus to obtain its own global phone number the software apparatus obtains it. The following illustrative examples provide a means of obtaining this number, but there may be other methods.

1) Ask the user: provide a prompt where the phone user may enter in his or her phone number. There are further two scenarios here.

a) Business rules allow for unverified global phone number. In this case, store the global phone number within the ‘what I heard’ software applause and use it on all calls to ‘what I heard’ service and as ‘this phone’.

b) The business rules require the ‘what I heard’ software apparatus to verify the phone number. In this case: 600 shows the time-flow interaction for this. The app in column 602 asks the user for the phone number in 610. It then sends a verification request to server 30 in 611. Server 30 gets this 611 in column 603. server 30 implements a verification API that takes this number to be verified and stores it in 612 in the ‘pending verification table’ 150 with column 151 set to the proposed global phone number and column 152 set to ‘pending’. Server 30 then sends a text message to the global phone number in 613 to a text message service 97 in column 604. The text message service forwards this message back to the phone in 614. Should the correct global phone number have been entered, the phone that sent the verification request in 611 will get this text message. The user responds to this text in 614A and sends the text message to server 30. Server 30 had arranged to have this text message sent to itself. Server 30, gets this 615 in column 603 and uses the ‘from’ global phone number in the text message to access table 151. It sets the state column 152 to ‘verified’ in 616. At some later date in 616A, depending on business rules, the ‘what I heard’ software apparatus issues another API call to server 30 in 617 asking if verification has occurred, passing it the still unverified global phone number. Server 30 gets this 617 in column 603. server 30 implements this API by using the passed global phone number to access table 150 using column 151 as key, returning column 152 in 618. If ‘verified’ is returned, a ‘verified’ global phone number is saved on the phone. In this case whenever this phone's own number is needed this value is used. If 618 had not returned ‘verified’, every time ‘this phone’ number is needed, another attempt is made to call 617. In each return of not ‘verified’, the ‘what I heard’ service cannot be called with the unverified number and no ‘what I heard’ is shown.

2) Encoded URL sent with ‘has app’ text message: Starting in column 654 of time flow procedure 650, the ‘has app’ service in 660 determines that a phone does not have the app. Alternately a carrier may send ‘has app’ like texts of its own to handsets under its control. These texts are sent in 661 as text message to the phone the text message contains a URL to a web page that suggests a download of the app. This URL also contains the global phone number. The phone receives the text in column 651. At some later time the user opens the text and follows the link in 662. This starts the phone's web browser in 663, which then requests the page from the web server 98 in column 655 by sending it the web request 664 which contains the global phone number. The web server sends the web page to the web browser in 665 echoing the global phone number. In 666, the web page instructs the web browser on the phone to store a cookie containing the global phone number. Sometime later, in 667, the user decides to click on the ‘download’ link’ on the web page. Alternately the user could decide to download the app themselves from the phones application catalog. The user is directed to the on-phone download catalog through 668. In column 656 the user decides to download the app. The download occurs via 669, installing the app to column 651, the phone OS. Sometime later the user runs the app for the first time in 670. The OS runs the app in 671, starting the app in column 653. On this first run of the app, the user is immediately directed to the web browser in column 652 by 673. The app puts in a unique ID into this URL before sending it, storing this unique ID within the app for later in 672. The web page shown illustratively says ‘thank you for downing the app’, press OK to continue’. The web server then sends a URL to the web server 98 in column 655 via 674. This URL has the unique ID and the cookie that stored the global phone number. The web server then forwards unique ID and global phone number to server 30 in column 657 via 675. The server stores the following in table 150; unique ID in column 153, global phone number in column 151 and state=‘pending pickup’ in column 152. This is shown in 676. Sometime later in 677, the app calls an API implemented on server 30 via 678. This API sends the unique ID stored in 672. The API returns the global phone number. Column 657 receives the request; searches table 150 for the passed unique ID in column 153, fetching the global phone number from 151. It sets the state, column 152 to ‘picked up’. The response is sent to the app in 679 (to column 657). The app stores this global phone number in 680. The app will now use this number as its global phone number and use this value whenever ‘this phone’ global phone number is needed.

3) Carrier log in: The user's global phone number is generally stored at the carrier. This can be obtained by calling a login API on server 40. The user is asked for userID and password for their carrier account in the ‘what I heard’ software apparatus. These values are sent via API to server 40. Server 40 responds with a user record that contains a global phone number. The app will only allow log in to the carrier for which the app is written. (I.e. the AT&T version of the app will allow only log in to AT&T and not Verizon). The returned global phone number is stored. The app will now use this number as its global phone number and use this value whenever ‘this phone’ global phone number is needed.

Additionally the carrier may have a ‘single-log-in’ facility on the phone whereby a log-in to other carrier apps on the phone (or on the phone's browser) will allow the ‘what I heard’ software apparatus to access the customer record containing the ‘global dialing plan phone number’ without asking the ‘what I heard’ software apparatus' user to log in again.

6.b. Mechanism for Certain Users of the ‘What I Heard’ API to Provide Private Strings or Binary Values and have them Translated to Global Numbers

When one or more RBT Authority 40 supports the global dial plan phone numbers server 30 normalizes passed strings or binary values to global dial plan numbers. The ‘what I heard’ API into server 30 supports this by allowing, depending on business needs a ‘type’ value to be associated with both phone A and phone B. A special value for ‘type’ is ‘global dial plan phone number’ this indicates to the system that the value is a global phone number. Other values passed are arbitrary and matches the arbitrary values inserted into table 160.

On receipt of a ‘what I heard’ API on server 30, step 203A checks both phone A and Phone B in turn to see if the type value is ‘global dial plan phone number’. If it is, the carrier is looked up as normal with no further action. If it is other than ‘global dial plan phone number’, ‘type’ and the passed string/binary value are used to search table 160, columns 163 and 162 respectively. The returned ‘global dial plan phone number’ is now used as the value for phone A and phone B are now used throughout the remaining ‘what I heard’ steps (unless it is later translated to a string/binary value below).

Under some circumstances, business rules on server 30 will not implement this feature, allowing the raw string/binary value to be passed to servers 40, or to be used as the key to any table on server 30 that requires phone numbers.

This feature may be implemented on both server 30 and phones 1, 3 and 5.

6.c. Mechanism to Translate Global Phone Numbers to Private Strings or Binary Values on Calls to RBT Authorities

Certain Server 40 RBT Authorities may not accept global dial plan phone numbers instead requiring a string or binary value. Server 30 supports a one-to-one translation scheme to translate these before sending.

The request column 105 of the RBT Authority table encodes a request that requires a translation. It also includes the ‘type’ to translate to. As an illustrative example it can be: ‘translate_to_skype_email’. Before sending the request to the referenced RBT Authority it uses the ‘global dial plan phone number’ that was received (or translated to) in the ‘what I heard’ API and this type to search table 160 columns 161 and 163 respectively. The retrieved string/binary value from column 162 is passed to the RBT Authority.

This feature may be implemented on both server 30 and phones 1, 3 and 5.

7. Notes on Third Party Call Apps and Phones that do not Generate Call Events or Logs

Definition: Third party call apps are applications on mobile phones that provide audio or video calling services but are not integrated into the phone's normal phone services. That is, there is no call completion events 202A provided on call progress and there is no centralized, known call log that can be scanned on a poll for 202D or for running app 202C to scan. Illustrative examples of this include VOIP apps that perform full call functions. Similarly certain phone OSs do not provide call completion or call log events or may not allow the ‘what I heard’ software apparatus to obtain this information.

Should the provider of these third party apps wish to provide ‘what I heard/played’ services to their users they may do so by: 1) generating an external notification event 202B either locally on the phone from their app, or have their network infrastructure send an external notification. This external event supplies sufficient information for the ‘what I heard’ service to determine the RBT played, e.g. a phone A and phone B. These values are recommended to be ‘global dial plan phone numbers’, however they may be strings/binary values with an associated type as described above in the discussion on phone numbers. 2) A direct call to a ‘what I heard’ API, either as a binary included library on the phone or as an external API where that app is acting as a third party app 95. When called as an API, it is also advisable that the values are in ‘global dialing plan’ format, but they may be string/binary and type. 3) store these same values in a known location and send an inter-process message as described in the ‘what I heard’ service description above, 4) store these same values in a known location and have a poll 202D or running app 202C pick it up.

Optionally these methods could provide more information over phone A and phone B as described in the ‘what I heard’ API (such as track title etc.).

### 8. Additional Notes on VOIP Networks

Voice Over IP services allow applications on mobile phones users to place audio calls and in some cases video calls over the IP networks.

For the ‘what I heard’ service two features distinguish VOIP services from phone audio service provided by a cell phone carrier 10 and 20.

First, the normal (default) phone services on the phone support the normal voice services in an integrated manner while the VOIP services are provided as separate apps. The normal voice service is integrated into the phone by having easy access (usually one button) into the phone service while VOIP calling is generally a separate app run a separate way. Additionally, normal phone services may provide call completion events 202A, log calls into the phone-wide call log and address books. Also, the normal phone functions utilize the global dialing plan phone numbers while VOIP calls may use their own addressing method such as user names or email addresses in addition to or in place of the global dial plan numbers’.

The fact that the app is separate and is not integrated into the base call event, log and address book are addressed above in “Notes on third party call apps and phones that do not generate call events or logs” above. The issue of different addresses is dealt with in the “Notes and Phone Numbers, including phones that may not have access to phone numbers.” section above. Here, the VOIP service may send these non-global dialing plan numbers or strings in the events or API calls to the ‘what I heard’ service along with an appropriate type, or it may directly provide ‘global dialing plan numbers’ if it uses them too.

The second main difference is that VOIP networks (here, a networks is a collection of a network and handsets and PCs that both support the same VOIP service) may be self-contained networks or interconnected with traditional phone networks. For self-contained networks, both endpoints to a call are the VOIP service, as such; phone A and Phone B's VOIP specific strings or binary addresses may consistently be used throughout without translation.

When VOIP networks are interconnected to traditional phone networks the VOIP service generally allows the ‘global dialing plan phone number be use used throughout. Here the VOIP service assigns a ‘global dialing plan phone number’ to the VOIP app. When a user on VOIP calls a phone on a traditional phone network, it uses that handset's ‘global dialing plan phone number’. That incoming handset sometimes sees the assigned VOIP number as the incoming call and other times it sees a generic global dial plan phone number representing the VOIP network. Conversely a handset on a traditional phone network uses the assigned-by-VOIP ‘global dialing plan phone number’ to call the VOIP user. This results in the VOIP app running on the called handset. To use the ‘what I heard’ system in this configuration either the VOIP app provides both numbers in ‘global dial plan’ phone format in calls to ‘what I heard’ or there exists a translation in table 160 between its string/binary form and the ‘global data plan phone number’ form.

### 9. Registration for Notifications

Notification services 60 forward notifications from some server to the phone. These notification servers use types of addresses. ‘Global dialing plan phone number’ and ‘Unique ID’.

In ‘global dialing plan phone number’ notification survives, the ‘global dialing plan phone number’ is provided and the notification service forwards it on. Sometimes this type of notification can be performed directly from a server without going through a notification server. In this case the ‘what I heard service, or any other entity that is trying to send notifications to the ‘what I heard’ software apparatus may directly use the ‘global dialing plan number’.

In the unique ID version the phone, notification server and server sending the notification all agree on a unique ID. The server sending the notification then uses the unique ID to send a notification to the app.

The unique ID version generally requires a registration to be sent from the handset to the notification service saying that it is interested in receiving notifications. This registration either assigns the unique ID from the notification service or is given the unique ID from the handset. To complete the registration process this unique ID is then sent from the handset (or forward from the notification server) to the server that is sending the notification.

In any event, for the purposes of the ‘what I heard’ system, when the server that is sending the notification receives this unique ID it also is accompanied by the ‘global dialing plan phone number’ associated with this device. This is because whether the notification is sent from server 30, 40, or networks 10 or 20 these servers use the ‘global dialing plan phone number’ internally and refers to this number.

If the registration is sent to a server 30, it uses table 160 to store these values, putting the unique ID (and any credential blobs) in column 162 and the ‘global dialing plan phone number’ in column 161. It sets type appropriate for the value, e.g. ‘Apple Notification Service’. Later, when it wishes to send a notification on its own volition it searches the table using the ‘global dialing plan notification’ phone number to match column 161 and ‘type’ (column 163). Column 162 is then returned as the unique ID to use for the notification.

The ‘what I heard’ software apparatus is responsible for sending all the needed notification registrations for all expected notifications from any server that may send a notification. This is generally done at first app startup.

### 10. Notes on Raw Record Cache Mechanism on Phone B

As a speed improvement to the current disclosure it should be noted that the raw RBT record for a phone B, the phone that receives calls, is unlikely to change on either 30 or 40 during the run of the software apparatus. As such, having the raw RBT record on the phone allows an RBT determination to occur local to the phone on subsequent incoming phone calls from any phone A without a retrieval to server 30 or 40.

To do this, an RBT Authority record on phone B that retrieves a raw record is modified to point to a rule that includes a ‘store w/b’ rule (similar to example RBT authority record 2, but on the phone). This record would be Ordinal 2. (On this first time through, ordinal 1 below that tries to retrieve from the cache would fail as the record is not in the database). This would cause the first raw record retrieved for an incoming call from a phone A from server 30 to be stored in table 1D (a version of table 120 on phone B). An ordinal 1 record would, similar to RBT authority record 7 would also be on the phone that would, as the first rule, try to retrieve from the local table 120. This is a raw record on the phone and as such, the new phone A, call it phone A-prime can be used in a raw record determination from the same raw RBT record retrieved for phone A. This time however, because it is a different phone number, the raw record calculation may return a different ‘what I heard’ determination.

This cache may be kept either for the amount of time that the ‘what I heard’ software apparatus is resident in memory, or another method, such as time residing in table 120 may be used to purge this message. Additionally, other sections of the ‘what I heard’ software apparatus, will allow administration of the raw RBT record. This manipulation may also serve as a signal to invalidate the cache.

### 11. Illustrative End-to-End Examples

The following are a set of illustrative examples with time flow communications diagrams that serve as a summary of procedures throughout. They should not be construed as exhaustive coverage of all features. The titles of each section do not imply a complete description of the illustrative features in the example.

11.a. Partial Notification, Two Possible RBT Authorities, Displayed in a Widget

This illustrative example shows: 1) a notification from 40 with phone B in it is sent to a phone A via a notification service 60 2) a background notification processes this on a phone. 3) the phone contacts the ‘what I heard’ RBT API on server 30, 4) server 30 first sees if a corporate RBT is active on phone B by getting a raw corporate RBT Time-of-Day record from server 40, not finding that the current time is within the range it then 5) calls server 30 to get a raw RBT profile for the Phone B. This record has all needed Metadata. 6) Server B analyzes the raw record and assembles a ‘what I heard’ return with all needed Metadata. 7) Server 30 stores it in a cache for a later retrieval. 8) The ‘what I heard is returned to the background process that then 9) updates the widget.

Time flow chart 1000 shows the flow of this illustrative example. This example uses RBT Authority record 101 on the phone to indicate that a ‘what I heard/played’ is called on server TMI-I and that a ‘what I heard/played’ determination is returned with full Metadata. Record 9 (which is an alternate ordinal 1 to carrier AT&T) on the server indicates that a raw time of day record is returned from the first server at the carrier. Record 2 on the server indicates that a raw user record is returned form server 2. The contents of these records were described above with table 100

Column 1001 starts the process in 1020A. Here, Server 40, after call completion decides to send a notification to phone A. As an illustrative example here it includes just the phone number of phone B. It sends the notification to the notification service 60 (1020)

Column 1002 receives this notification (1020) on the notification service 60. And forwards it the phone OS (1021)

Column 1003 receives the notification 1021 on phone A's OS. the ‘what I heard’ software apparatus previous to this time had registered with the OS that it is interested in receiving this type of notification so the phone OS forwards this to the background process section of the app (1022)

Column 1004, the background process receives 1022 in step 202B. Phone side ‘what I heard’ processing is entered at 203. Since there is no ‘what I heard’ determination in the notification, only the phone number and call direction, processing at 203 passes to ‘what I heard’ processing in 205. It looks through the phone's RBT authority table in step 205 and finds record 101 indicating that it should contact server TMI-1 in step 209 and ask for ‘what I heard’ processing. It passes its phone number as phone A and the number received in the notification as phone B. It assembles this request in 1023 and sends it to server 30 in 1024.

Column 1006 receives this ‘what I heard’ request on server 30 in step 204. It first contacts the phone number to carrier service 80 in step 203A, sending request 1025 to it. Column 1007 receives this and sends the response back to 1006 in 1026. The determination in this case is that it is for AT&T.

Server 30, column 1006 receives this response and then searches for ordinal 1, and carrier=AT&T in step 205. (Note, we arrange for record 9 instead of record 1 being in the table as AT&T ordinal 1.) The record indicates that AT&T server-1 be contacted asking for Corporate_RBT3. Phone B is sent in the request. This request is sent to that server in 1027 at step 209.

Column 1008, which is AT&T server-1 (a server 40 type server), receives this request and using phone B that was passed and returns the raw corporate RBT record associated with B. it returns it through 1028.

1028 is received in column 1006 on server 30 and processing continues through 210 to step 211 to do raw calculation. This RBT authority (record 9), uses rule 1007. Rule 1007 states that a TOD check only occur (and that the record is stored also. The returned record from AT&T server-1 indicates that an RBT is played, as an illustrative example, from 9 AM to 5 PM Monday through Friday. it happens to be 6 PM on Monday so, applying rule 1007 there is no RBT to be played and step 212 determines that ‘no RBT’ was played and processing loops back to 205 to search for RBT authority for AT&T of ordinal 2. This returns record 2, indicating that AT&T Server-2 be contacted asking for a raw user record for phone B. Step 209 contacts this server and sends 1029.

Column 1009 receives this 1029 on AT&T Server 2 (a server 40 type server). AT&T server 2 then searches for the raw record associated with phone B and returns this as the response in 1030.

Column 1006, server 30 receives this response in step 210 which, seeing it raw proceeds to step 211 to do raw calculation. This RBT authority (record 2), uses rule 1002. Rule 1002 states that Time of Day, MDN, user default and carrier default are checked in that order. (And that the record be stored also) The returned record from AT&T server-2 indicates that user had no TOD set and no MDNs set, but it did have a line default of say ‘Let It Be’ with the full Metadata). This results in ‘let it be’ being played for everyone, so ‘Let It Be’ is the determination. Step 211 also stores this record returned from AT&T server-2 in table 120 (shown as 1031) with both phone A and Phone B stored. Server 30 proceeds through to 217G that sends the return value to phone A in 1032.

Column 1004, the background process, receives this 1032 response. The phone's RBT authority record 101 was used to send this and its rule 1005 indicates that it is a ‘what I heard’ response with all the data needed. The background process then passes the what I heard Metadata display information to the widget half of the ‘what I heard’ app in 1033 (this is not an actual send but a pass within the app of the data)

Column 1005, the widget displays this Metadata in 1034 via 217A and the user sees ‘what I heard’ on the last call. (Actually the call that the network sent the notification for)

11.b. Call Completion Pop-Up, Server 30 has ‘What I Heard’ Cached

These illustrative examples shows: 1) a call completion event (outgoing) on a phone B being sent to a RBT app that then pops-up. 2) in-line it puts up rotating arrows and calls the ‘what I played’ RBT API on server 30 passing phone A, 3) server 30 sees that a ‘what I played’ with full Metadata for the phone A and phone B pair had been previously cached on server 30. 4) Server 30 returns ‘what I played’ to phone B. 5) phone B stops the rotating arrows and displays ‘what I played’ when phone A called me.

Time flow chart 1100 shows the flow of this illustrative example. This example uses RBT Authority record 101 on the phone to indicate that a ‘what I heard/played’ is called on server TMI-1 and that a ‘what I heard/played’ determination is returned with full Metadata. Record 5 on the server indicates that a cached ‘what I heard’ may be found in table 120. The contents of these records were described above with table 100

Column 1101 starts the process in the phone's OS. The RBT app had previously registered that it should be sent ‘call completion events’. In 1110, call completion starts the process sending the event shown as 1111. This is an outgoing call so it sends the ‘outgoing call complete’ event. Column 1102, the background process of the RBT app receives this call completion event and processes it starting at step 202A. The first thing it does is to collect this phone's phone number at Phone A, and the phone number of the call that was just completed as phone B. The business rule for this version of the RBT app allows for the ‘what I heard’ access to occur while the app is up, so the background process of the RBT app issues a broadcast event that causes the app to be visible. This is 1112. Since the app is visible, we need to let the user know that we are accessing the back end, so a loading animation of circular arrows is put on top of the now visible app. This is 1113. ‘What I heard’ processing now starts on the phone at 203A. There is no ‘what I heard’ in the event information, so 203 continues to 203A. There is no ‘calculate Carrier’ in this version of the app on the phone so it starts the ‘what I heard’ loop on the phone in 205. 205 retrieves RBT authority record 101 which indicates that server TMI-1 be contacted with a ‘what I heard’ API request. This is sent via 1114.

Column 1103 receives 1114, the API request on server 30, starting step 204. It first contacts the phone number to carrier service 80 in step 203A, sending request 1115 to it with ‘phone B’. Column 1104 receives this and sends the response back to 1103 in 1116. The determination in this case is that it is for Verizon.

Server 30, column 1103 receives this response and then searches for ordinal 1, and carrier=Verizon in step 205. The record indicates that a locally stored ‘what I heard’ should be searched in table 120 using both phone A and Phone B. We will assume that some recent request had stored the record matching Phone A and Phone B and that the search returns a record. This is shown in 1117. Step 210 determines that ‘what I heard was included in the record so it jumps to 217G to return it. Server 30 returns this record that has all the needed Metadata sending it in 1118.

The RBT app on the phone (a phone 1) receives ‘what I heard’ determination in column 1102. It first stops and removes the rotating arrow in 1119. Continuing ‘what I heard’ processing on the phone sees a ‘what I heard’ in 210 and proceeds to 217B to display the ‘what I heard’ Metadata results in the pop-up. This is shown in 1020.

11.c. Network Notification to OS Only Notification Center, Partial ‘What I Heard’

This illustrative example shows: 1) the network equipment for the carrier of Phone A sending a notification to phone A with the track name and track ID (partial Metadata) via a notification service. 2) phone A only supports a notification center and does not send the notification to the RBT app if the app is not running, instead, putting it in the notification center 3) The user sees the notification and runs the app from the notification center which passes the notification data to the app. 4) the app, seeing it needs more Metadata, calls server 30 to get it. 5) Server 30 doesn't have the data so it calls server 40. 6) The data is returned through server 30 to the app that then updates the display in the running app with this data.

Time flow chart 1200 shows the flow of this illustrative example. We use special record 105 in the RBT Authority for this situation. It has the special tag ‘Track-info’ in the ordinal, indicating that this rule should be used on a notification

Column 1201 starts the process. Here, Network 10 sees the call completion in 1201A and decides to send a notification to phone A. Network 10 includes a human readable message that as an illustrative example says ‘your friend just played ‘Let It Be’ for you.’ it also contains the track-ID associated with ‘let it be’ so the phone can use it as a reference to retrieve all the needed Metadata. It sends the notification to the notification service 60 (1210)

Column 1202 receives this notification (1210) on the notification service 60. And forwards it to the phone OS (1211)

Column 1203 receives the notification 1211 on phone A's OS. The ‘what I heard’ software apparatus previous to this time had registered with the OS that it is interested in receiving this type of notification. This type of phone though does not forward notifications directly to apps (and thus start them automatically), instead, it displays the text ‘your friend just played ‘Let It Be’ for you’ in a special area on the phone designated for notifications (1212). The phone associates this notification with the registered phone app so that when the user selects it, it starts the app, passing it the notification at startup.

At some time later, the user selects this notification from the phone's notification area in 1213. 1213 causes the app to start at 1214. The phone OS starts the app at 202C. The app runs in column 1204. It starts at 202C seeing the waiting actual notification (that was set up by the OS) and retrieves it. Seeing a ‘what I heard’ determination with a track ID step 203 passes control to 219. 219 see that only the trackID was provided and searches the phone's RBT authority for the special record ‘Track info’. this retrieves record 105 from the RBT authority table 100 which indicates that server TMI-1 be accessed to get the track-info passing the ‘track info’ request from column 105. This request is sent via 1215.

Column 1205 receives 1215 on server 30, which is the special API request to retrieve just the track info. Server 30 knows that this information is not in its table 110 so it passes the request via 1216

Column 1206 receives this 1216 track-info request on server 40. Server 40 retrieves this information and returns in via 1217

Column 1205, server 30, receives this Metadata response in 1217 and forwards this response via 1218

Column 1204, the phone, receives this Metadata response and displays it via 217E in 1219.

11.d. Run App to Scan Call Log. Get from a Carrier and Aggregator

This illustrative example shows: 1) running the app directly 2) scanning the call log for both incoming and outgoing calls 3) the first call, an incoming one where this phone acts as a phone B, sends a ‘what I played’ RBT API on server 30 passing the incoming call as phone A and its own phone number as phone B, 4) Server 30 calls the server 40 servicing the carrier associated with phone B 5) server 40 returns a raw record for phone B to server 30. 6) Server 30 figures what would be played for phone A. 7) server 30 returns ‘what I played’ to the phone, 8) the phone displays this ‘what I played’. 9) the second call is processed, an outgoing call where the phone acts as a phone A, sends a ‘what I heard’ request with the outgoing number as phone B and its own number as phone A. 10) Server 30 calls the server 40 servicing the carrier associated with this new phone B 11) server 40 returns a raw record for phone B to server 30. 12) server 30 figures what would be heard on phone A. 13) server 30 returns ‘what I heard’ to the phone, 14) the phone displays this second ‘what I heard’.

Time flow chart 1300 shows the flow of this illustrative example. This example uses RBT Authority record 101 on the phone to indicate that a ‘what I heard/played’ is called on server TMI-1 and that a ‘what I heard/played’ determination is returned with full Metadata. Record 2 on the server, modified for our purposes to be ordinal 1, indicates a raw record is to be expected from AT&T, and record 4 on the server, indicating that it is a carrier aggregator that supports carriers Orange, O2 and Videophone and that it too returns a raw RBT profile.

The user decides to start the app from the phone's app menu in 1310, column 1301. Here, the user decides to start the app. The app is started in 202C. 202C in this case scans the incoming and outgoing call logs for calls it has not processed since the last time it scanned the log. It will notice one incoming and one outgoing call in our illustrative example. In 1311 it processes the first call, an incoming one, so the number in the call log is a phone A, and the phone that the app is on is a phone B for ‘what I heard’ purposes. It starts thread A as column 1302, passing it these phone numbers via 1312.

Thread A, column 1302 starts ‘what I played’ processing. It passes 203 and 203A going to 205 where it looks through the phone's RBT authority table in step 205 and finds record 101 indicating that it should contact server TMI-1 in step 209 and ask for ‘what I heard’ processing. It passes phone A and phone B numbers. It assembles this request and sends it to server 30 in 1313. It should be noted that this Thread A now suspends waiting for the response and the phone actually proceeds to 1321 to start a separate thread for the second phone number while thread A waits. (1321 is described below)

Column 1304 receives this ‘what I heard’ request 1313 on server 30 in step 204. It first contacts the phone number to carrier service 80 in step 203A, sending request 1314 to it. Column 1305 receives this and sends the response back to 1304 in 1315. The determination in this case is that it is for AT&T.

Server 30, column 1304 receives this response and then searches for ordinal 1, and carrier=AT&T in step 205. (Note, we arrange for record 2 instead of record 1 being in the table as AT&T ordinal 1.) The record indicates that AT&T server-2 be contacted asking for RBT_PROFILE_REQ1 asking for a raw user record for phone B. This request is sent to that server in 1316 at step 209

Column 1306 receives this 1316 on AT&T Server 2 (a server 40 type server). AT&T server 2 then searches for the raw record associated with phone B and return this in 1317.

Column 1304, server 30 receives this response in step 210 which, seeing it raw proceeds to step 211 to do raw calculation. This RBT authority (record 2), uses rule 1002. Rule 1002 states that Time of Day, MDN, user default and carrier default are checked in that order. (And that the record be stored also) The returned record from AT&T server-2 indicates that user had no TOD set and no MDNs set, but it did have a line default of say ‘Let It Be’ with the full Metadata). This results in ‘Let It Be’ being played for everyone, so ‘Let It Be’ is the determination. Server 30 proceeds through to 217G that sends the return value to thread A on the phone in 1318.

Column 1302, Thread A receives this 1318 response. The phone's RBT authority record 101 was used to send this and its rule 1005 indicates that it is a ‘what I heard’ response with all the data needed. Thread A then posts all the Metadata in 1319 so the running app displays it in 1320. Thread A now dies.

As noted, the second phone number, the outgoing call example is actually processed while thread A is waiting for the response. These occur in 1321 and the thread is started in 1322. Here, the phone's number is a phone A, and the one from the call log, phone B. From here, items 1323 through 1328 proceed in the same manner as 1313 through 1320, except that the carrier determination is ‘O2’, and thus RBT Authority record 4 is used. Thread B on the phone receives the ‘what I heard’ response in 1328. The phone's RBT authority record 101 was used to send this and its rule 1005 indicates that it is a ‘what I heard’ response with all the data needed. Thread B then posts all the Metadata in 1329 so that the main app displays it in 1330. Thread B now dies.

11.e. Jukebox with ‘on-the-Fly’ Audio ID on the Phone. Shows in Notification Bar, App is then Run

This illustrative example shows: 1) in a background process the recording of the audio clip between call initiated and call connected events on phone A takes place. 2) on call completion Phone A sends a ‘what I heard’ request with phone B and its own number as phone A. 3) server 30 has the raw record cached for phone B. 4) it calculates ‘what I heard’ from the raw record and concludes that a jukebox was played. 5) Server 30 returns ‘what I heard’ with full Metadata for each track in the jukebox. This includes a URL to the actual clip for each item in the jukebox. 6) The phone’ background process sees that a jukebox is returned and starts audio match processing. 7) Audio processing uses the URL for each actual clip and collects all these possible clips. 8) The phone produces audio match signatures for each of the possible clips. 9) The phone makes an audio signature for the clip recorded at the start. 10) An audio match is performed matching the recorded clip against the list of possible clips. 11) On a match, the Metadata from the matched record is assembled into a ‘notification bar’ event. 12) The full set of Metadata is stored. 13) When the user selects the event from the notification bar the app is run. 13) The app sees the stored Metadata and displays it.

Time flow chart 1400 shows the flow of this illustrative example. This example uses RBT Authority record 201 on the phone to indicate that the ‘what I heard/played’ API is called on server TMI-1 and that a ‘what I heard/played’ determination is returned with full Metadata. This record further states, through rule 1008 that should an RBT be returned in this ‘what I heard’ it will try to fail-over to an audio match. This record 201 is an alternate ‘ordinal 1’ on the phone. Record 103 on the phone is used to effect audio processing as ordinal 2. Record 4 on the server, indicates that it is a carrier aggregator that supports carriers Orange, O2 and Videophone and that it too returns a raw RBT profile. The contents of these records were described above with table 100

Column 1401 starts this process in 1410A. The ‘what I heard’ app's background process previously registered with the phone OS to get all the phone progress events including ‘call initiated’, ‘call connected’ and ‘call ended’. The phone OS on phone A sends the ‘call initiated’ event in 1410. The background process of phone A receives this event in 1402, starting step 201A that starts recording the ‘heard’ audio stream in 1411. This records the RBT audio heard.

When the other side picks up in 1412A, the phone OS sends a ‘call connected’ event via 1412 to 1402. The background process picks up the event and stops the recording of the audio stream in 1412B, resulting in only the pre-connected audio being recorded.

When the call completes, either with this phone or remote phone hanging up, or the call terminates in another manner, the OS on phone A sends the ‘call completed’ event 1413 to the background process.

The background process in column 1402 receives 1413 in step 202A. 202A collects the current phone's number as Phone A, and the number that was called as Phone B. ‘what I heard processing is entered at 203. Since there is no ‘what I heard’ determination in the notification, only the phone numbers, processing at 203 passes to ‘what I heard’ processing in 205. It looks through the phone's RBT authority table in step 205 and finds record 201 indicating that it should contact server TMI-1 in step 209 and ask for ‘what I heard’ processing. It passes Phone A and Phone B. it assembles this request and sends it to server 30 in 1414.

Column 1404 receives this ‘what I heard’ request on server 30 in step 204. It first contacts the phone number to carrier service 80 in step 203A, sending request 1415 to it. Column 1405 receives this and sends the response back to 1404 in 1416. The determination in this case is that it is for ‘O2’

Server 30, column 1404 receives this response and then searches for ordinal 1, and carrier=O2 in step 205. The record indicates that the aggregator service ‘Europe Aggregator-1’ RBT_Profile_REQ3. Phone B is sent in the request. This request is sent to that server in 1417 at step 209

Column 1406, which is Europe Aggregator-1 (a server 40 type server), receives this request and using phone B that was passed and returns the raw RBT record associated with B. it returns it through 1417A

1417A is received in column 1404 on server 30 and processing continues through 210 to step 211 to do raw calculation. This RBT authority (record 4), uses rule 1004. Rule 1004 states that a raw RBT is expected, however it does not failover (here on the server) if a Jukebox is encountered. Rule 1002 states that Time of Day, MDN, user default and carrier default are checked in that order. The returned record from Europe Aggregator-1 indicates that an MDN based called ID is used when phone A calls in. (i.e. phone A passed in the API is the same as phone number in the MDN in the MDN based RBT section.). The RBT in this MDN entry is a jukebox. This same return from server 40 also has the track-info Metadata for all constituent tracks. A ‘what I heard’ is returned indicting that a jukebox was played, and here are all the possible tracks. (It cannot determine which one, which is what the audio processing will do). This ‘what I heard’ is returned in 1418

Column 1402, the background process, receives this 1418 response. The phone's RBT authority record 201 was used to send this and its rule 1008 indicates that it is a ‘what I heard’ response with all the data needed, however if a Jukebox is received it would fail. Seeing a jukebox, it fails in 210 and loops back to 205 to get the next RBT Authority on the phone.

Searching for ordinal 2 now retrieves phone RBT Authority record 103. Record 103 indicates that ‘local-audio’ be performed and that it is of the type ‘on-the-fly’, indicating that feature extraction occur on the set to be matched now.

This directs flow to step 213 in 1419. Using the Metadata returned from the server for all the constituents to the Jukebox, step 213 extracts the URLs pointing to audio clips. In turn it sends a 1420 request to server 40's track repository, column 1407 (which may be separate from the ‘RBT record’ processor 1406 on server 40). Column 1407 returns the track in 1421. Each track in the jukebox is done this way repeating 1420 and 1421 until all track audio has been retrieved.

Column 1402 continues at 1422 (which is in step 213), producing ‘signatures’ for each of these retrieved tracks. 1423 (also in step 213) produces a signature for the recording from 1411. 1424 does a ‘soft match’ of the recording to the list of possible tracks. If there are many features that match, a match is declared. (We'll only consider this ‘match case’ here in our illustrative example.) The Metadata associated with the track that was matched (and was returned in the ‘what I heard’ from the server) is collected and a ‘what I heard’ determination is made.

In 1425 this Metadata is used to assemble a short message, illustratively ‘Your friend just played ‘Let It Be’. This is sent to the OS API to display at the top notification bar in the system. The full set of Metadata is also sent for the system to later send to the app when it is run. This short message appears at the top of the phone in 1425A.

At some time later, the user selects this notification from the phone's notification area in 1426. This causes the app to start. The phone OS starts the app at 202C in 1427. The app runs in column 1403. It starts at 202C seeing the waiting actual notification, it gets it in 1428 (that was stored from 1425 in the OS). Since all the Metadata was stored and retrieved in the notification call, the ‘what I heard’ visual Meta is displayed on the phone using step 217E.

11.f. Offline Processing, One Each of Four Supported Phone Scenarios, Use of ‘has App’

This offline processing illustrative example shows the processing for two call pairs. In the first pair Phone A has the app, and phone B doesn't have the app, but it can get the app. The phone that has the app has a widget that will display the results. In the second pair, Phone A can't get the app but allows text messages and phone B has no path to it by an alternate means. This results in two ‘what I heard’ determinations and four separate passes through ‘has app’.

This illustrative example shows: 1) a process starts on server 30 to process calls; 2) it encounters call pair record number 1. 2) Phone A and phone B in this record are extracted and passed to ‘what I heard’ processing. 3) On determining that something was heard, between these two (i.e. phone B played for phone A) (via a cached value) a ‘has app’ is done on Phone A 4) has app returns that this Phone A ‘has the app’; the process then sends a notification via the notification service to phone A of ‘what I heard’. All the Metadata is sent in the notification. 5) Phone A receives this in a background process. 6) It then sends all the Metadata that was in the notification to the widget which then displays it. 7) ‘Has app’ is called for Phone B. 8) ‘Has app’ determines that this Phone B does not have the app, but it is capable of downloading it. 9) A text message with a link to the local app store is sent to this phone. 10) The user on that phone can follow the link to download the app to see more about ‘what I played’. 11) the process then sends Phone A and Phone B of the second record to ‘what I heard’ 12) on determining that something was heard between the two, a ‘has app’ is done on Phone A of this pair. 13) Has app returns that this Phone A can't have the app but can receive text messages. 14) A text message is sent to this phone A with a URL to a page that lets the user interact more with this heard RBT. 15) The user follows the link to the web page. 16) The process then sends phone B of the second record to ‘what I played. 17) on determining that something was played, a ‘has app’ is done 18) has app returns that this phone is un-reachable by any means (perhaps it is a landline) and discards the result of the ‘what I heard’.

Time flow chart 1500 shows the flow of this illustrative example. For the one case of ‘has app’, this example uses RBT Authority record 104 on the phone to indicate that a ‘what I heard/played’ that is received later in a notification has all the required Metadata. This is a special record with the ordinal column set to ‘enough’ meaning that there is enough data. Record 5 on the server indicates that a ‘what I heard’ is in the cache in table 120.

Note: for clarity FIG. 1500 does not show ‘what I heard’ processing on the phone number to carrier column.

Also note that there is a cached record for these two calls in 120 so that they all result in positive ‘what I heard’ processing.

Column 1501 starts this offline process on server 30 it executes the process 202E. 202E runs through the supplied list. 1520 starts processing record 1, Phone A column. It uses this as phone A and the other column as phone B and call direction=outgoing (i.e. a ‘what I heard’). ‘what I heard’ processing starts at 203A, calculating the carrier of Phone B. Determining that it is ‘Verizon’, it searches for RBT Authority Verizon, ordinal 1, which retrieves record 5, indicating that the record should be cached. A search of 120 with phone A and phone B shows a cached ‘what I heard’ with all Metadata in 1521.

Continued processing continues to ‘has app’ in step 215. This sends a ‘has app’ lookup request for phone A to the ‘has app’ server 90 via 1522 to column 1502. The ‘has app service returns ‘has app’ in 1523 to column 1501.

1501 receives this ‘has app’ result. This causes processing on server 30 to continue to step 217H which then sends a notification 1524 with all the Metadata to the phone A via notification server 60 in 1503. Column 1503 gets the 1524 and forwards it to phone A column 1504 via 1525.

Phone A receives the notification 1525 in column 1504. The background process on phone A receives this notification. The background process then passes this complete ‘what I heard’ Metadata display information to the widget half of the ‘what I heard’ app. (this is not an actual send but a pass within the app of the data) the widget displays this Metadata via 217A in 1526 and the user sees ‘what I heard’ from this call sent from the ‘offline process’

The offline process then moves to processing ‘has app’ for phone B of this first call record in 1527. As noted, the ‘what I heard’ determination that was collected during processing of phone A is the same ‘what I played’ for phone B so the stored determination for this pair may be used for both ‘has app’ determinations.

The call 1528 to the ‘has app’ service in column 1502 determines that phone B does not have the app, but is on a phone type that may have the app. The ‘has app’ service then sends, illustratively, a text message that says ‘you recently heard ‘Let It Be’ from your friend, click here to download the app to learn more.’ (This text message was supplied by 30 to then ‘has app’ service and passed with 1528). The text message is sent to phone B via 1529.

Phone B in column 1505 receives this text message from 1529. At some later time the user clicks on the link in the message to get the app in 1529A. This starts the download store in 1529B This directs the user to the on phone app store in column 1506. The user may download the app in 1529C.

Separately the ‘has app’ service in column 1502 returned ‘no app, message sent’ in 1530 to server 30 in column 1501.

The offline process then moves to processing the next phone A and Phone B pair in 1531. Here phone A and phone B are used with a call direction ‘outgoing’, asking ‘what I heard on phone A when I called phone B’. The same ‘what I heard’ processing as 1520 occurs here in 1531 retrieving a cached ‘what I heard’ using phone A and phone B from 120 and using it for ‘what I played’ determination with all the Metadata.

The call 1532 to the has app service for phone A in column 1502 determines that phone A does not have the app and that phone ‘cant’ have the app, but the phone is capable of text messages. The ‘has app’ service then sends, illustratively, a text message that says ‘you recently heard ‘let it be’ from your friend, click here to learn more.’ (This text message was supplied by 30 to the ‘has app’ service and passed with 1532). The text message is sent to phone B via 1533.

Phone A in column 1507 receives this text message from 1533. At some later time in 1533A the user clicks on the link in the message to go to the web page referred to in the text message via 1534. This directs the user to the web site in column 1508. The user sees this web page and may interact with it in 1535.

Separately the ‘has app’ service in column 1502 returned ‘no app, message sent’ in 1536 to server 30 in column 1501.

The offline process then moves to processing for phone B of this second call record in 1537.

The call 1538 to the has app service in column 1502 determines that phone B does not have the app and that phone ‘cant’ have the app, and the phone is NOT capable of text messages. The ‘has app’ service returns ‘can't reach phone with any alternate message’ in 1539. This results in 1540 the ‘what I played’ determination being dropped on the floor.

11.g. Multiple Carriers Directly from Phone with No Server 30

This illustrative example shows an example of the phone going directly to RBT Authorities, one for each of two carriers directly, bypassing server 30. it shows: 1) outgoing phone call 1 occurring, 2) the background processes contacting the ‘phone to carrier’ service, 3) direct call for a raw record to a server 40 of this carrier, 4) after raw processing, the display of this ‘what I heard’ in the widget. 5) A second call coming in, 6) steps repeated on a second server for a different carrier.

Time flow chart 1600 shows the flow of this illustrative example. This example uses RBT Authority record 108 on the phone to indicate that a raw record is requested from AT&T-server 2 and to use rule 1006 to process it. Record 109 on the phone indicates the same thing, except that server Verizon-1 is contacted. The contents of these records were described above with table 100

Column 1601 starts the process. Previous to this, the ‘what I heard’ software apparatus had asked to receive call notification events. Here, a call completes so the phone OS sends an ‘outgoing call complete’ event to the background process section of the app (1610)

Column 1602, the background process on phone A receives 1610 in step 202A. This version of the software apparatus is configured to contact the phone number to carrier service and to search the RBT authority with the returned carrier name. It contacts the phone number to carrier service 80 in step 203A; sending request 1611 to it for phone B. Column 1603 receives this and sends the response back to 1602 in 1612. The determination in this case is that it is for AT&T.

The background process, column 1602 receives this response and then searches for ordinal 1, and carrier=AT&T in step 205. The record indicates that AT&T server-2 be contacted asking for RBT_PROFILE_REQ1. Phone B is sent in the request. This request is sent to that server in 1613 at step 209

Column 1605, which is AT&T server-2 (a server 40 type server), receives this request and using phone B that was passed returns the raw RBT record associated with B. it returns it through 1614

1614 is received in column 1602, the background process on phone A and processing continues through 210 to step 211 to do raw calculation. This RBT authority (record 108) uses rule 1006. Rule 1006 states that Time of Day, MDN, user default and carrier default are checked in that order. The returned record from AT&T server-2 indicates that user had no TOD set and no MDNs set, but it did have a line default of say ‘Let It Be’ with the full Metadata. This results in ‘Let It Be’ being played for everyone, so ‘let it be’ is the determination. The background process then passes the what I heard Metadata display information to the widget half of the ‘what I heard’ app in 1615 (this is not an actual send but a pass within the app of the data)

Column 1603, the widget displays this Metadata via 217A in 1615A and the user sees ‘what I heard’ on the last call.

Likewise, a second outgoing call is completed sometime later in 1616. Processing continues with 1616 to 1621A in the same manner as 1610 to 1615 except that the carrier determination is ‘Verizon’, obtaining RBT authority record 109 instead of 108 which directs to verizon-server-1. (Column 1606 instead of column 1605)

11.h. Network Calls Server 30 ‘What I Heard’ and Provides it in the Low Level Protocol to the Phone. The Phone's Call App Displays then Stores this in the Call Log and Address Book

This illustrative example shows the network providing ‘what I heard’ at a low level to the phone and the phone's call app playing it. It also shows how the network can call server 30 to determine ‘what I heard’. It shows: 1) an outgoing call started, 2) the network contacting server 30 to determine what I heard 3) a ‘ringing’ notification from the network where the network adds in this ‘what I heard’. 3) The phone's app that handles phone calls updates the display with ‘what you are listening to now’. 4) On call termination the phone's pop up that has ‘call time 10:00’ is updated to include ‘what I heard’. 5) The ‘what I heard” determination is stored in the phone's call log and address book 6) the ‘what I heard’ widget is updated with this outgoing call.

There is no RBT Authority table used for these steps on the phone and server 30 is treated as a black-box for clarity in this example. The carrier network 10 is a CDMA network.

Column 1701 starts the process in the phone's main phone call application by the user placing an outgoing call 1710. This call is to a phone B on a remote network 20, while the current handset, phone A, is serviced by network 10. The call request goes from the phone's main call app to the phone OS in 1711.

The phone OS in column 1702 gets 1711 and sends a low level phone protocol call connection request 1712 to the network 10 to start the call connection process.

The carrier network 10 receives 1712 in column 1703 and determines what is being played (or about to be played) by the incoming side. Had the incoming handset, phone B been on network 10, the network has access to the RBT profile of B and could, if it so desired, determine ‘what I heard’ directly. The phone being on network 20, network 10 cannot readily access this record, instead it opts to call a ‘what I heard’ service on server 30. (Note, network 10 could also make this access to server 30 when phone B is on its network if it so desires).

Carrier Network 10 then forwards a ‘what I heard’ API request to server 30 in 1713. This request contains Phone A, Phone B and call direction=outgoing.

1713 is received on server 30 in column 1704. This illustrative example does not show the interaction and setup required on server 30 to determine ‘what I heard’ for clarity. It returns a ‘what I heard’ with full Metadata in 1714.

1714 is received on network 10 in column 1703 and, this being CDMA, piggy-backs (adds to the payload) the ‘what I heard’ determination in the ‘call proceeding message’ sent from the network to the MO device (Mobile Originated=MO=Phone A). The network sends this in 1715.

1715 is received in the Phone OS in column 1702. Here, step 202F is incorporated into the phone OS by the phone's manufacturer. Step 202F returns this ‘what I heard’ to the phone OS and the phone OS uses whatever mechanism it normally uses to convey a ‘call proceeding message’, appending ‘what I heard’ to the phone's app via a 1716. 202F stores phone A, phone B, direction and this ‘what I heard’ information for other apps to get. It may also broadcast this information on phones with broadcast event mechanisms. (The phone's App could also have listened for a broadcast event or it could have passed the location that 202F stores the ‘what I heard’)

1716 is received by the phone's call app in column 1701. The required information is extracted from the returned ‘what I heard’ display Metadata (only a portion is sent by the network) and displayed illustratively in 1717 within the phone's call app as ‘What you're hearing now’ (e.g. you are hearing ‘Let It Be’ while you wait for ‘George’ to answer).

The reminder of the call is not of interest in this illustrative example and is shown as ‘connected’ in the phone's call app in 1718. (Column 1701)

At some time later, the call terminates. We show it manually terminated in 1719 but other events could have terminated the call. 1720 in the phone's call app (column 1701) can now also display ‘you heard ‘Let It Be’ in the same pop up it uses to display the call duration. This display may also include a ‘interact’ button that will start the ‘what I heard’ software apparatus using 202C and pass it Phone A, Phone B and call direction in the startup parameter list as described with 202C.

Simultaneously, the phone OS in column 1702 sends a ‘call completed’ event in 1721 to apps that had registered to receive this broadcast event.

1721 is received by the ‘what I heard’ background process in the ‘what I heard’ software apparatus by step 202A. (Shown in column 1707). For clarity the steps that the background process takes to determine ‘what I heard’ are not shown, instead they are represented by 1722, which takes phone A, phone B and direction from the step 202A and returns full ‘what I heard’ display Metadata. (Alternately, had 202F included complete ‘what I heard’ info and stored it, 1722 should retrieve this.)

The background process in 1707 invokes step 220C to send, via 1723, the ‘what I heard’ determination to the phone's call log. The call log receives this in column 1705.

Next, the background process in 1707 invokes step 220B to send, via 1724, the ‘what I heard’ determination to the phone's Address book (also called the contact list). The address book receives this in column 1706.

Finally, the background process in 1707 invokes the display method in step 217A to display, via 1725, the ‘what I heard’ determination in the ‘what I heard’ software apparatus' widget. The widget displays this in 1726 (steps not shown for clarity.)

The user now, through the widget may interact with this ‘what I heard’ display.

### Representative Mobile Devices and Wireless Environments

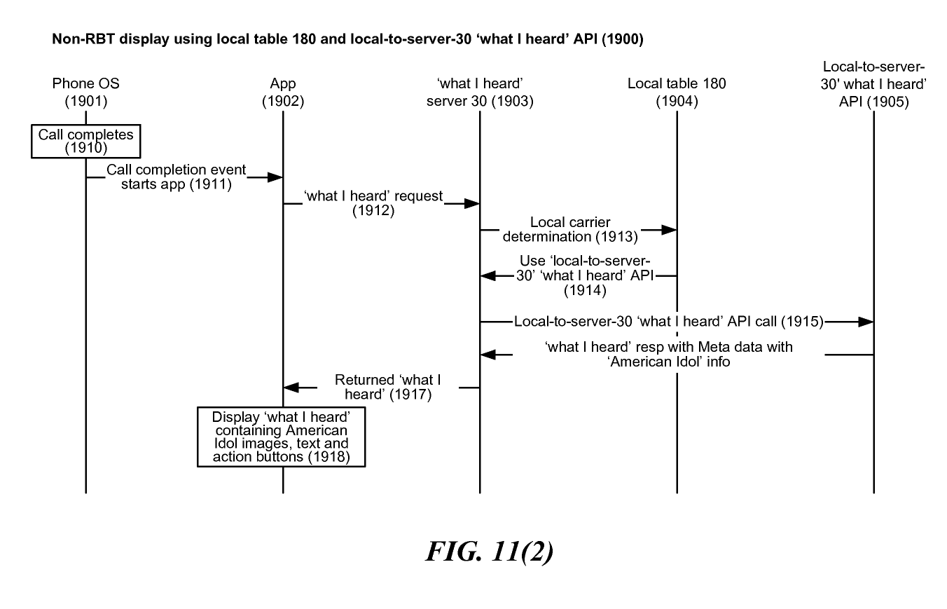

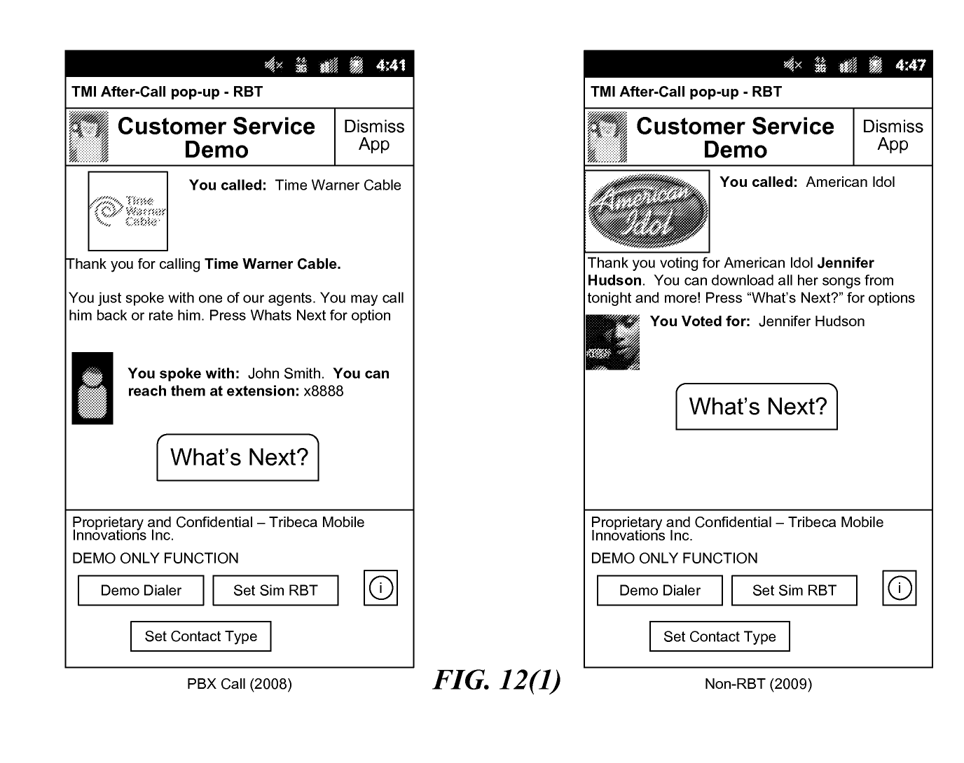

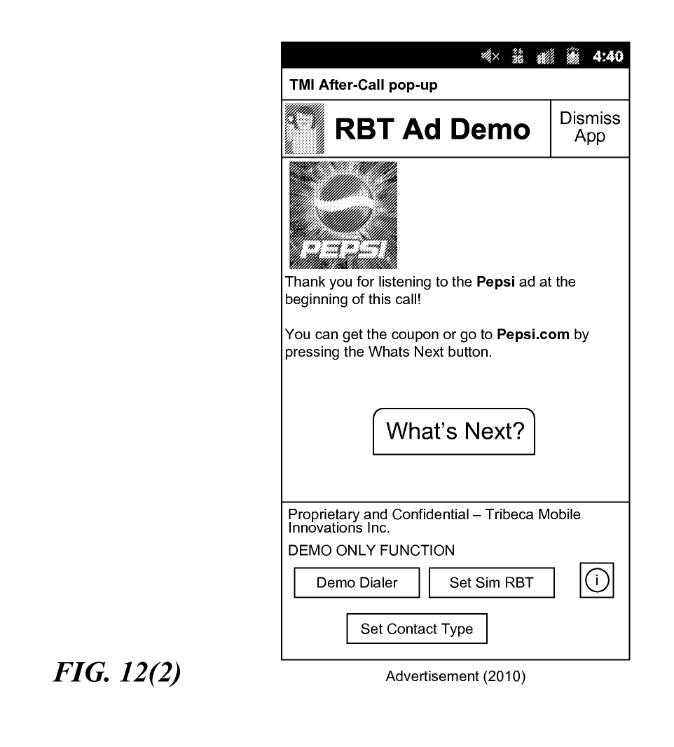

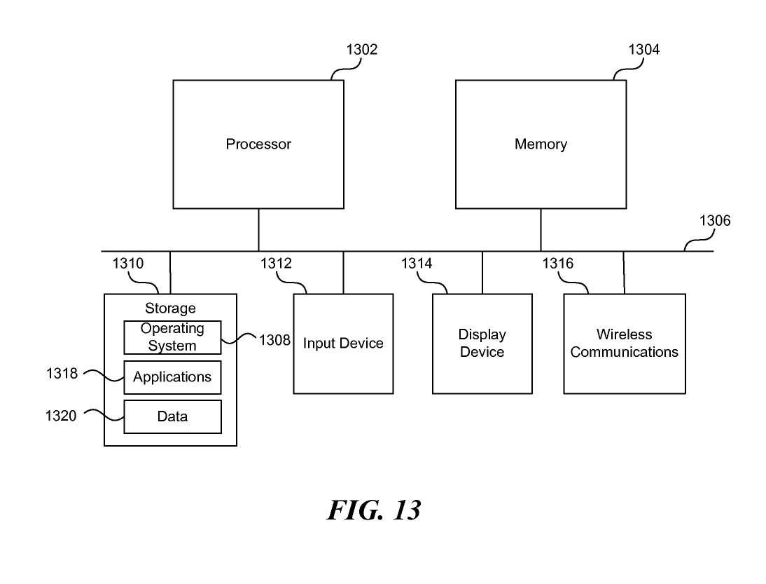

FIG. 13 is a high-level block diagram showing an example architecture of a mobile device. The mobile device includes processor(s) 1302 and a memory 1304 coupled to an interconnect 1306. The interconnect 1306 shown in FIG. 13 is an abstraction that represents any one or more separate physical buses, point to point connections, or both, connected by appropriate bridges, adapters, or controllers. The processor(s) 1302 may include central processing units (CPUs) of the mobile device and, thus, control the overall operation of the mobile device by executing software or firmware. The processor(s) 1302 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1304 represents any form of fixed or removable random access memory (RAM), read-only memory (ROM), flash memory, or the like, or a combination of such devices. The software or firmware executed by the processor(s) may be stored in a storage area 1310 and/or in memory 1304, and typically include an operating system 1308 as well as one or more applications 1318. Data 1320 utilized by the software or operating system is also stored in the storage area or memory. The storage area 1310 may be a flash memory, hard drive, or other mass-storage device.

The mobile device includes an input device 1312, which enables a user to control the device. The input device 1312 may include a keyboard, trackpad, touch-sensitive screen, or other standard electronic input device. The mobile device also includes a display device 1314 suitable for displaying a user interface, such as the display. A wireless communications module 1316 provides the mobile device with the ability to communicate with remote devices over a network using a short range or long range wireless protocol.

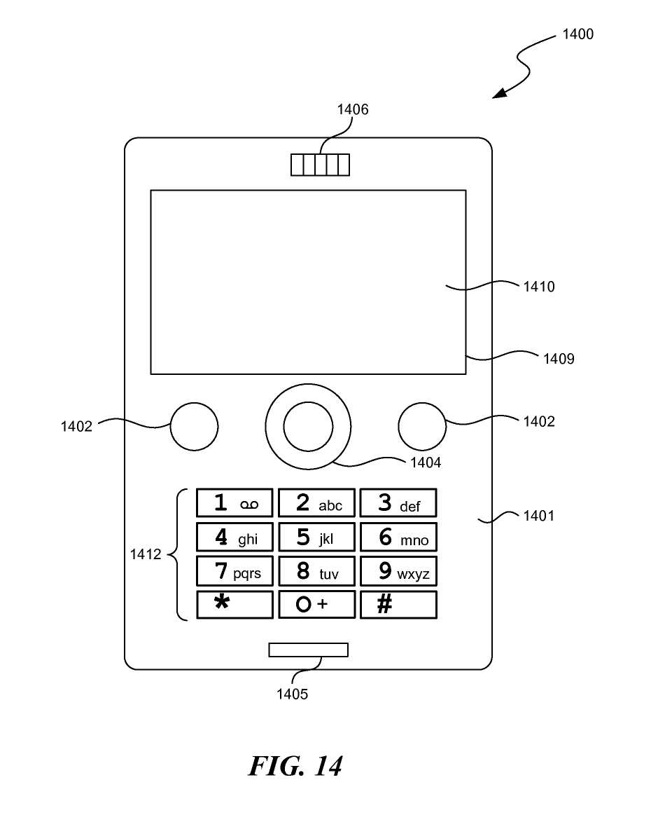

FIG. 14 is a front view of a mobile device 1400 suitable for processing. As shown in FIG. 14, the mobile device 1400 may include a housing 1401, a plurality of push buttons 1402, a directional keypad 1404 (e.g., a five-way key), a microphone 1405, a speaker 1406, and a display 1410 carried by the housing 1401. The mobile device 1400 may also include other microphones, transceivers, photo sensors, and/or other computing components generally found in PDA phones, cellular phones, smartphones, portable media players, portable gaming devices, portable email devices (e.g., Blackberrys), or other mobile communication devices.

The display 1410 includes a liquid-crystal display (LCD), an electronic ink display, and/or other suitable types of display configured to present a user interface. The mobile device 1400 may also include a touch sensing component 1409 configured to receive input from a user. For example, the touch sensing component 1409 may include a resistive, capacitive, infrared, surface acoustic wave (SAW), and/or another type of touch screen. The touch sensing component 1409 may be integrated with the display 1410 or may be independent from the display 1410. In the illustrated embodiment, the touch sensing component 1409 and the display 1410 have generally similar sized access areas. In other embodiments, the touch sensing component 1409 and the display 1410 may have different sized access areas. For example, the touch sensing component 1409 may have an access area that extends beyond a boundary of the display 1410. The mobile device 1400 also includes a 12-key numerical keypad 1412 capable of receiving text or numerical input from a user. Alternatively, the mobile device 1400 may include a full QWERTY keyboard for receiving user input. Instead of, or in addition to, a hardware keypad or keyboard, the mobile device 1400 may also provide a software keyboard or keypad on the display 1410 to enable a user to provide text or numerical input through the touch-sensing component 1409.

Non-RBT Determination Containing the Record of the Agent within a Corporation that was Just Called

This illustrative example shows a phone A which has the software apparatus calling an organization's PBX, being connected to an agent through that PBX and, after the call completes, seeing the agent's phone name, photo and direct call back information. It shows 1) the call being placed 2) the owner of phone A navigating through the PBX to an agent. 3) The ‘what I heard’ software apparatus being started by a call completion event 202A. 4) Use of the local number to carrier table to direct flow based on this particular phone number, 5) the ‘what I heard software’ apparatus' querying a remote server 40 with phone A's phone number to obtain the needed metadata about the call that was just completed as a non-RBT determination. 5) Displaying that information in the pop-up style 217B

The first record in Table 180 contains the illustrative record for this organization; in this case it is Time Warner Cable (TWC). Column 181 contains a list of phone numbers that may be used to contact TWC and that support the ‘what I heard’ service 40 that will be accessed by the ‘what I heard’ software apparatus. Column 182 has a key that will be used to access table 100, record 11 (in FIG. 10). This record 11 in table 100 contains information needed to contact the appropriate server, in this case server TWC-4. The record also indicates that a ‘what I heard’ determination is expected. Record 11 further refers to rule 1012 (column 106), referring to table 130 which then refers to rule ‘13’ in rule list 560. This rule says to expect a direct ‘what I heard’ determination with ‘who you were talking to’ Metadata.

The time flow chart 1800 shows the flow of this illustrative example.

Column 1801 is the phone A's Operating system. In our case it is responsible for placing phone calls, conducting the call, and then starting the ‘what I heard’ software apparatus when the call completes. Column 1802 is the ‘what I heard’ software apparatus on phone A. 1803 is phone A's carrier, 1804 is TWC's carrier, 1805 is TWC's PBX, 1806 is the desk phone of the TWC agent that is connected to through the PBX and also represents the agent him or herself. 1807 is the ‘what I heard’ server 30. 1808 is TWC's call completion query server that takes a phone # and timestamp and returns the agent, agent photo and call back information. This server acts as a server 40 type in our system.

The illustrative example starts at step 1810 by the user phoning TWC. The phone OS in column 1801 contacts their own carrier, carrier A in column 1803 through a message 1811. Carrier A contacts TWC carrier B in column 1804 through a message in 1812. Carrier B connects to TWC PBX in column 1805 through step 1813. Steps 1811 though 1813 serve only to connect phone A to the TWC PBX.

TWC's PBX starts its automated call direction service in 1814 to deliver audio prompts to the user in 1815. The user presses DTMF keys or speaks (1816) to this call director to direct his or her call too an agent in column 1806. Step 1816A is internal to the PBX and has the effect of connecting the caller on phone A to an agent. The agent is shown in step 1817. The Agent and the owner of phone A talk in 1818.

The call completes in step 1819, column 1801 (either side hangs up). The phone's OS in column 1801 sends a call completion event in 1820, starting the software apparatus in column 1802. The software apparatus contacts ‘what I heard’ server 30 in column 1807 with 1821. Table 180 is consulted first to see if ‘phone B’ is in this table. We find TWC's number there, and then using the retrieved column 182, access table 100 to determine that TWC-4 server should be contacted. Server 30 contacts the TWC this call completion server, acting as a server 40 in column 1808, through 1822. The TWC call completion server contacts the PBX in column 1805 through the query in 1823 and it responds back in 1824. Note the internal communication of server 40 with the PBX is shown for illustrative purposes only and may or may not actually exist. Server 40 in column 1808 responds back to server 30 with a ‘what I heard’ determination (in its own style and in this case a ‘non-RBT’ determination) with the agent's name, a URL to his or her phone and a dial string for directly dialing this agent back with an 1825. After decoding and/or transforming the results of 1825, Server 30 in column 1807 responds back to the ‘what I heard’ software apparatus on phone A, column 1802 through the ‘what I heard’ determination in 1826 with metadata in the form needed for rule 13 in table 560. The ‘what I heard’ software apparatus in column 1802 receives this indication and displays the agent's name, photo and direct contact number in a pop-up style display in step 1827.

Item 2008 shows this determination as seen through an embodiment of the current disclosure.

11.j. Non-RBT Determination Containing Metadata when a Particular Number is Called from any Phone A

This illustrative example shows a phone A which has the software apparatus calling a particular phone B number and receiving information related to that number. It shows 1) the ‘what I heard’ software apparatus being started by a call completion event 202A. 2) Use of the local number to carrier table to direct flow based on this particular phone B number, 3) the ‘what I heard software’ apparatus' calling a local-to-server-30 software apparatus with phone B's phone number to obtain the needed metadata about the call that was just completed as a non-RBT determination. 4) Displaying that information in the pop-up style 217B.

The second record in Table 180 contains the illustrative record for any phone A calling this phone B, in this case it is voting for a particular ‘American Idol’ contestant using one of two 1-800 (866) numbers assigned to vote for that particular contestant. Table 181 contains this list of phone numbers used to vote for this contestant. Column 182 has a key that will be used to access table 100, record 12 (in FIG. 10). This record 12 in table 100 indicates that the local-to-server-30 software apparatus be contacted (via the special value ‘Local-code’ in column 103) and that it need only pass ‘phone b’ (request column 105). The record also indicates that a ‘what I heard’ determination is expected. Record 12 further refers to rule 1013 (column 106), referring to table 130 which then refers to rule ‘14’ in rule list 560. This rule says to expect a direct ‘what I heard’ determination with a generic set of data to display, in this case it has two images, two sets of text and two action URLs connected to two buttons.

The time flow chart 1900 show the flow of this illustrative example.

Column 1901 is the phone A's Operating system. In our case it is responsible for starting the ‘what I heard’ software apparatus when the call completes. Column 1902 is the ‘what I heard’ software apparatus on phone A. 1903 is the ‘what I heard’ server 30. 1904 is the local number to carrier table (180); we show it here because it replaces the call to server 80 seen in other illustrative examples. 1905 is the local-to-server-30 ‘what I heard’ software apparatus.

The illustrative example starts at step 1910 with the call completing in column 1901 (either side hangs up). The phone's OS in column 1901 sends a call completion event in 1911, starting the software apparatus in column 1902. The software apparatus contacts ‘what I heard’ server 30 in column 1903 with 1912. Table 180 is consulted first to see if ‘phone B’ is in this table (1913). We find TWC's number there and then using the retrieved column 182, access table 10. The retrieved record from table 100 indicates ‘local-code’, directing the system to use the local-to-server-30 ‘what I heard’ software apparatus (1914). We pass phone B (as indicated in column 105) to this software apparatus in 1915.

The local-to-server-30 ‘what I heard’ software apparatus fills in the form ‘14’ Metadata return with the following as an illustrative example: photo-1: American Idol Logo. Photo-2: Image of Jennifer Hudson, Text-1: ‘Thank you for voting for American idol’. Text-2: “Jennifer Hudson”, button-1-words: “get last track”, button-1-URL: URL to download this track: button-2-words: “visit americanidol.com”. button-2-URL: “http://www.americanidol.com”. These values are returned in 1916. Server 30 passes this return value to the app on the phone in 1917.

1918 causes the pop-up to occur and display all the metadata.

Image 2009 shows this determination as seen through an embodiment of the current disclosure.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

We claim:

1. A computer-implemented method for providing a user interface for identifying a called party's ringback tone (RBT) provided to a mobile communication device, the method comprising:
receiving an event notification that a call between a calling party and the called party is complete;
wherein the event notification is free of RBT data,
determining a wireless carrier that provides wireless service to the called party;
receiving a user record of the called party;
employing an RBT identification authority, based at least in part, on the determined wireless carrier;
applying at least one rule associated with the employed RBT identification authority;
determining RBT metadata from the called party's user record,
wherein the RBT metadata provides to the called party information associated with the RBT data including a song title, song artist, or album; and
providing the RBT metadata for display to the called party.

2. The computer-implemented method of claim 1, further comprising:
determining at least one service associated with the determined RBT metadata; and
providing, to the calling party, information for display regarding the at least one service.

3. The computer-implemented method of claim 2, further comprising:
receiving a selection of the at least one service; and
providing the selected service.

4. The computer-implemented method of claim 2, wherein the at least one determined service is selected from the following: RBT recommendation to the called party, purchasing an audio track associated with the at least one determined characteristic of the RBT, providing a rating based on the at least one determined characteristic of the RBT, and requesting additional information associated with the at least one determined characteristic of the RBT.

5. The computer-implemented method of claim 1, further comprising:
providing for display to the calling party an RBT history comprising at least one previously determined RBT metadata.

6. The computer-implemented method of claim 1, wherein the RBT identification authority is either an audio-match authority or a record-based authority.

7. The computer-implemented method of claim 1, wherein the RBT identification authority is located remotely from the mobile communication device and from the wireless carrier.

8. The computer-implemented method of claim 1, further comprising:
providing for storage in a mobile device of the called party the determined RBT metadata.

9. The computer-implemented method of claim 1, further comprising:
determining characteristics of the mobile communication device;
wherein the RBT metadata is displayed based, at least in part, on the determined characteristics of the mobile communication device.

10. The computer-implemented method of claim 1, further comprising:
providing for display on a mobile device of the called party, at an end of the call, a popup screen or widget, wherein the screen or widget provides the RBT metadata and information regarding the calling party.

11. The computer-implemented method of claim 1, wherein the displayed RBT metadata is displayed through one of the following: a mobile application stored on the mobile communication device, a notification bar on the mobile communication device, a widget stored on the mobile communication device, a log stored on the mobile communication device, a pop-up window, and a numeric badge.

12. The computer-implemented method of claim 1, wherein the call is placed through a Voice over IP (VoIP) communication protocol.

13. A tangible computer-readable storage medium whose contents, when executed, cause a mobile communication device to provide a user interface for identifying a called party's ringback tone (RBT) metadata, the method comprising:
receiving an event notification that a call is being placed;
recording the received audio stream until the call is connected;
storing the received audio stream;
determining a wireless carrier that provides wireless service to the called party;
receiving a list of constituent audio tracks based on the determined wireless carrier,
wherein the list of constituent audio tracks is comprised of at least the received audio stream;
receiving audio clips of every audio track contained within the list of constituent audio tracks;
comparing the stored audio stream to one or more audio clips contained within the list of constituent audio tracks;
determining RBT metadata from the comparing step; and
providing for display the RBT metadata.

14. The tangible computer-readable storage medium of claim 13, further comprising:
determining at least one service associated with the determined RBT metadata; and
displaying the at least one service,
wherein the at least one determined service is selected from the following: RBT recommendation to the called party, purchasing an audio track associated with the at least one determined characteristic of the RBT, providing a rating based on the at least one determined characteristic of the RBT, and requesting additional information associated with the at least one determined characteristic of the RBT.

15. A mobile communication device for providing a user interface for identifying ringback tone (RBT) metadata, the mobile communication device comprising:
a memory;
a processor coupled to the memory;
a receiver component for receiving RBT metadata upon completion of a call; and,
a display component for displaying at least a portion of the received RBT metadata.

16. The mobile communication device of claim 15, wherein the display component is further configured to display an RBT history comprising previously determined RBT metadata associated with multiple previous RBT audio clips, and
wherein the system further comprises a processing component for:
employing an RBT identification authority, based at least in part, on the received RBT metadata;
applying at least one rule associated with the employed RBT identification authority; and
determining additional RBT metadata.

17. The mobile communication device of claim 16, wherein the processing component is further configured to determine at least one service associated with the determined RBT metadata,
wherein the display component is further configured to display the at least one service
wherein the mobile communication device comprises a touch-sensitive input component,
wherein the touch-sensitive input component is further configured to receive a selection of the at least one service, and wherein the processing component is further configured to provide the selected service.

18. The mobile communication device of claim 17, wherein the at least one determined service is selected from the following: RBT recommendation to the called party, purchasing an audio track associated with the at least one determined characteristic of the RBT, providing a rating based on the at least one determined characteristic of the RBT, and requesting additional information associated with the at least one determined characteristic of the RBT.

19. A system for identifying a called party's ringback tone (RBT) metadata, the system comprising:
at least one processor;
memory coupled to the processor;
means for determining the called party's phone number and a wireless carrier that provides wireless service to the called party;
means for employing an RBT identification authority, based at least in part, on the determined wireless carrier;
means for searching a local cache containing previous RBT identifications, based at least in part, on the called party's phone number;
means for determining the called party's RBT metadata from the local cache; and
means for sending a notification that the called party's RBT has been identified.

20. The system of claim 19, wherein the notification is a text message, and wherein the text message contains a link to a web page.

21. A computer-implemented method for providing a user interface for displaying call pair related metadata provided to a mobile communication device, the method comprising:
receiving an event notification that a call between a calling party and the called party is complete, the calling party and the called party comprising a call pair;
wherein the event notification is free of metadata;
determining an information authority from the called party phone number;
employing the information authority, based at least in part on the called party phone number, to determine call related metadata;
applying at least one rule associated with the employed information authority to retrieve a data record;
determining call pair related metadata from the retrieved data record,
wherein the call pair related metadata provides to the calling party information associated with the call pair including an image and text related to the called party; and
providing the call pair related metadata for display to the calling party via the mobile communication device.

22. The computer-implemented method of claim 21, wherein the mobile communications device is a cell phone, wherein the information authority is a local ringback tone (RBT) information authority, wherein the call is associated with a vote electronically cast for a music artist, wherein the image is an image related to the music artist, and wherein the text includes a link to permit the calling party to purchase a digital audio or video file related to the music artist.

23. At least one tangible computer-readable storage medium whose contents, when executed, allow a mobile communication device to provide a user interface for displaying call pair related data provided to the mobile communication device, the method comprising:
receiving an event notification that a call between a calling party and a called party is complete;
determining the called party's phone number;
determining an information authority, based at least in part from the called party's phone number,
wherein the information authority comprises of at least one rule;
applying the at least one rule to determine call pair related data from a record; and
providing the call pair related data.

24. The tangible computer-readable storage medium of claim 23, wherein the event notification is free of metadata, and wherein the call pair related data is comprised of one or more of the following: images, textual information, and interactive buttons.

25. The tangible computer-readable storage medium of claim 23, wherein the call pair related data is comprised of one or more of the following: a call agent's name, a URL to his phone, and a dial string for directly dialing the call agent back.
